(19) United States
(12) Patent Application Publication
(10) Pub. No.: US 2005/0091368 A1
(43) Pub. Date: Apr. 28, 2005

(54) Interactive crisis management alert and information system

(76) Inventor: Michael M. Ozburn, Marshall, VA (US)

Correspondence Address: NIXON & VANDERHYE, PC, 1100 N GLEBE ROAD, 8TH FLOOR, ARLINGTON, VA, 22201-4714, US

(21) Appl. No.: 10/692,720

(22) Filed: Oct. 27, 2003

(51) Int. Cl. G06F 15/173

(52) U.S. Cl. 709/224

(57) ABSTRACT

An interactive crisis alert system allows persons to be notified of a crisis condition to select the method and instrumentality through which they are notified. The system supports communication with its users via telephone, cell phone, pager, PDA, e-mail, and facsimile machine. In addition to notification of crisis situations the system can be used to disseminate information of interest to relevant groups of the system's users. The system provides for registration via Internet connections between the system and its users. A specific person within the household of users has access to enter household data into the system, and to determine who within the household will receive specific categories of crises or information. This specific person also determines who can take custody of children within the household during a crisis situation.

### FIELD OF THE INVENTION

This invention is directed to an interactive crisis management alert and information system for notifying, in real time, particular members of a group within a school, business or other enterprise, of a crisis situation or for disseminating information using predetermined and selected modes of communication. More particularly, the enterprise and members of the enterprise interact to determine how members should be notified about a crisis and depending upon the severity of the crisis each member will have preselected the modes of communication.

### BACKGROUND OF THE INVENTION

Even before the Sep. 11, 2001 tragedy in New York and Washington, D.C., where terrorists attacked public and governmental buildings, there has been a need for a crisis management alert system to inform the public about crisis situations. The Federal Government created the Homeland Security Agency which determines the level of a potential crisis and alerts the public to that level through a series of color coded alert warnings. Television and radio stations broadcast these alert warnings as part of their news dissemination services.

Commercial businesses, schools and governmental agencies typically rely on phone trees or prerecorded messages to provide emergency information. These systems require the particular members of the enterprise or school to have a reasonable apprehension that such information will be available and ready access to a telephone or computer. For example, during inclement weather, a business may provide a call-in telephone number for its employees to determine whether the office will be closed or open for business that day. Such warnings also can be provided on a web site over the Internet or broadcast through normal television or radio broadcast stations.

Some Web based companies allow Internet users to sign-up for news releases or information about special sales promotions on merchandise. Such information is delivered to the Internet user's e-mail address.

None of the above-described systems provide any flexibility with respect to how the users or members of the enterprise or school are to be contacted. In addition, the above-described systems either deal with catastrophic crises or disseminate information which is of interest to the member, but do not provide alerts in both situations.

### SUMMARY OF THE INVENTION

A first exemplary embodiment of the present invention involves an interactive crisis management alert and information system which is particularly applicable for schools. The system is interactive in that it allows the legal guardian of a student (hereinafter “the parents”), to register who, why and how certain persons are to be notified about a crisis, and what types of information can be disseminated to those persons.

In the wake of the tragic events surrounding 9/11 it has become incumbent on everyone to become more security conscious. The confusion and inability to get instructions—and information—was dramatically underscored that day. However, it does not take a 9/11 event to dramatize the need for an emergency notification system—even within school systems.

The need exists to effectively deal with other events such as, for example, severe weather, hazardous material spills, Homeland Security alerts, and weapons within the schools. The need also exists to communicate certain information between the school and guardians, events of various urgencies such as, for example, absence or truancy of students, cancelled soccer practice, need for chaperones for a field trip, PTA meetings, and special event announcements. The inventive system is not meant to replace the school's existing Emergency Preparedness Plan, but instead is provided to help the school become an effective user of an automated notification system for various crises or events.

In case of an emergency, the school is responsible for the safety and well being of its students. Therefore in an emergency, there is a general need to get the right information to the right people at the right time. The inventive system takes into account the additional key factors:
Emergency situations are more varied than in times past.
Situations require greater flexibility in response than ever before.
Communicating the nature of the emergency and the response taken are both critical.
Correct response to an emergency requires student information that is complete and up-to-date.
Emergencies require that parents have access to current instructions without having to call the school.
Advance communication of key plan components is not allowed.
   History has shown us—repeatedly—that phone trees and the like break down. The improved inventive system provides a process that pre-defines situations, organizes responses, designates recipients of appropriate messages and supports all reasonable communication alternatives. The inventive system also provides for an automated means to support that process.

The inventive system has great utility in today's environment because it not only deals with emergency or crisis situations, but also is capable of use for day-to-day routine communications. Thus, although the system's focus is on crisis situations, it should be kept in mind the advantages of also having a system for day-to-day communications between the school and parents.

In times of crisis situations, a school's specific need is to take action appropriate to the situation, and to notify appropriate parties as to what they should expect and what they are expected to do. The following chart depicts a subset of potential steps that are carried out by the system as a result of a chemical spill crisis.

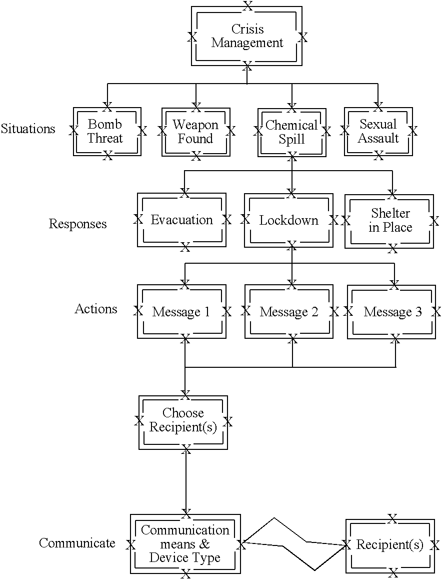

The chart indicates that handling of a crisis will involve:
Crisis Situation Occurs
   Upon recognition of a crisis, there must be some assessment of how encompassing the threat is, and deal with it accordingly.
Formulate the Response
   The response will vary from informing necessary parties to evacuation of the school based upon the scope and nature of the emergency. Of course, the response will be handled more efficiently if it has been planned (and practiced) in advance.
Create Appropriate Messages for Dissemination
   If the school planned for the general circumstance, a general message will have already been formulated. The school must tailor a specific message(s) to fit the specific situation.
Choose Recipient(s)
   Recipients appropriate to the circumstance are selected to receive messages. This step is greatly facilitated by groups of individuals having been previously defined as potential recipients, and the mode of communications having been pre-defined.
Communicate the Messages
   Send the messages electronically (using pre-designated means by individual recipient) to the designated recipients. Means for sending messages should be available by regular phone, wireless phone, pager, facsimile machine and/or e-mail.
Recipients Receive the Messages
   When the messages are received, the information in the message(s) should provide basic information regarding the event, a description of the current situation, what the recipients should expect, and directions as to what the recipients should do (and not do).

During a crisis, the expected response by parents, the media and community residents may create chaos—unless a comprehensive, proactive plan is in place. In a major emergency the phone lines may be overloaded. Thus, the system does not rely on phone lines as the only communications vehicle. Schools must be prepared to evacuate the school at any time or take other, less drastic, measures.

In setting up the inventive system, the school must first confront a series of hard questions to help determine how effective the school will be in a crisis. The school must also consider the myriad types of major emergencies that a school might be forced to confront. The following exemplary list of potential emergencies serves to focus on the types of situations the school should prepare for:

| | | |
|---|---|---|
| Bomb Threat | Chemical Spill | Student Disorder |
| Nearby Explosion | Hurricane | Snow Storm |
| Tornado | Flood | Fire |
| Hazardous Material | Power Outage | Personal Emergency |
| Severe Windstorm | Hostile Intruder | War |
| Weapon Found | Escalated Homeland | Fog |
| | Security Alert | |
| Bus Accident | Gas Odor | Hostage Situation |
| Kidnapping | Medical Emergency | Missing Student |
| Public Demonstration | Sexual Assault | Shooting/Stabbing |
| Air Contamination | Water Contamination | Food Contamination |

Key questions that elicit the data needed to be loaded into the system include:
a. What is the worst type of crisis that the school might encounter?
b. What is the second worst crisis that the school might encounter?
c. What are the recurring crisis situations that might have to be dealt with?
d. Who makes decisions for various levels of crisis?
e. What are the required roles within the school administration to manage the various types of critical situations?
f. What if the phone system is unavailable?
g. What kind of actions will be necessary for each of these?
   Staging areas
   Lockdown procedures
   Evacuation procedures
   Training
   Communications vehicles
   Practice implementations
   Backup procedures in case of disaster at the school (for instance, how to deal with a situation where the school is without its computer system, i.e., a power outage or fire).
h. Who should be contacted in these situations (which groups of people)?
i. Does the school have alternate means to communicate with parents?
j. Who will set up the necessary procedures, and who will implement them?
k. How will the word get to groups that are away from the school grounds as to what they should do?

To obtain answers to the above questions and to implement the system it will be necessary to form a Crisis Management Team (CMT) to provide leadership and oversight as the accountable authority. The school will need to assign personnel to fill the roles that are defined below. The school must identify the types of crisis situations that need to be addressed first and formulate a plan that is all encompassing over time. A list of groups of people that need to be notified when crises occur must be formulated. Finally, the identification of routine communication events that will be handled easier with the inventive system should also be identified and the corresponding list of groups should be created.

The entire CMT team does not need to be defined and assigned designated roles at the very beginning. However, at least the following roles should be filled to ease the implementation of the system:
Incident Supervisor—makes decisions based on available information
Off-site Evacuation Coordinator—responsible for organizing evacuation of students
Student Accounting Leader—responsible for an accurate accounting of all students
Parent Liaison—responsible for disseminating information to parents
Communications and Recorder—responsible for contacting 911 and requesting necessary resources
Executive Administrator—oversees system data, maintenance and operation

The above positions represents the core group of the CMT. Of course, the school may initially assign each team member multiple roles expecting to eventually limit each person to a single role. It may be prudent to assign persons to fill in as backups to each role (since emergencies seldom happen when all the key players are in attendance).

There are a number of steps that the school should take in preparation for effectively dealing with emergencies through the facilities of inventive system. However, not all of these steps have to be done before effectively using the system.

For example, the school does not have to have all of your crisis situations covered prior to using the system. They can, and should be, phased in. In fact, initially the system can be used for day-to-day fairly routine communications as emergencies are added into the mix.

Data that defines all students, parents and faculty should be provided so heads of household, family members and students can be defined to the system software. At a minimum the list should contain the following distinct fields:
First Name
Last Name
Unique Identifier such as Social Security Number
   The data should be contained in an Outlook or Excel file in that the system software has an Import Wizard that quickly, and accurately, imports the data into its system database. In order to fully function, the school must have a Web Site address. The address is necessary because the system operates as an Internet application that uses the school computer as a Web server. The software can be accessed through the URL of the school Web Site.
Although most households have access to the Internet by computers in their home or office, some will not. Alternative means of registering those households should be provided. Schools can successfully implement one or two different ways to accommodate those families lacking computers:
1) Phone Registration: Allocate one or more trained staff members to receive phone calls from parents to register families.
2) Computer Kiosks: Create one or two kiosks where parents can register their family using computers at the school.

Using the table below, for example, the school can identify the types of critical situations to be planned for. Of course, the school may add and/or subtract entries as needed. In addition to providing a “Response” for each “Situation,” the school should also provide a ranking of the “Priority” of each “Situation.”

| Situation: | Response: | Priority: |
|---|---|---|
| Air Contamination | | |
| Aircraft Endangerment | | |
| Animal Disturbance | | |
| Bomb Threat | | |
| Bus Accident | | |
| Chemical Spill | | |
| Earthquake | | |
| Explosion | | |
| Fire | | |
| Flood | | |
| Food Contamination | | |
| Fog | | |
| Gas Odor | | |
| Hazardous Material | | |
| Homeland Security—Red Alert | | |
| Intruder in School | | |
| Hostile Intruder | | |
| Hurricane | | |
| Kidnapping | | |
| Medical Emergency | | |
| Missing Student | | |
| Nearby Explosion | | |
| Personal Emergency | | |
| Power (Utility) Outage | | |
| Public Demonstration | | |
| Severe Windstorm | | |
| Sexual Assault | | |
| Shooting/Stabbing | | |
| Snow Storm (cancel or delay | | |
| Student/Civil Disturbance | | |
| Tornado | | |
| War | | |
| Water Contamination | | |
| Weapon Found | | |

More particularly, the school should identify the type of response (and actions) expected for each critical situation. The typical responses can be chosen, for example, from the following list:
Shelter In-Place—Student remain in their scheduled classes.
Take Cover—Students remain in their scheduled classes, but assume protective positions.
Lockdown—Students remain in their scheduled classes, but the doors of the school are locked preventing entrance and exit.
Vacate—Students vacate building, but go to designated locations on the school grounds.
Evacuation—Students are removed from the school to a predetermined off-site location.
All Clear—Emergency is resolved, so the students are to resume scheduled activities (or as directed).

Using the same table, the school should identify the implementation priorities for each situation. By prioritizing situations, the school will have defined a plan to attack most critical crisis situations first. The rest can be phased over time.
1: Implement immediately in preparation for the initial launch.
2: Planned for the 2^{nd} phase.
3: Planned for the 3^{rd} phase.
Use additional phases as necessary until your list is exhausted.

The school should identify the types of groups that are to receive messages in various crisis situations. Crisis situations will vary in scope thereby impacting a few people (parents of a student), mid-size groups (teachers and students in a class) or the entire student body (and faculty).

The following table provides examples of groups and should not be considered as limiting or exhaustive.

| Groups: | Content/Use: |
|---|---|
| Bus Drivers | All bus drivers supporting the school. |
| Bus Riders | All riders of a specific bus |
| | (students and driver). |
| Bus Rider Parents | Parents of all riders of a specific bus. |
| Class Members | Teacher and all students of a specific class. |
| Class Parents | Teacher and all students of a specific class. |
| CMT Members | Members of the Crisis Management Team. |
| Counseling Team | Designated personnel with basic counseling |
| | skills. |
| Family | Identifies the parents, other household |
| | members and students. |
| Faculty | All members of the faculty of the school. |
| Field Outings | All students, teachers and chaperones of |
| | a field trip. |
| First Aid Team | School staff with first aid training. |
| Grade Level | All students of a specific grade level. |
| Homeroom | Teacher and students in a specific homeroom. |
| Homeroom Parents | Parents of all students of a specific |
| | homeroom. |
| Media (Crisis) | Media contacts for crisis situations. |
| Media (Weather) | Media contacts to cancel or delay opening |
| | of school. |
| PTA Members | Members of the Parent Teachers Association. |
| School District | Administrative members of the school district. |
| School-Sponsored | Sponsors and students of various school-sponsored |
| Activities | activities (Spanish Club, Choir, Cheerleaders, |
| | Band, National Honor Society, etc.). |
| Search & Rescue | Team members with training in search and |
| | rescue. |
| Student Body | All of the students enrolled at the school. |
| Staff | Nurses, administrative and custodial staff |
| | (non-faculty employees). |
| Teams | Coaches, players and student managers that |
| | comprise teams. |
| Team Parents | Parents of all students of a specific team. |

The school should identify the specific groups that are to receive messages for specific crisis situations. There will usually be multiple groups that require information based upon the nature and scope of the crisis.

| Situation: | Response: | Priority: | Groups: |
|---|---|---|---|
| Air Contamination | | | |
| Aircraft Endangerment | | | |
| Animal Disturbance | | | |
| Bomb Threat | | | |
| Bus Accident | | | |
| Chemical Spill | | | |
| Earthquake | | | |
| Explosion | | | |
| Fire | | | |
| Flood | | | |
| Food Contamination | | | |
| Fog | | | |
| Gas Odor | | | |
| Hazardous Material | | | |
| Hostage Situation | | | |
| Intruder in School | | | |
| Homeland Security—RedAlert | | | |
| Hurricane | | | |
| Kidnapping | | | |
| Medical Emergency | | | |
| Missing Student | | | |
| Nearby Explosion | | | |
| Personal Emergency | | | |
| Power (Utility) Outage | | | |
| Public Demonstration | | | |
| Severe Windstorm | | | |
| Sexual Assault | | | |
| Shooting/Stabbing | | | |
| Snow Storm | | | |
| Student/Civil Disturbance | | | |
| Tornado | | | |
| War | | | |
| Water Contamination | | | |
| Weapon Found | | | |

As the above tasks are completed, the system software should be installed. The actual install process can be done in minutes. This can occur while the CMT continues to more fully complete the school's plan.

As noted above, there was a need to provide authentication data that defines the students, parents and faculty. In order to prevent unauthorized intruders from hacking into the software, the system has a robust authentication technique. Based on the direction of the CMT, each head of household must match designated data to be provided access. At a minimum, the software forces the head of household (and other family members or students) to match the data they enter when being registered to a Social Security number, first and last names. If the data is available in what is provided for authentication, other fields may be authenticated. The authentication data is loaded into the system database for subsequent use for authentication.

The process then begins with the school (or school system) sending a letter to the household of each attending child. This letter instructs the head of household how to register within the system. The letter will contain the Web Site address to be used for registration.

The Head of Household is solely allowed to input family and contact data, and to update or revise family and contact data to the system. However, the Head of Household is allowed to delegate their authority to other family members or friends.

For those crises requiring evacuation of the school, the Head of Household can name those persons to whom the school can release the student(s). The system, at a time of crisis, can allow a specific period of time (for example 30 minutes) in which the Head of Household can update or revise his/her custody profile. For example, within the specific period of time after notification of a crisis, the Head of Household could add a family member or friend to the custody profile thereby allowing the added person to pick-up the student(s) at the school.

The system, at the conclusion of the specific period of time, generates an updated custody report which lists the persons who can pick-up specific students.

In order to prepare for actual use of the system, the Administrator should begin entering data based on the situations and responses targeted by the CMT. Testing of the system is best accomplished by limiting the situations and responses so the Administrator can focus all attention on a few test cases. This approach is not only more manageable; it is also more efficient and effective.

It is important to test the creation of a family scenario first (from registering head of household to changing family member records). After registering the head of household of a family, additional facilities are provided to:
Identify Family Members—Select students and other family members that comprise the family.
Define Relationships—Identify how students and other family members relate to the parents/guardians.
Define Physical Locations—Identify physical locations (home, after-school care site, vacation home) of the family.
Identify Virtual Locations—Virtual locations are e-mail addresses, phone numbers and pagers available to the family.
Identify Emergency Contacts—Specify family members (and means of communication) that should be contacted in emergency situations.
Specify Alert Options—Based upon level of alert (crisis), choose one or more ways to send the alert message.

The definition and maintenance of groups is a key component of the success of the crisis management process. A group can be any combination of students, faculty and staff that share something in common related to the school. There are countless groups within a school. Consider the following:

| | | |
|---|---|---|
| Crisis Management | Football Team | Bus Driver & Riders |
| Team | | |
| Cheerleaders | Band | Chess Team |
| First-Aid Team | Substitute Teachers | PTA |
| Softball Team | French Club | 6^{th} Graders |
| Coaches | School Paper Staff | Trained Counselors |
| Mrs. Jones' Class | Media Contacts | School District |
| | | Contacts |

Groups are important because they are the targets of all communications to be issued by the system. Whether a crisis or mundane event, there is typically the need to send a message to members of one or more of these groups. The system makes it easy to create groups because the data associated with each person (student, faculty, staff or parent) has already been gathered. One need only choose individuals from lists of persons presented. Initially, only a few groups need to be created—enough to test the notification processes selected for testing.

In order to be ready for emergencies, certain lists (in paper form) must be available. Some will be for distribution to involved parties for review, confirmation and reference. Others must be printed for inclusion in a Critical Response Kit or Go Kit (to be described in greater detail later).

The system allows for the definition (and maintenance) of alerts and the dissemination of non-emergency information. The system provides the means to identify targeted crisis situations and routine situations. Thus, the system handles crisis situations by effectively communicating information and directions in their midst. However, the system will most often be used to notify various individuals of scheduled meetings, canceled or postponed games, and otherwise send routine messages. The building of crisis alerts is a work in progress as they are defined on a phased basis based on the priorities set by the CMT. The mundane alerts can be created on an as-needed basis.

System testing should at least initially relate to alerts in crisis situations. Tests should be set up so that groups are tested with respect to various modes of communication (e-mail, wireless and wired phone, pager, etc.). Tests should, however, include both emergency and non-emergency situations. The system should not be launched until the CMT is fully satisfied that implementation goals of the system have been met.

The most important considerations for launching the system are the following that relate to gathering family data:
Student, parent and faculty data has been successfully loaded into the system database.
The CMT has agreed upon an authentication scheme and that data has been successfully captured using the Import Wizard.
Your Web Site has been created and is accessible by parents and faculty for registration, logging in and maintenance of family data.
The Notification Letter has been created and addressed to heads of household for all students. The Web Site that enable the user to log in is accurately reflected in the letter, and the instructions on the letter clearly lead the recipient to the proper place to register.
The e-mail response to the registration of the head of household is ready and that the e-mail generation properly authenticates the head of household.
As stated previously, the school must have staff in place to register and update family information for those families without access to the Internet or e-mail. The load on this staff may be considerable at the start of a new school year, but will diminish quickly to a trickle, as updates are needed. The school may also consider providing access to heads of household by establishing computer kiosks for use by those without the necessary home Internet access.

An ongoing challenge to any program is to keep the information current. This will also be the case with the inventive system. Although family members change infrequently, e-mail addresses and phone number do change occasionally. The school should periodically (monthly) send out reminders to families to update changes.

The CMT should meet frequently in the beginning to assess progress and make necessary changes. There should be a plan in place for addressing additional crisis situations. As a result, the school will be more and more prepared to deal with emergencies over time. The CMT should be assigning responsibilities for crisis tasks to a more diverse group of individuals over time to minimize overloading responsibilities. This action also enables assigned parties to focus more closely on their assignments.

The following definitions for terms and items are pertinent to crisis management.

1) Off-Site Evacuation Location:

Identify Evacuation Sites: Identify alternate sites for off-site evacuation to be used for bomb threats or other such threats where students need to be moved a safe distance from the school. Churches, large buildings and other schools are potential evacuation sites.

Size of the Location: There must be adequate room for the students and faculty evacuated.

Access: Is the location within reasonable walking distance of the school? The walking route must be clear of fences, hazards or other obstructions.

Security: Can the site be secured from media or other groups seeking to interact with the students or faculty?

Shelter: Does the site provide protection from the weather? A lack of shelter at the evacuation site may require early dismissal rather than evacuation.

Ownership: Is the owner willing to provide access to the property in an emergency situation?

2) Staging Areas:

Command Post: It is essential that all decisions be coordinated with the various participating agencies during a crisis. The important information exchange that is critical to informed decision-making will only work if there is only one central location that is preset as the Command Post (CP). The CP will be located near the school, but out of any potential danger. The area must be sufficient to accommodate police and fire CPs (in addition to the CP of the school). It should not be near the Media Staging area. If the school is not evacuated, the CP should be inside of the school to facilitate communications.

Bus Staging Are a: This alternative bus staffing/loading area will be necessary when the school's off-site evacuation location is not sufficient to handle school bus traffic. This location will be used when students are dismissed from other than the primary school building. A nearby school will often be used for this purpose.

Media Staging: While controlling the media may not initially be top priority, failing to prepare for the media response can easily turn into a public relations nightmare. An emergency or crisis at a local school is a major news story, and will prompt major response from the local media. Crisis Management Teams must prepare for the media response while realizing that ignoring the media is not an option during a crisis. An ongoing problem is that media will often arrive at the same time as police and fire personnel. The location of the Media Staging area should be common knowledge so the media can be efficiently guided to their assigned location (away from other critical staging areas). The area should be sufficient to accommodate numerous vehicles without infringing on traffic flow.

Parent Reunion Area: Parents will inevitably arrive at the school to retrieve their children during incidents that involve violence or risk to students. This expected response must be anticipated and dealt with in such a way that disruption of efforts to deal with the crisis is minimized. A well-organized Parent Reunion Area will alleviate parent fears and efficiently deliver students to their guardians—all without interfering with crisis management. Everyone in authority must be able to direct parents and students to this area, which may or may not be on the school grounds. Churches, large buildings and other schools are potential sites if the campus is not feasible.

3) Lockdown Procedures:

An emergency situation may prevent the safe evacuation of a school, thus requiring steps to isolate students, faculty and staff from danger. This is the definition of a lockdown.

The principal, Incident Supervisor, or any staff member that observes a critical incident should be able to order a school lockdown. The Crisis Management Team should be assembled prior to announcing the lockdown, or immediately thereafter. Members of the team should report to the main office or command post identified in the announcement. The CMT will then plan for the next steps. The next steps will involve monitoring and intervening in the emergency, making notifications, ensuring lockdown procedures are in place, and that all students and faculty are secure. The dangerous situation must be isolated from most of the school.

Teacher Response: The teacher should take their class away from the threat if it is nearby and possible. Identify alternate sites for off-site evacuation to be used for bomb threats or other such threats where students need to be moved a safe distance from the school. Churches, large buildings and other schools are potential evacuation sites. If evacuation is not appropriate, do the following:
Immediately lock the doors.
If appropriate to the threat, sit the students on the floor away from doors and windows.
Take an accounting of students while listing extra or missing students. Take these lists with you if you leave the room.
Use discretion in permitting students entry into the classroom.
If a phone is available, keep the line open.
Keep calm and comfort the students until directed to leave by the police or CMT.

Threat Area: The Incident Supervisor must immediately assign someone to oversee the threat area (if appropriate) to ensure that others do not enter it inadvertently.

Hallway Evacuation: The Incident Supervisor must immediately send unassigned teachers to walk the halls placing wandering students into nearby classrooms.

Special Considerations: The playgrounds and ball fields should be paid special attention because of their possible remoteness. Special attention should also be paid to the cafeteria, library and auditorium.

4) Evacuation Procedures:

An evacuation involves moving the student body and staff off the school campus to a pre-determined site. The following are important points:
Need for Evacuation: Bomb threats and chemical spills are two examples of when emergency situations may require evacuation beyond the normal fire evacuation locations. You must identify off-site evacuation locations for the school and assign someone to oversee these sites.
Evacuation Route: The evacuation route must be able to accommodate the large student movement while not exposing students or staff members to danger. In the case of a bomb threat, the evacuation route should avoid school parking lots, large containers and other areas where explosive devices might be hidden.
Chemical Concerns: Added concerns of chemical incidents include wind direction and avoiding walking into danger.
Evacuation Signal: The signal for evacuation can be communicated in several ways that should be noticeably different from an alarm for a fire. Acceptable signals include a unique bell signal, code announcement, or plain language verbal announcement.
Bomb Threat Concerns: Specific staff members should be trained to check the halls and rooms for suspicious packages. They should be instructed what to do if any are found. Radio use must be curtailed if a bomb is involved since many are detonated by an electronic signal.
Rosters: Each teacher must take their roster of students under their control (and those missing) to the evacuation site to account for all students.
   5) Critical Response Kit:

A large duffle bag should be purchased to serve as what is also known as a “Go Kit” for the school. These items may also assist police and fire personnel in dealing with a school crisis. This should be pre-filled with the following items to help deal with emergencies:

| | | |
|---|---|---|
| Bell Schedule | Charged Batteries | Critical Incident Plan |
| Emergency Care | Faculty Emergency | First-Aid Kits |
| Cards | Contacts | |
| Flashlights | Incident Recorder Log | Latex Gloves |
| Map (Footprint) of | Master Bus Schedule | Master Roster of All |
| School | | Classes |
| Note Pads & Pens | Phone List | Phone List (Home & |
| | (Emergencies) | Cell) |
| Phone List (Internal) | Portable Radio List | Resource Skill Lists |
| Students Needing | Support System | CMT Assignments |
| Special Assistance | Locations & | |
| | Instructions (Water, | |
| | Electric, Gas, etc.) | |

6) School Partnerships:

A partnership with another nearby school will be helpful to both schools in dealing with an emergency where an evacuation is necessary. Factors for consideration include:
Choosing Off-Site Location: The grade levels at your school, proximity of the location, and safety of the route are important consideration in choosing alternate sites. The school's ability to absorb the students is also significant.
Infrastructure: Another school already has phones, computers and school bus areas in place. These factors make another school better equipped to handle your evacuation.
Critical Response Kit Storage: You may permanently store your go kit at the partner school so one is always available.
Backup Site: The selected school would be a good candidate to by your backup, off-site location for the system in case your computer system is down.
Pre-Allocated Space: The partnered school must have a plan and the space available to absorb the evacuated students and staff. The host school may need to dismiss early or alter their schedules to accommodate your students.
   7) Practice & Training:

Training (drills) in dealing with emergencies must become a regular event during the school year. Preparation for a crisis can only be reasonable expected if the school practices dealing with such events.
Practice Is Essential: Recognizing and responding to a crisis takes practice.
CMT Discussions: It is impractical to practice all forms of crisis. However, they can be discussed. The more plans are reviewed; the better that plan will be executed. The resulting understanding will also enhance the comfort level of the faculty and prepare the school.
Training: The CMT should invest in training various staff members in areas where needed (first-aid, CPR, bomb detection, counseling, etc.). Once trained, the newly initiated can train others. Community agencies are often willing to equip others in necessary skills.
   8) Staff Resources:

Many of your existing staff have already been equipped with special training. In a crisis situation, members of the CMT need to know who is trained in what. Survey your teachers and staff to determine the special skills they already have and keep lists of those by skill.

These lists must be regularly updated to reflect newly trained personnel while deleting those who are no longer at the school. A sample list which can be maintained in the system database as well as in hard cover is shown below.

Resource Skill List
Skill:

| | | Home/ | |
|---|---|---|---|
| Name: | Room Phone: | Cell Phone: | Room #: |
| | ( ) - | ( ) - | |
| | ( ) - | ( ) - | |
| | ( ) - | ( ) - | |
| | ( ) - | ( ) - | |
| | ( ) - | ( ) - | |
| | ( ) - | ( ) - | |

9) Crisis Phone Directory:

In schools without the system there would be a need to separately maintain various phone lists including phone trees for the CMT, parents, faculty, staff, and others. With the system, such lists can be easily maintained and generated as a natural by-product.

The Administrator simply creates a group comprised of each desired grouping, and regularly prints that list. Those lists that are desirable (and should be included in the Crisis Response Kit) include the following:
Roster for Entire Student Body with Guardian Contact Data
Classroom Rosters with Guardian Contact Data
Bus Rosters with Guardian Contact Data
CMT Roster with Assignments & Home Contact Data
Emergency Contact Data
Media Contact Data
   10) Backpack Letters:

Backpack letters represent the traditional means of schools to the families of its students. Such letters have some disadvantages including:
The success of a letter reaching the parent is in the hands of the student-often an unreliable means of communications.
Although relatively inexpensive, it is still something that requires the labor of your staff, the use of copying machines (or printers) and the cost of paper.

The system offers a less expensive alternative to communicate with parents through e-mail (although not all households have e-mail access).

Regardless of the means to send letters, the following are important considerations in communicating with parents with “backpack letters”:
Letters, written in conjunction with public safety officials, can be an effective way of relying important and helpful information.
Letters can be re-read and used as a reference tool.
Letters to the home following a crisis provide the opportunity to:
   Explain the existing situation.
   Describe steps taken by the school to ensure student safety.
   Inform parents how they can support their children.
The decision to send Letters to the home are based on answers to the following questions:
   Are other children or adults endangered by the situation?
   Are others likely to be at risk in the future?
   Are there actions that parents should take to further protect their children?
   Are there harmful rumors relating to the school that need to be addressed?

A key feature of the system is that the Head of Household has personal control over critical communications. In addition, the Head of Household has complete access to his/her children's profiles and the ability to delegate his authority or to add additional members to the custody profile. Non-Head of Household members have access to read family and relationship data, but cannot make any changes in the data.

### BRIEF DESCRIPTION OF THE DRAWINGS

FIG. 1 is a schematic diagram showing the system components and connections to user components;

FIG. 2 shows a household profile screen;

FIG. 3 shows an authorized user group management screen;

FIG. 4 shows an administrator's group screen;

FIG. 5 shows a send an alert screen;

FIG. 6 shows the schoolhouse alert architecture;

FIG. 7 shows the registration/login screen;

FIG. 8 shows the registration instructions screen;

FIG. 9 shows the privacy and confidentiality statement screen;

FIG. 10 shows the initial registration screen;

FIG. 11 shows a completed registration screen;

FIG. 12 shows the registration congratulation screen;

FIG. 13 shows a sample registration e-mail screen;

FIG. 14 shows the registration error message screen;

FIG. 15 shows the initial head of household screen;

FIG. 16 shows a completed head of household screen;

FIG. 17 shows an administrator's primary profile management screen;

FIG. 17A shows an administrator's primary profile summary screen;

FIG. 18 shows a member's primary profile screen;

FIG. 19 shows the initial primary profile folder screen;

FIG. 20 shows the completed primary profile folder screen;

FIG. 21 shows the initial family member folder screen;

FIG. 22 shows the add member—family members folder screen;

FIG. 23 shows the add student—family members folder screen;

FIG. 24 shows the add non-student—family members folder screen;

FIG. 25 shows the family members folder with list screen;

FIG. 26 shows the initial relationship folder screen;

FIG. 27 shows the updated relationships folder screen;

FIG. 28 shows the initial physical locations folder screen;

FIG. 29 shows the empty physical locations folder screen;

FIG. 30 shows the completed physical locations folder screen;

FIG. 31 shows the physical locations folder—list screen;

FIG. 32 shows the initial virtual locations folder screen;

FIG. 33 shows the new virtual locations entry screen;

FIG. 34 shows the completed virtual locations entry screen;

FIG. 35 shows the virtual locations folder list screen;

FIG. 36 shows the initial emergency contacts folder screen;

FIG. 37 shows the add new emergency contacts screen;

FIG. 38 shows a completed emergency contacts screen;

FIG. 39 shows the emergency contact folder—list screen;

FIG. 40 shows the initial alert option folder screen;

FIG. 41 shows a sample alert options screen;

FIG. 42 shows the administration greetings screen;

FIG. 43 shows the greeting screen;

FIG. 44 shows the alert list screen;

FIG. 45 shows the create alert screen;

FIG. 46 shows a sample completed alert screen;

FIG. 47 shows the alert edit screen;

FIG. 48 shows the group list screen;

FIG. 49 shows the creative group screen;

FIG. 50 shows a sample completed group screen;

FIG. 51 shows the group edit screen;

FIG. 52 shows the Web site administration screen;

FIG. 53 shows a sample add entry screen;

FIG. 54 shows the alert situation entries screen;

FIG. 55 shows the alert authority entries screen;

FIG. 56 shows the authentication codes entry screen;

FIG. 57 shows the counties entries screen;

FIG. 58 shows the countries entries screen;

FIG. 59 shows the device entries screen;

FIG. 60 shows the ethnicity entries screen;

FIG. 61 shows the grade levels entries screen;

FIG. 62 shows the health condition entries screen;

FIG. 63 shows the language proficiency entries screen;

FIG. 64 shows the medicine entries screen;

FIG. 65 shows the member status entries screen;

FIG. 66 shows the message delivery entries screen;

FIG. 67 shows the permission entries screen;

FIG. 68 shows the personal account status entries screen;

FIG. 69 shows the relationship entries screen;

FIG. 70 shows the relationship role entries screen;

FIG. 71 shows the school role entries screen;

FIG. 72 shows the type of group entries screen;

FIG. 73 shows the state entries screen;

FIG. 74 shows the zip code entries screen;

FIG. 75 shows the Web site administration screen;

FIG. 76 shows the system configurations screen;

FIG. 77 shows the school house alert help screen;

FIG. 78 shows the contents tab of the screen shown in FIG. 77;

FIG. 79 shows an open chapter of the contacts contents tab shown in FIG. 78.

FIG. 80 shows the index tab of the screen shown in FIG. 77;

FIG. 81 shows the search tab of the screen shown in FIG. 77;

FIG. 82 shows an alerts report screen;

FIG. 83 shows a child pick-up report;

FIG. 84 shows an unregistered people report;

FIG. 85 shows an alert history report; and

FIG. 86 shows details of the alert history report.

### DETAILED DESCRIPTION OF THE INVENTION

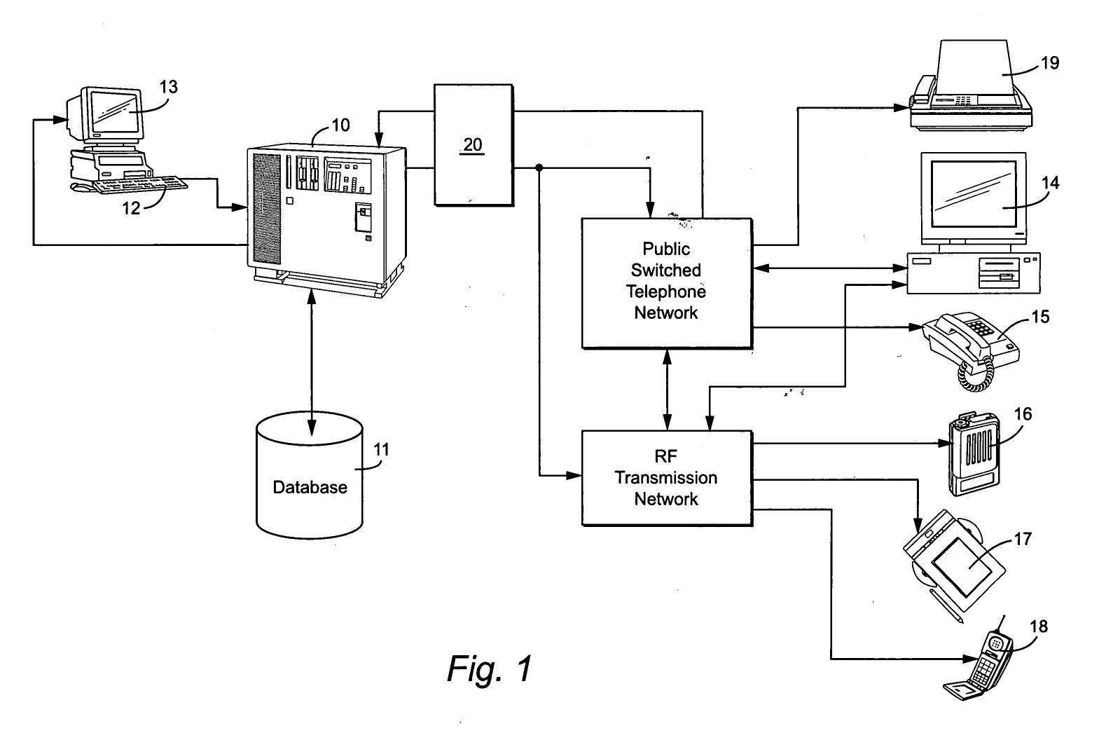

FIG. 1 shows the major components of the system to be server 10, database 11, input means 12, such as for example a keyboard (shown) or mouse (not shown), monitor 13, and telecommunications equipment 20. Member or parent equipment can include computer 14, telephone 15, pager 16, PDA 17, cell phone 18 and facsimile machine 19. As shown in FIG. 1, these user devices are connected to server 10 by means of the public switched telephone network and/or the RF transmission network and telecommunications equipment 20. As will be understood by those skilled in the art telecommunications equipment 20 includes modems, Interactive Voice Response (IVR) units, automatic dialers, etc. More particularly, the system creates messages using the Voice XML 1.0 standard and telecommunications equipment 20 compatible with this standard is used to transmit the voice messages over the public switched telephone network and/or the RF transmission network.

As will be readily understood by those skilled in the art, server 10 is loaded with the crisis management alert and information system software and student data is loaded into database 11. Keyboard 12 and monitor 13 allow the system administrator to input data into server 10 and database 11. Likewise, computer 14 allows parents to access the system software loaded on server 10 during the registration process or subsequently to update certain data as will be described in greater detail below.

Crisis alerts and routine information can be disseminated from the system server 10 through the public switched telephone network and/or the RF transmission network and telecommunications equipment 20 to contact the parents' computer 14, telephone 15, pager 16, PDA 17, cell phone 18 and/or facsimile machine 19. The details of these connections between the components identified in FIG. 1 are well known to those skilled in the art and therefore will not be further described herein.

A typical hardware configuration will depend on the size of the system (i.e., number of users) but will comprise at least the following:
Server Class System, i.e., Dell Power Edge
Dual processors at 1 GHz cpu speed
1 GB RAM
2 RAID Volumes configured: RAID 1 and RAID 5 with a shared Hot On-Line spare
40 GB SCSI Ultra3 Drives (10K), two for the RAID 1 and four for the RAID 5, one additional drive for the on-line hot spare.
RAID controller with 4 channels and 128 Meg cache.
Redundant power supplies and cooling fans.
Redundant, dual port Network Interface cards (NIC), one for the user network and the other for the dedicated backup network.
Diskette Drive 1.44 MB for the Emergency Repair Diskette.
High Speed IDE CD-ROM Drive for system installation.

Preferably, a Pentium IV chipset is used, with a bus speed of 100-130 MHz minimum, and a clock speed of at least 1 GHz. At least 1 GB RAM is preferred, and Hard Drives should be formatted using the NTFS instead of FAT or FAT32 options. The number of drives depends on the type of RAID to be implemented for each drive, and the drives required to support the file layout mapping to be used for this application. The following table shows the recommended RAID implementation and file layout mapping.

| | | | RAID |
|---|---|---|---|
| Drive | Size | File Mapping | Level |
| C: | 8 GB | Program Files, OS, paging file, various | RAID 1 |
| | | agents, anti-virus | |
| D: | 28 GB | SQL Server 2000 files, User Database log | RAID 1 |
| | | files | |
| E: | 80 GB | User Database Data and Index files | RAID 5 |
| F: | 20 GB | Tempdb file | RAID 5 |
| G: | 160 GB | Database Backups, FTP files, etc. | RAID 5 |

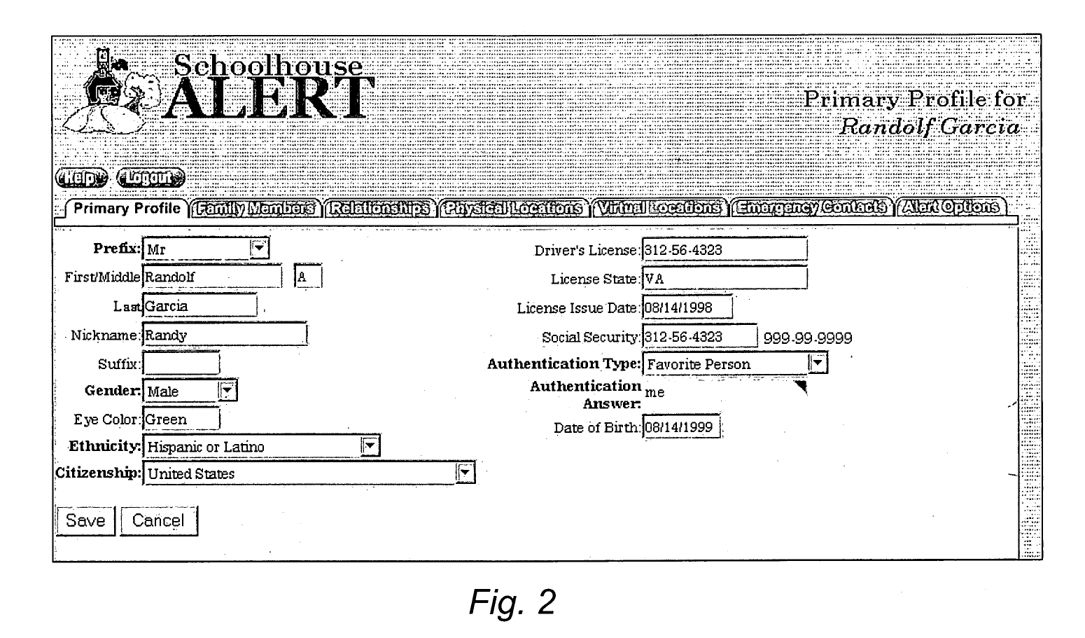

The method of inputting data through the use of particular screens as created by the system software will now be described. The information for the head of household (family and relationships) is captured in the User Profile screen shown in FIG. 2. In addition to key information about the head of household (user), the tabs (or folders) of this screen enable the family unit to be fully described. The content of each folder is briefly described in the following table:

| Folder/Tab: | Content/Us : |
|---|---|
| Primary Profile | Contains information that helps to identify the |
| | head of household |
| Family Members | Identifies the other members of the family |
| | including spouse, students or others |
| Relationships | Links each family member to others of the |
| | family and defines their relationship |
| Physical Locations | Defines alternate physical locations (i.e., |
| | neighbor's house, vacation home, home of |
| | divorced parent, etc. |
| Virtual Locations | Identifies how to contact each person through |
| | virtual devices (cell phone, e-mail, etc.) |
| Emergency Contacts | Defines a list of persons to be contacted for |
| | various types of emergency situations |
| Alert Options | For various emergency situations, defines the |
| | device and person to be alerted |

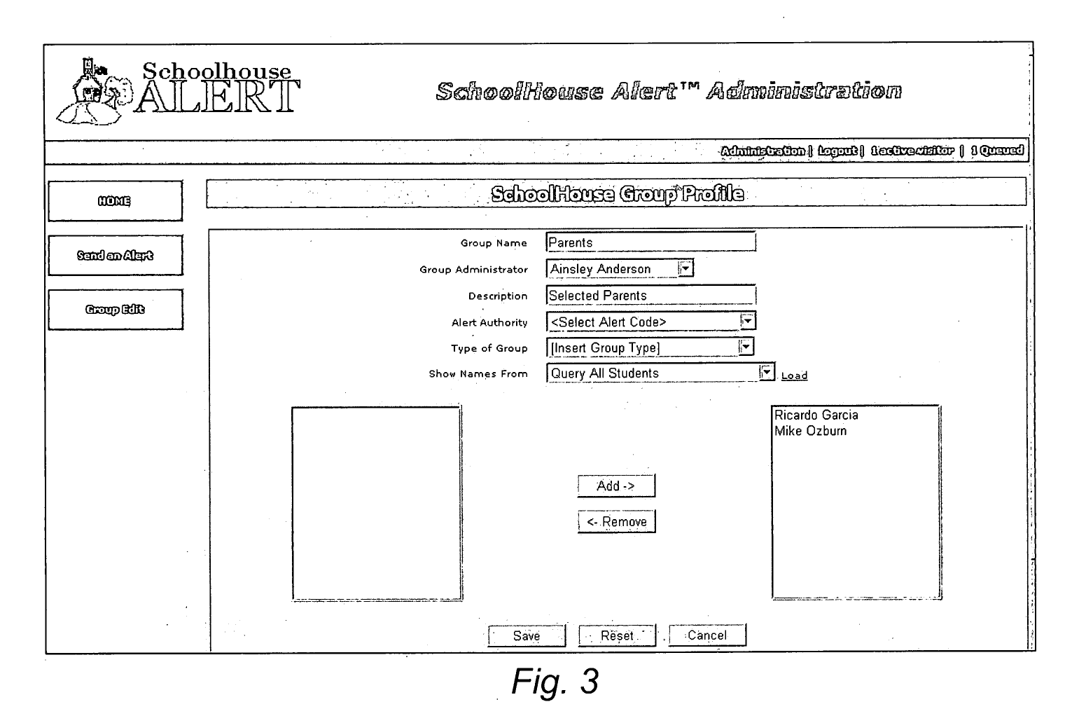

Once a household is set up with the User Profile and the Administrator establishes a group and authorization rights to that group, authorized users may manage that group through the screen shown in FIG. 3.

The authorized user can do the following:
Select the user group
Choose message types
Create a unique message or select from pre-packaged text and plans.

Messaging options should balance the need to notify an individual with the convenience of deciding how to receive the notification based on:
Enterprise defined Alert Levels
User defined preferences

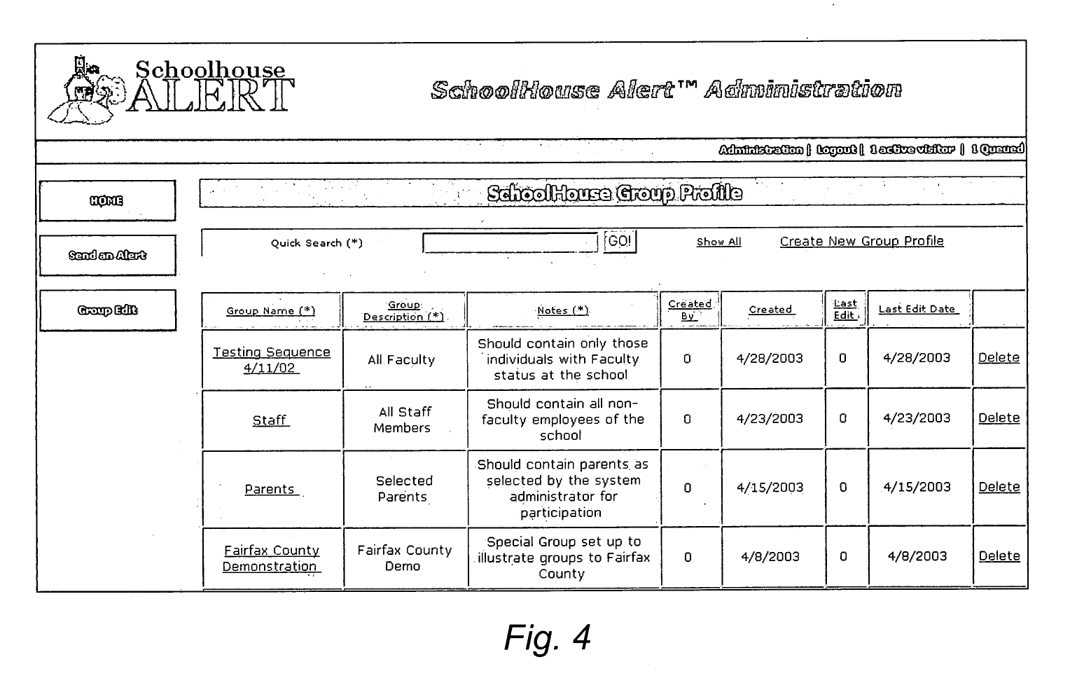

The Administrator (among other things) must define each group, and authorize users to custom tailor the choices within that group. As shown by the screen in FIG. 4, a group has the following key elements:
Unique group name
Description of the group
Notes that further describe the group
When the group was created and by whom
When the group was updated and by whom

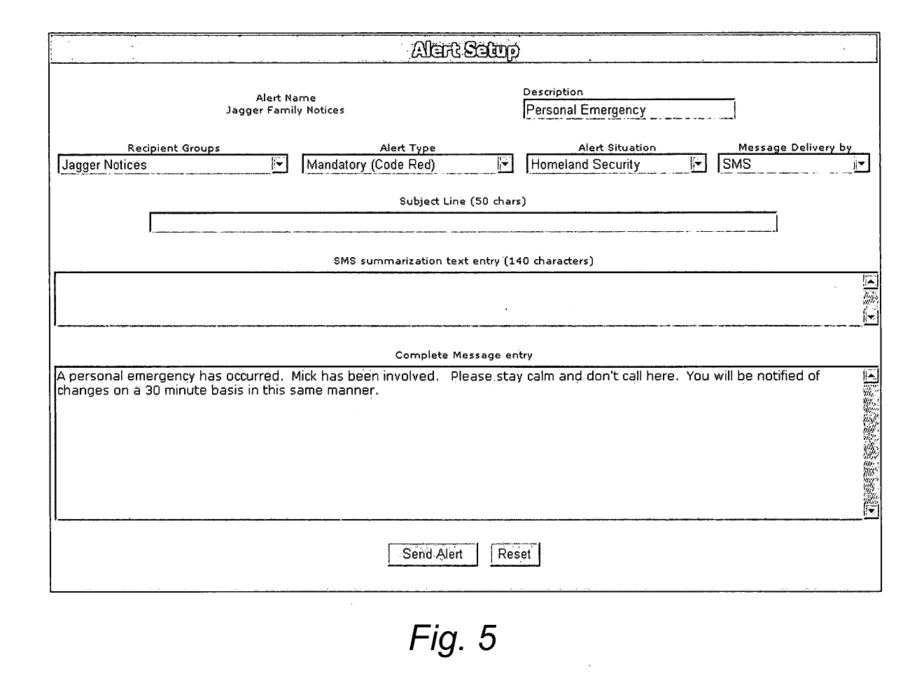

Once alerts have been set up by the authorized users in groups, when an emergency * arises, an Administrator will use the group to send the appropriate alert through the screen shown in FIG. 5. All of the necessary preparatory work has been done so that notification of an event can be communicated to interested parties in a matter of minutes.

The system software is preferably built with standards-based technology on an open and scalable architecture. The underlying database is preferably Microsoft's SQL Server, which is an industry standard in databases.

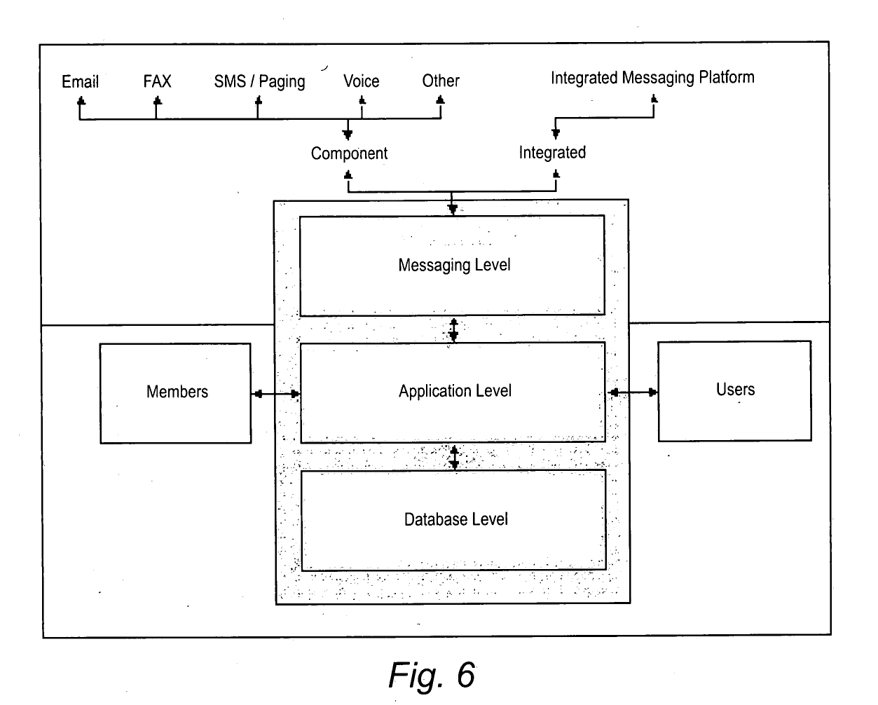

FIG. 6 shows the system architecture. The system is a repository of information about the family, their relationships, how to contact them and groups that need to be informed for various levels of emergencies. An alert message must be transmitted in various modes (e-mail, fax, pager, phone, etc.) to the appropriate person(s).

Over and above the benefits of a robust emergency messaging system, the system provides the following specific benefits:
A relations-based personal profile is established for each individual.
A roles-based framework for organizing and managing group communication is established (both formal and ad hoc groups).
An integrated content management framework is available to facilitate various plans, but utilizing standardized processes.
All of this is provided via a user-friendly, Web interface that increases useful interaction while minimizing administrative costs.

The following describes the value-added aspects of the system at various levels of alert notifications:
Improved communications during true emergencies.
User-controlled contact framework ensures most up-to-date contact information is made available.
System-based individual profiles provide basis for creation of a wide variety of “groups”.
User-controlled contact preferences permit users to receive the information that is relevant to each child.
Common framework improves communications between parents and school officials (teachers, advisors, coaches, etc.).
Convenient administrative tools allow the system to be used for ad hoc groups (task forces, teams, etc.) and special purposes (postponed or rescheduled event, special actions, updates, etc.).

None of the notification facilities of the system are available to a family unless the head of household (guardian) defines the family (and its members) to the system. The head of household must have access to the Internet on a computer to define the family.

If the family lacks access to the Internet with a computer, there are alternatives. First, the guardian could visit the school and use a computer reserved for such families. Second, the guardian could call the school and the staff of the school could enter the information.

The school will send a communique to the guardian of each child in their school (or school system). The letter identifies the Web Site address to be used for registration. This is the first of several steps in the process, which include the following:
1. Guardian receives communique from school with instruction on how to register as head of household.
2. Head of household registers self in the system.
3. The system software responds to registration by sending an e-mail to the head of household with authentication and instructions for logging in and completing the information about the family.
4. Head of household defines entire family, locations, means of communications and types of alerts to be used.
5. Head of household continually updates this information so notifications can be made when necessary.

The process begins with the school (or school system) sending a letter to the household of each attending child. This letter instructs the head of household how to register within the system. The letter will contain the Web Site address to be used for registration.

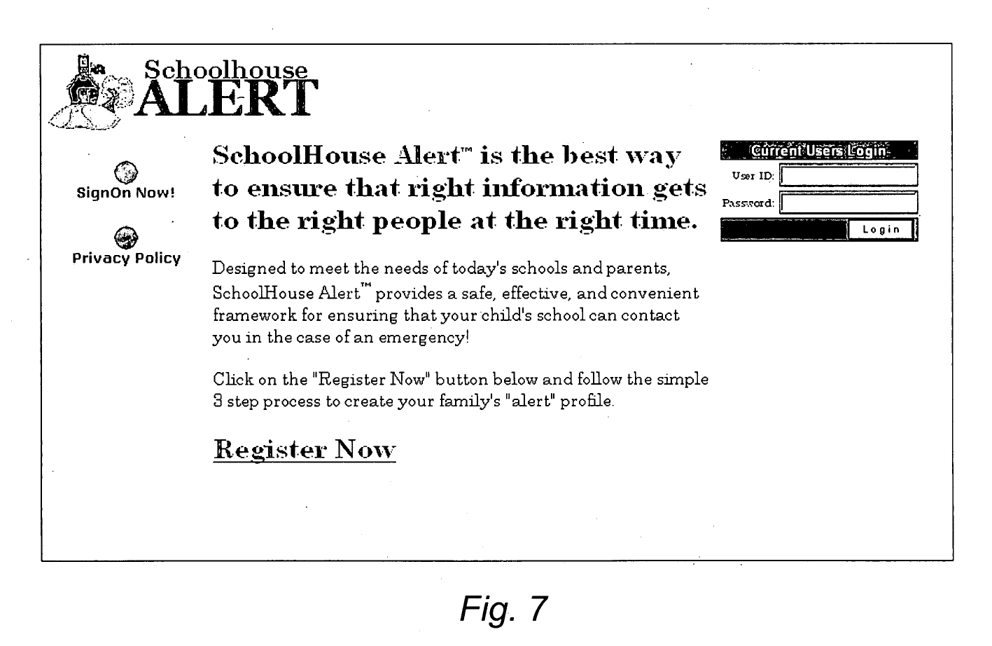

Upon receipt of the above-described letter, the head of household should respond with either a phone call to the school or by registering directly. Assuming the latter, the screen shown in FIG. 7 will be presented to the head of household when he/she uses the Web Site address provided in the letter.

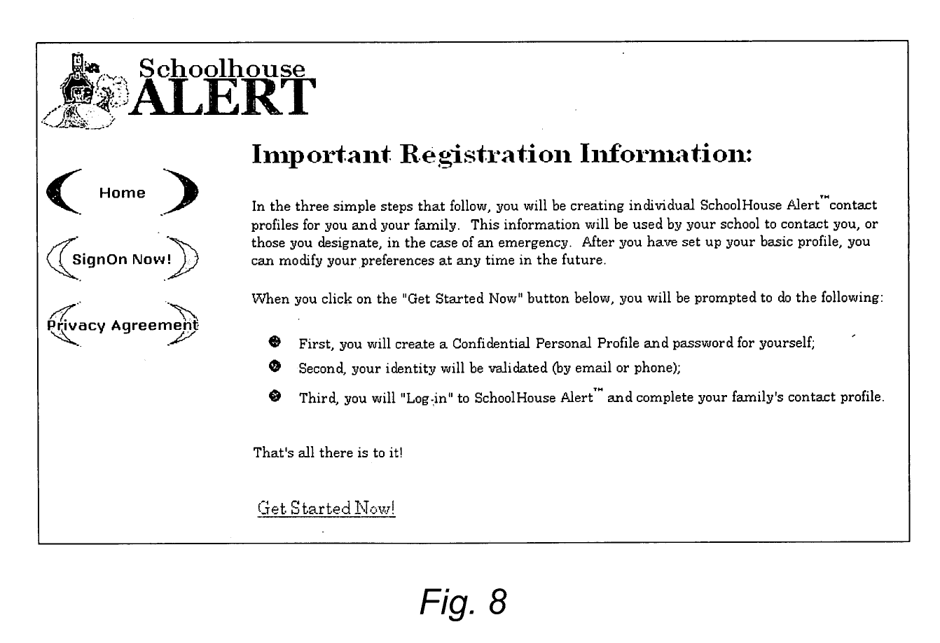

The head of household cannot login as yet since he/she has not defined his or her User ID or Password. If the SignOn Now button is pushed or the Register Now hyperlink is clicked, the screen shown in FIG. 8 is presented.

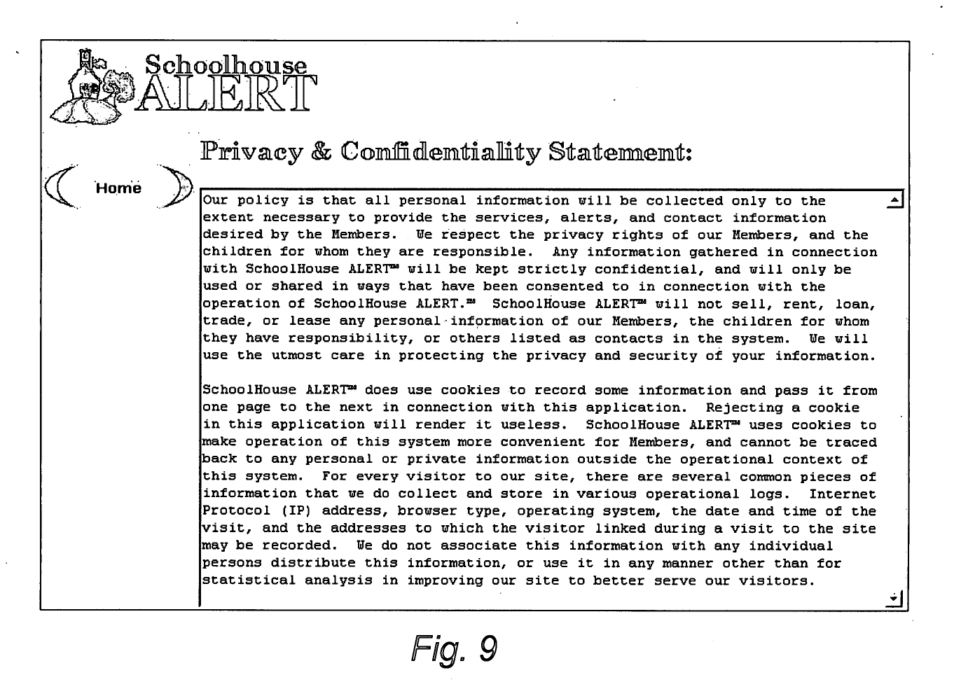

Clicking on the Privacy Agreement button will display the screen shown in FIG. 9. The user can continue after reading the agreement.

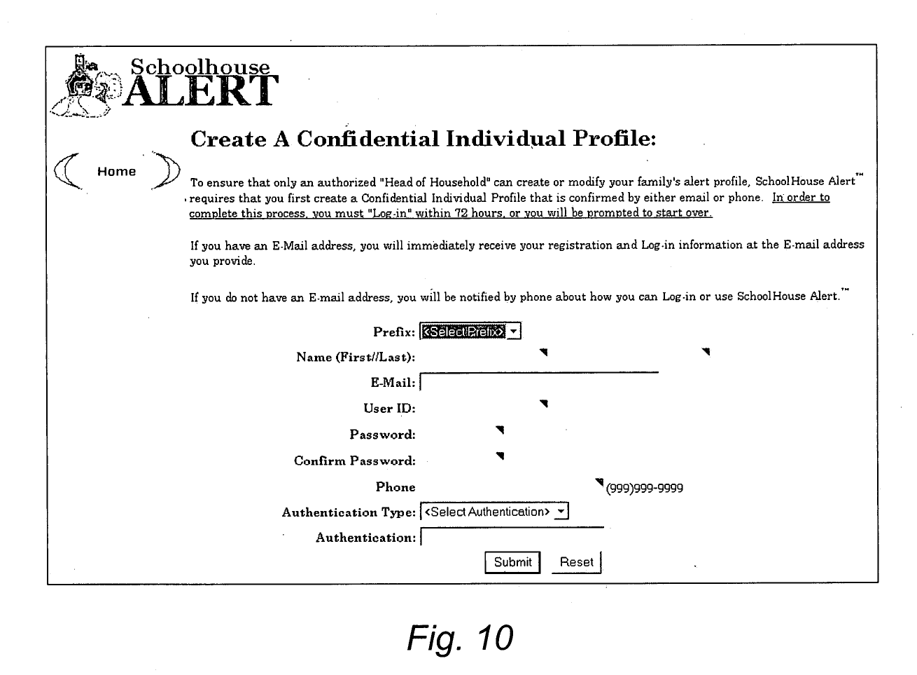

After reading the instructions, registration can begin by clicking the Get Started Now hyperlink at the bottom of the screen shown in FIG. 8. The screen shown in FIG. 10 will be presented to register as head of household.

This form, when properly completed, contains all essential information necessary to identify the head of household. Subsequently, this person will be permitted to login and complete the remaining information to be able to effectively communicate between the school and the family.

The following table (bolded fields are required) describes each field and its content:

| Field Label: | Content/Us : |
|---|---|
| Prefix: | Choose an appropriate prefix from the list |
| | in the dropdown provided. |
| Name (First/Last): | Enter both your first and last names. |
| E-Mail: | Enter your e-mail address if you have one |
| | at home or at work. If you have both, use |
| | the one accessible during the daytime |
| | hours. |
| User ID: | Enter an identifier for logging in to the |
| | system (your e-mail address will ensure |
| | that it is unique). |
| Password: | Enter the password you will use to login. |
| Confirm Password: | Confirm your password by re-entering it. |
| Phone: | Enter your phone number with area code with |
| | which we can contact you during the daytime |
| | hours. Please enter using the format indicated. |

The next two fields (along with User ID and Password)
must be supplied to successfully login.

| | |
|---|---|
| Authentication Type | Choose a selection from the dropdown provided |
| | to help us authenticate your identity. |
| Authentication | Enter your response to the previous selection. |

The following buttons are used to save or reset your responses:

| | |
|---|---|
| Submit | Save the data entered. |
| Reset | Discard the data entered. |

When the Submit button is pressed, the software will validate the inputted data. If required fields are empty or other errors are detected, the user will be prompted to correct the error(s). When the data is acceptable and Submit has been pressed, an e-mail will be sent to the user so that the user can login and complete the process by defining his/her family. The user cannot login until the e-mail is received because it contains an authentication code that is necessary to successfully login.

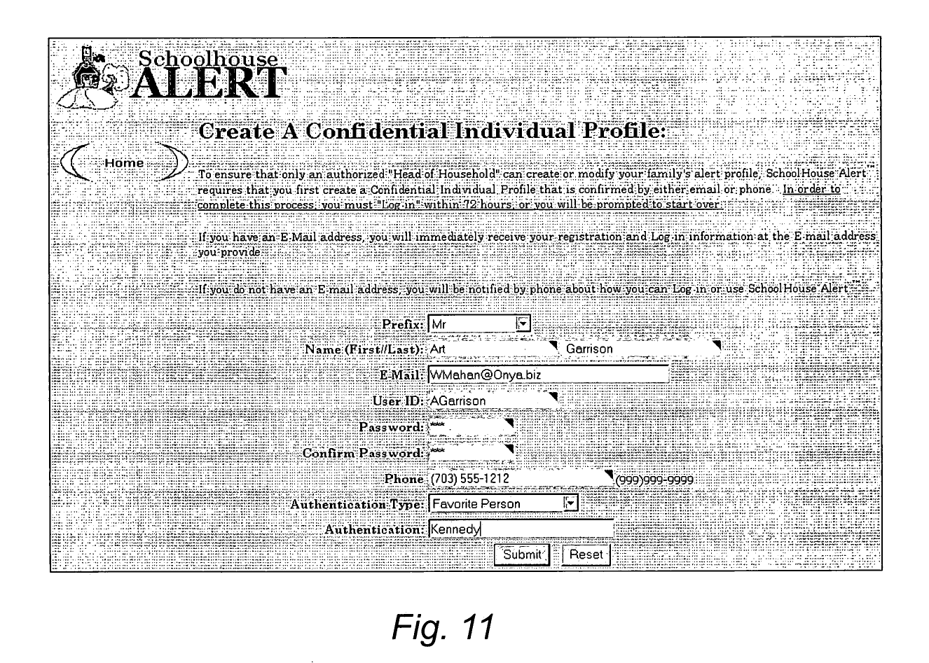

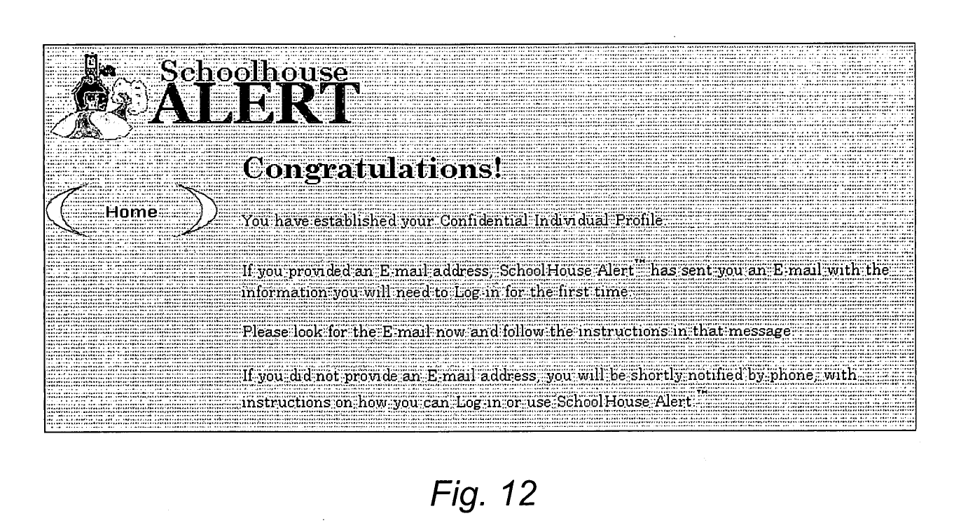

FIG. 11 shows a completed registration screen. If the registration is acceptable, the screen shown in FIG. 12 will be presented.

As noted above, if the user does not have access to a computer (nor the Internet) at home or the office, the user must call the school and provide a school staff member the information required by the system. The staff member will then enter the information on the user's behalf. If the user has access to a computer and the Internet, but does not have e-mail, then the user must call the school and provide authenticating information to validate his/her identity and the school staff will provide the authentication code. Subsequently, the user can operate as others and enter family data.

The system will not permit the user to login with the User ID and Password since the system automatically assigns a unique authentication code. The software is extra careful in permitting access to the system because of the damage potentially done by unauthorized users.

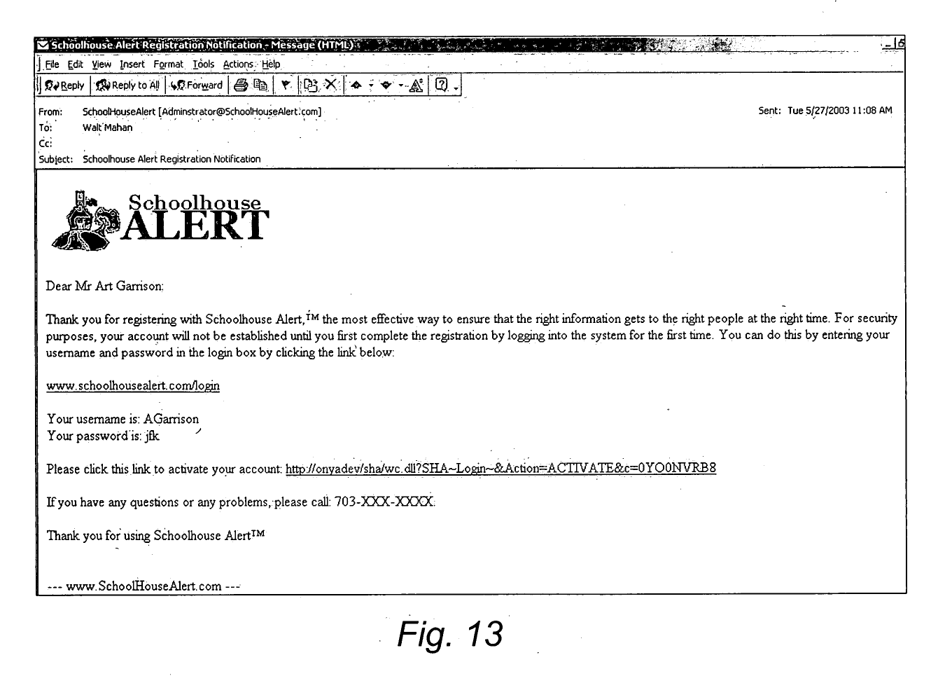

The user will receive the e-mail shown in FIG. 13 which thanks the guardian for registering and provides the following:
A hyperlink to login may be found after the first paragraph. (In this example, it is: www.schoolhousealert.com/login).
The User ID and Password defined by the user.
An Activation Code generated by the software that must be provided the first time logging in is embedded in the 2^{nd} hyperlink in the e-mail. When ready to proceed to log in the first time after registering, click on this hyperlink.
A phone number to call for questions.

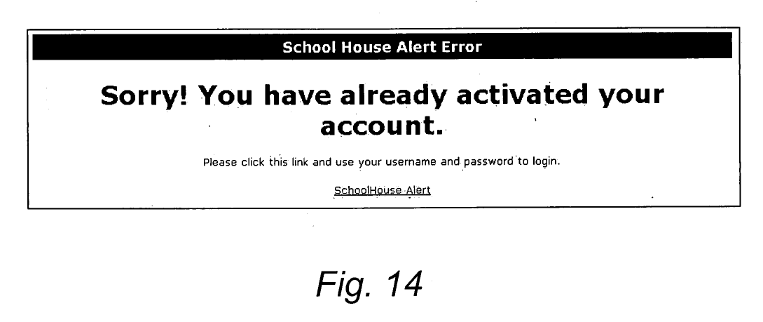

If the user tries to register a second time with the first time hyperlink, the user will receive the error message shown in FIG. 14.

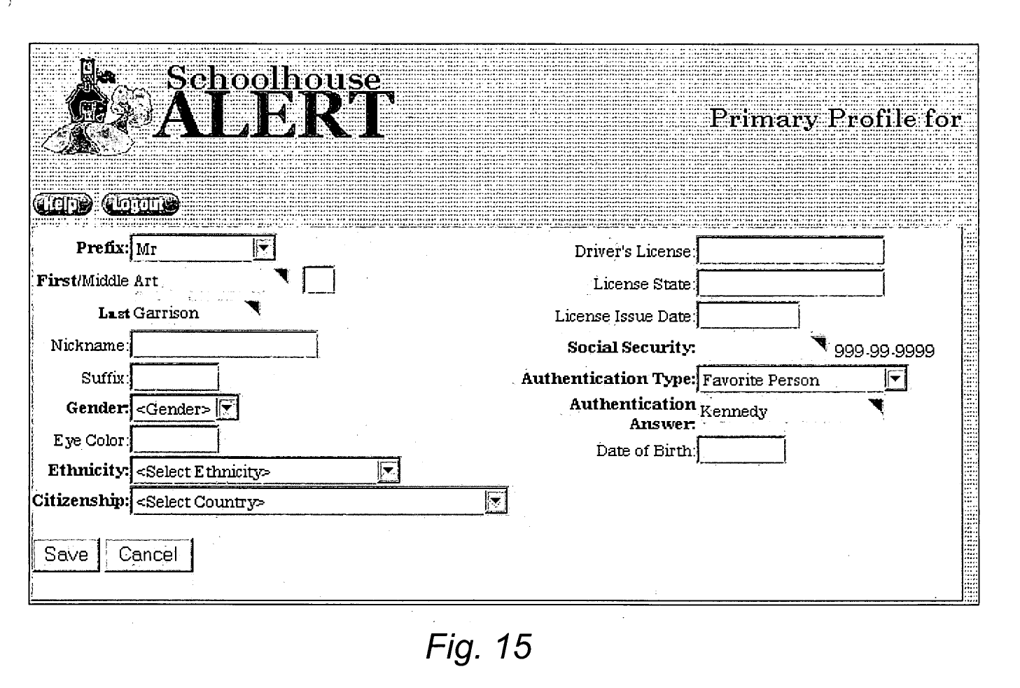

As described previously, the initial login to the system is best handled by clicking on the hyperlink provided in the e-mail. When the user initially clicks on the hyperlink found in the e-mail, the user automatically bypasses the login screen and is presented with the screen shown in FIG. 15 to complete entering information about the head of household.

The following table describes the fields (required fields are bolded) shown in FIG. 15.

| Field Label: | Content/Use: |
|---|---|
| Prefix: | Choose an appropriate prefix from the list |
| | in the dropdown provided. |
| First/Middle: | Enter your first name (notice that it was |
| | pre-populated), and optional, middle initial. |
| Last: | Enter your last name (notice that it was |
| | pre-populated). |
| Nickname: | Enter a commonly used nickname, if any. |
| Suffix: | Choose an appropriate suffix from the list |
| | in the dropdown provided. |
| Gender: | Choose your gender from the list in the |
| | dropdown provided. |
| Eye Color: | Enter the color of your eyes. |
| Ethnicity: | Choose your ethnic origin from the list |
| | in the dropdown provided. |
| Citizenship: | Choose your citizenship from the list in |
| | the dropdown provided. |
| Driver's License: | Enter the identifier for you on your |
| | driver's license. |
| License State: | Choose your state where licensed from |
| | the list in the dropdown provided |
| | (not included for students) of the |
| | person being described. |
| License Issue Date: | Date of issuance of driver's license. |
| Social Security: | Enter your Social Security Number |
| | (include hyphens). |
| Authentication Type: | Choose a selection from the dropdown |
| | provided to help us authenticate your |
| | identity. |
| Authentication Answer: | Enter your response to the previous |
| | selection. |
| Date of Birth: | Enter your date of birth in MM/DD/YYYY |
| | format. |

The following buttons are used to
save or reset your responses:

| | |
|---|---|
| Save | Save the data entered. |
| Cancel | Discard the data entered. |

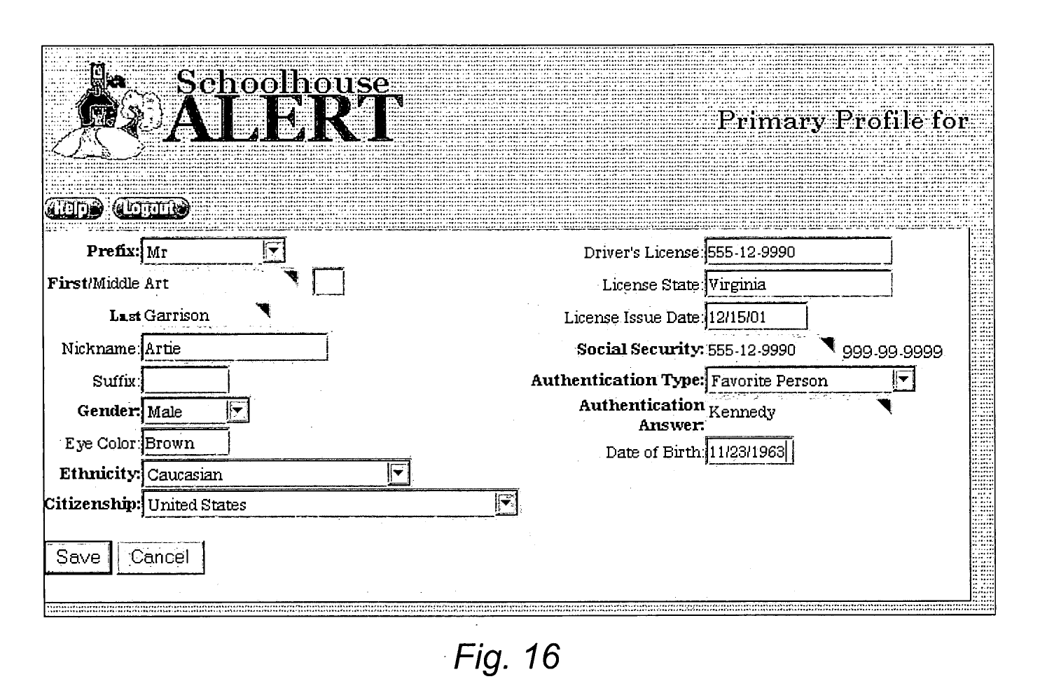

A completed form is shown in FIG. 16, and the Save button is pushed when finished. If the changes are accepted, the data will be saved and the user will be presented with the standard Login Screen that is described below.

As described previously, the initial login to the system is best handled by clicking on the hyperlink provided in the e-mail. It is also recommended that the user capture the standard login Internet address by making it a “Favorite” using the facilities of the Internet browser to facilitate future logins. Use of the same Internet address with which the user registered, will result in the screen shown in FIG. 7.

Once the user has logged in the first time using the indicated hyperlink that authenticated the user's identity as head of household, the user can no longer use that hyperlink. Instead, the user uses the Log In hyperlink, shown in FIG. 7. Once the user's Login User ID and Password are entered properly, press the Login button. The software will present the screens as shown in the following sections that permit the user to completely describe his/her family.

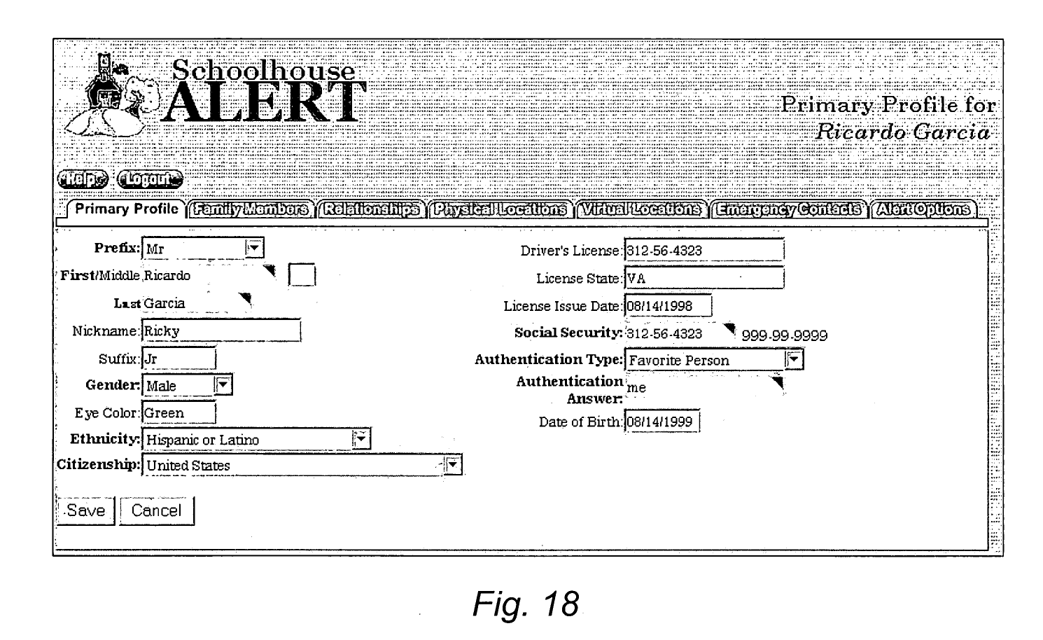

Once the user has successfully logged in and updated the Primary Profile for the head of household, the system presents the subsequent screen shown in FIG. 18. This screen enables the user (head of household) to totally describe the user's family. It also permits the user to indicate how to contact key family members when emergencies arise.

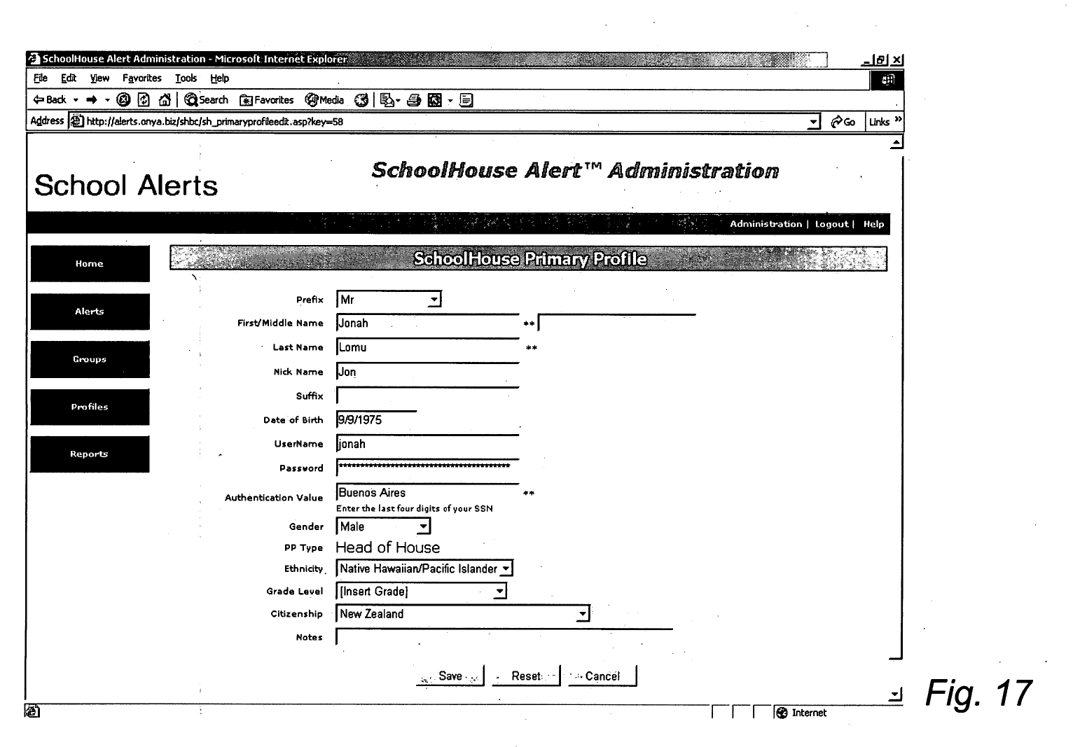

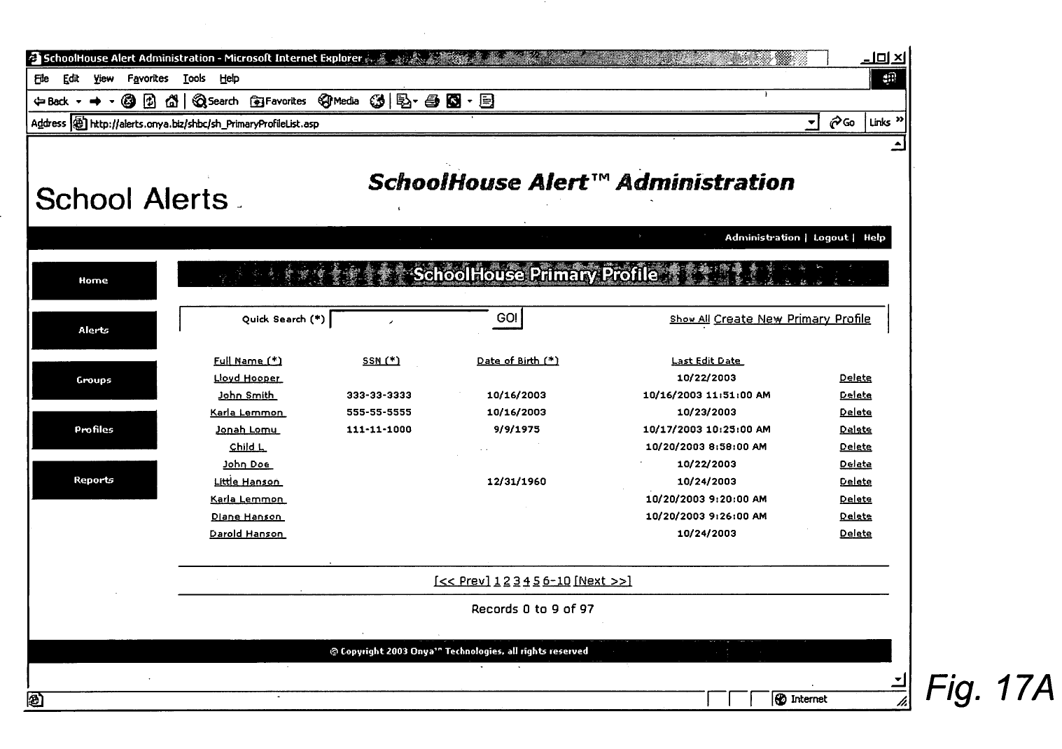

The screen shown in FIG. 17 is used by the Adminstrator to access the a particular head of household's Primary Profile. FIG. 17A shows the Administrator's Primary Profile screen, and selection of a particular head of household's Primary Profile, as shown in FIG. 17, is obtained by clicking on the hyperlink for that particular head of household shown on the screen in FIG. 17A.

The screen shown in FIG. 18 is identical to the previously completed screen shown in FIG. 16, for the head of household. However, it has a number of tabs that provide access to other folders. These folders permit the user to expand the definition of the family, and how to reach family members.

Notice that there are seven tabs (or folders) to completely describe the family, its inter-relationships, its physical and virtual locations, and who to contact in case of emergencies. The following table provides an overview of these folders:

| Folder/Tab: | Content/Use: |
|---|---|
| Primary Profile | All of the information relating to the head of |
| | household. |
| Family Members | Identifies additional members of the family. |
| Relationships | Defines the relationships between family |
| | members. |
| Physical Locations | Describes actual locations where family |
| | members can be located. |
| Virtual Locations | Defines ways family members can be contacted |
| | through virtual devices (cell phone, e-mail, |
| | etc.). |
| Emergency Contacts | Identifies persons to be contacts in |
| | emergencies. |
| Alert Options | Categorizes emergency situations and who to |
| | contact. |

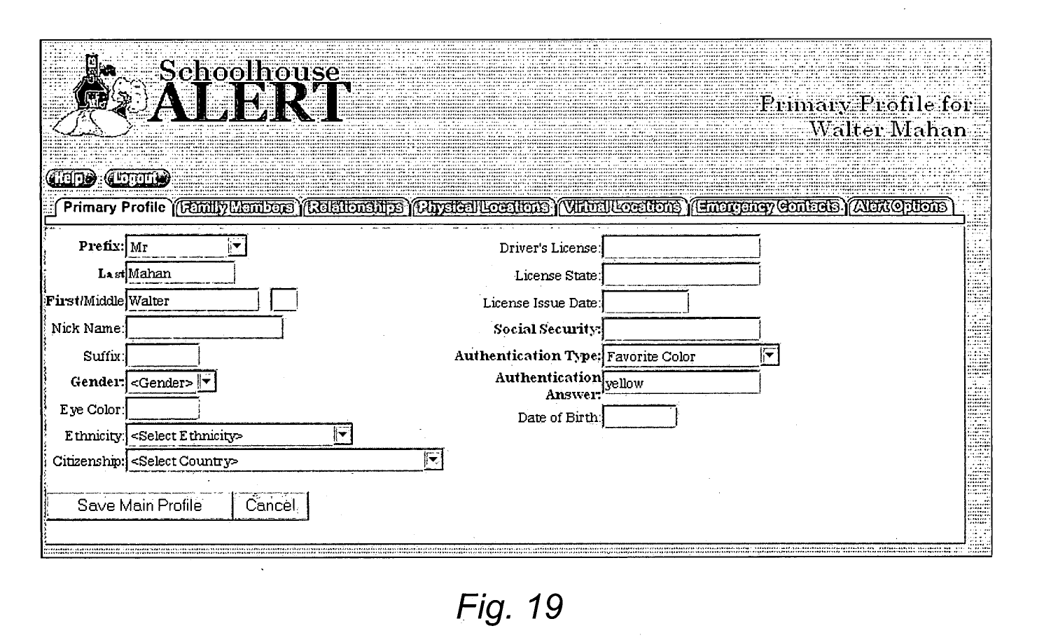

The primary profile folder is for supplemental information about the head of household. The initial screen is depicted in FIG. 19. The table that follows describes the fields (required fields are bolded) in this folder:

| Field Label: | Content/Use: |
|---|---|
| Prefix: | Choose an appropriate prefix from the list in |
| | the dropdown provided. |
| Last: | Enter your last name (notice that it was |
| | pre-populated). |
| First/Middle: | Enter your first name (notice that it was |
| | pre-populated), and optional, middle initial. |
| Nickname: | Enter a commonly used nickname, if any. |
| Suffix: | Choose an appropriate suffix from the list in |
| | the dropdown provided. |
| Gender: | Choose your gender from the list in the |
| | dropdown provided. |
| Eye Color: | Enter the color of your eyes. |
| Ethnicity: | Choose your ethnic origin from the list in |
| | the dropdown provided. |
| Citizenship: | Choose your citizenship from the list in |
| | the dropdown provided. |
| Driver's License: | Enter the identifier for you on your |
| | driver's license. |
| License State: | Choose your state where licensed from the |
| | list in the dropdown provided (not included |
| | for students) of the person being described. |
| License Issue Date: | Date of issuance of driver's license. |
| Social Security: | Enter your Social Security Number |
| | (include hyphens). |
| Date of Birth: | Enter your date of birth in MM/DD/YYYY |
| | format. |
| E-Mail: | Enter your e-mail address if you have one |
| | at home or at work. If you have both, use |
| | the one accessible during the daytime hours. |
| User ID: | Enter an identifier for logging in to the |
| | system (your e-mail address will ensure |
| | that it is unique). |
| Password: | Enter the password you will use to login. |
| Confirm Password: | Confirm your password by re-entering it. |
| Phone: | Enter your phone number with area code with |
| | which we can contact you during the |
| | daytime hours. |

The next two fields (along with User ID and Password)
must be supplied to successfully login.

| | |
|---|---|
| Authentication Type: | Choose a selection from the dropdown provided |
| | to help us authenticate our identity. |
| Authentication: | Enter your response to the previous selection. |

The following buttons are used to save or reset your responses

| | |
|---|---|
| Save Main Profile | Save the data entered. |
| Cancel | Discard the data entered. |

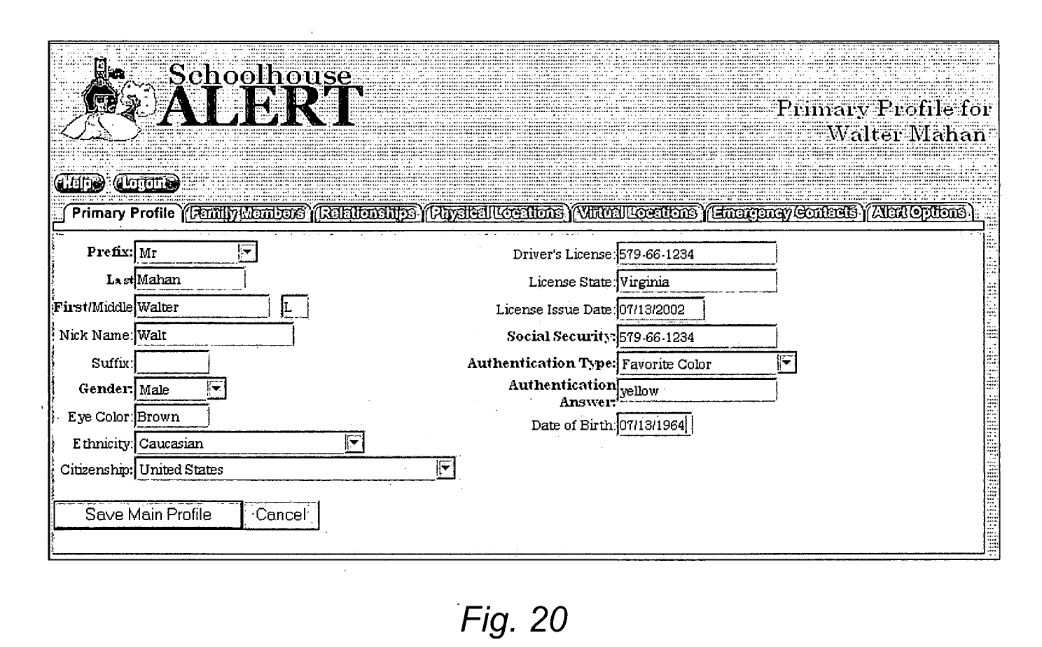

The screen shown in FIG. 20 is an example of the folder when completed.

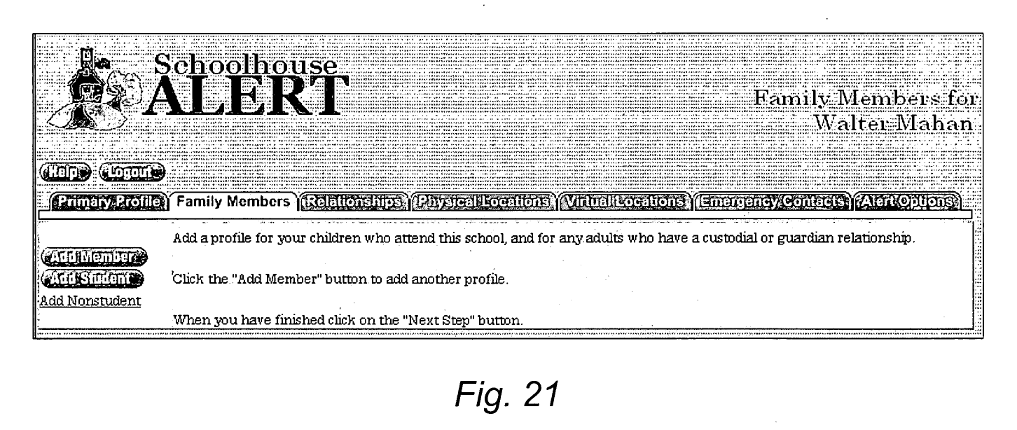

The family member folder enables the head of household to identify additional family members including spouse and children. The initial screen is depicted in FIG. 21. The screens presented for adding a member and adding a student are similar to the Primary Profile folder, but contain fewer fields.

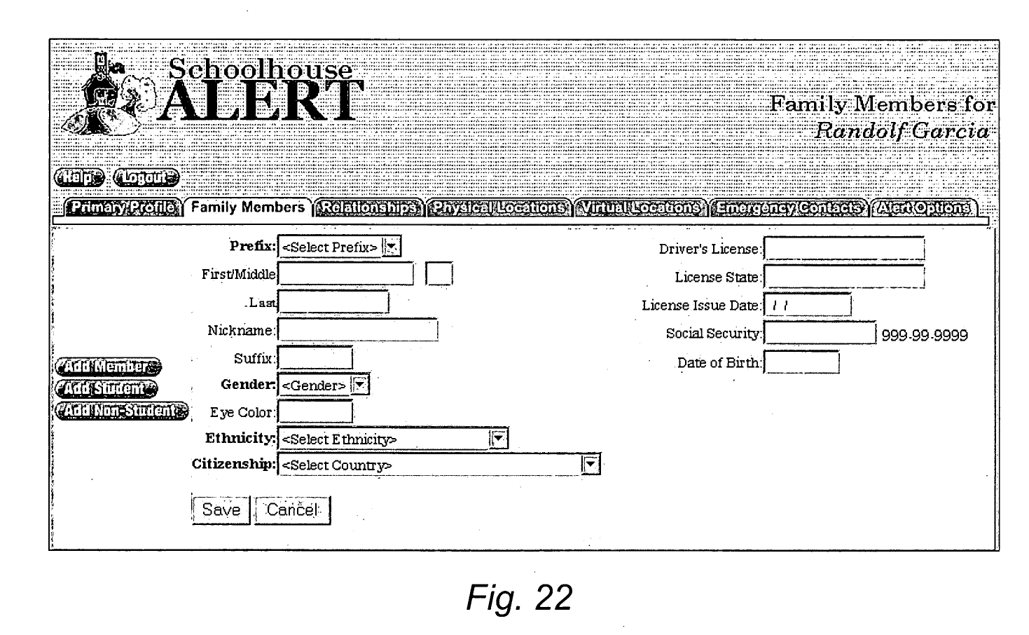

The screen shown in FIG. 22 results when the “Add Member” button is clicked.

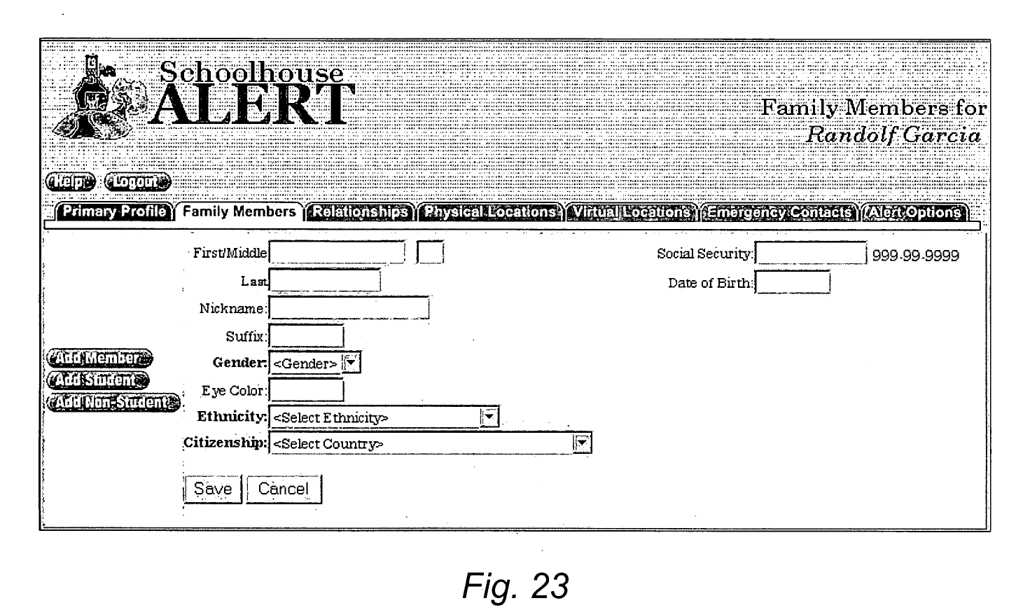

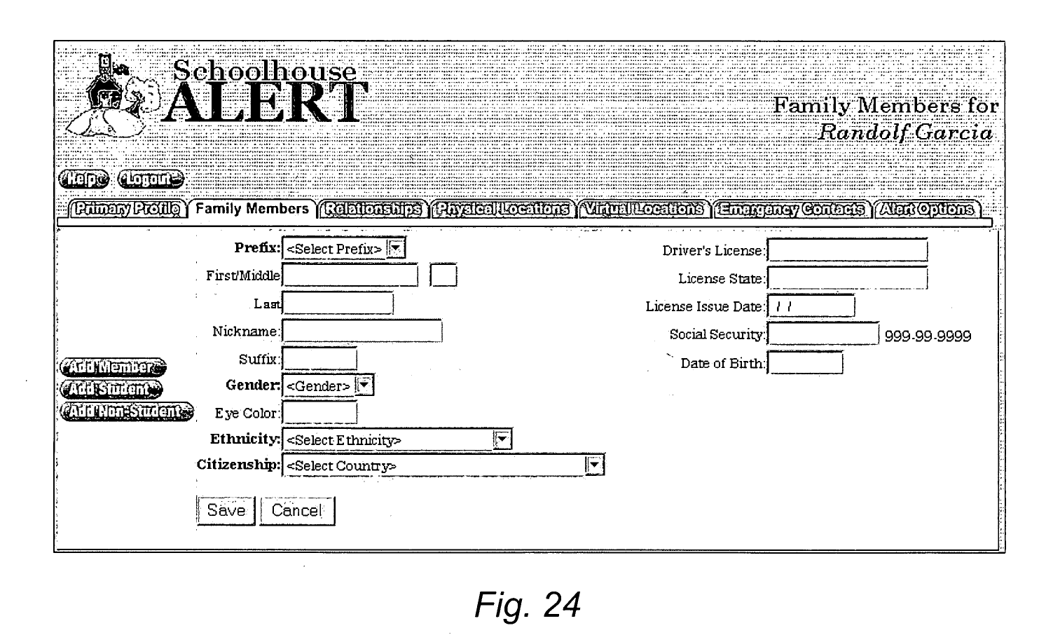

The screen shown in FIG. 23 results when you click the “Add Student” button, and the screen shown in FIG. 24 results when you click the “Add Non-Student” button.

The table that follows describes the fields (required fields are bolded) on family member folder:

| Field Label: | Content/Use: |
|---|---|
| Prefix: | Choose an appropriate prefix from the list in the |
| | dropdown provided (not included for students). |
| Last: | Enter your last name. |
| First/Middle: | Enter your first name, and optionally, middle |
| | initial. |
| Nickname: | Enter a commonly used nickname, if any. |
| Suffix: | Choose an appropriate suffix from the list in the |
| | dropdown provided. |
| Gender: | Choose your gender from the list in the dropdown |
| | provided. |
| Eye Color: | Enter the eye color of the person being |
| | described. |
| Ethnicity: | Choose the ethnic origin from the list in the |
| | dropdown provided of the person being described. |
| Citizenship: | Choose the citizenship from the list in the |
| | dropdown provided of the person being described. |
| Driver's License: | Enter the identifier on the driver's license (not |
| | included for students) of the person being |
| | described. |
| License State: | Choose your state where licensed from the list in |
| | the dropdown provided (not included for students) |
| | of the person being described. |
| License Issue Date: | Date of issuance of driver's license (not |
| | included for students) of the person being |
| | described. |
| Social Security: | Enter the Social Security Number (include |
| | hyphens) of the person being described. |
| Date of Birth: | Enter the date of birth of the person being |
| | described in MM/DD/YYYY format. |

The following buttons are used to save or reset your responses:

| | |
|---|---|
| Save Main Profile or | Save the data entered. |
| Save Student Profile | |
| Cancel | Discard the data entered. |

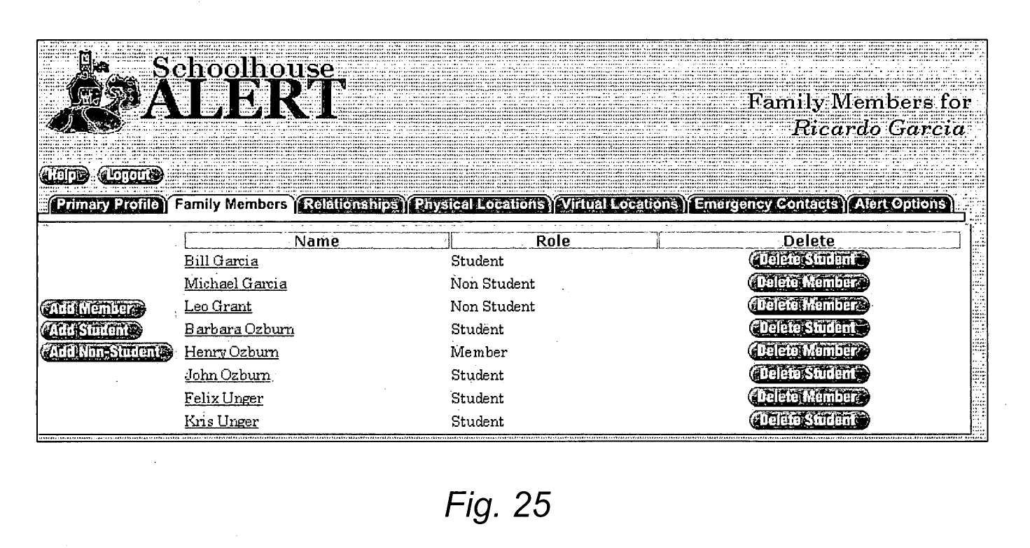

After entering several students and non-students, the Family Members folder contains a list of Family Members and appears similar to the screen shown in FIG. 25.

Clicking on the desired hyperlinked name in the list (i.e., John Ozburn) enables the family member record to be changed. A family member may be deleted by clicking the “Delete Member” button for the appropriate record.

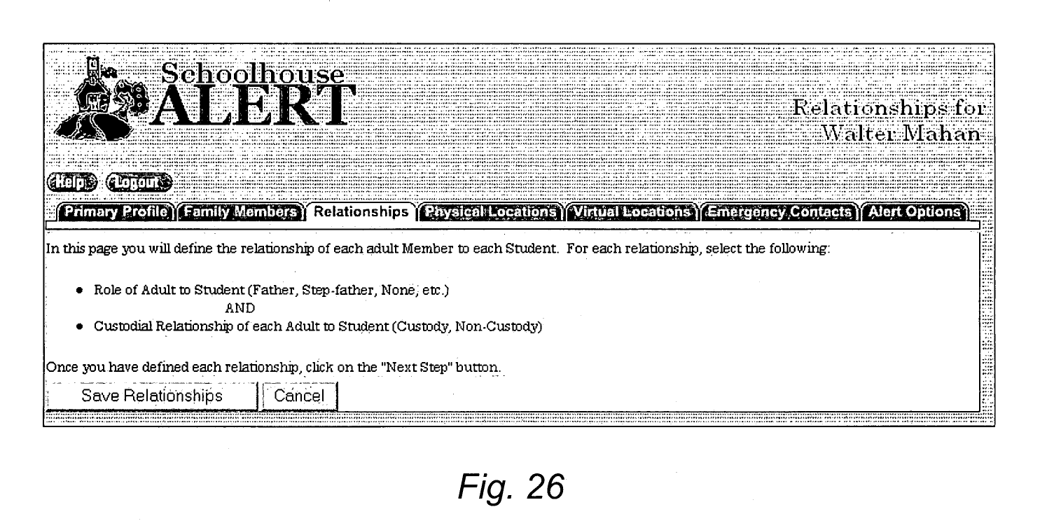

The relationships folder is for information about the relationships of family members to one another. The initial screen is depicted in FIG. 26.

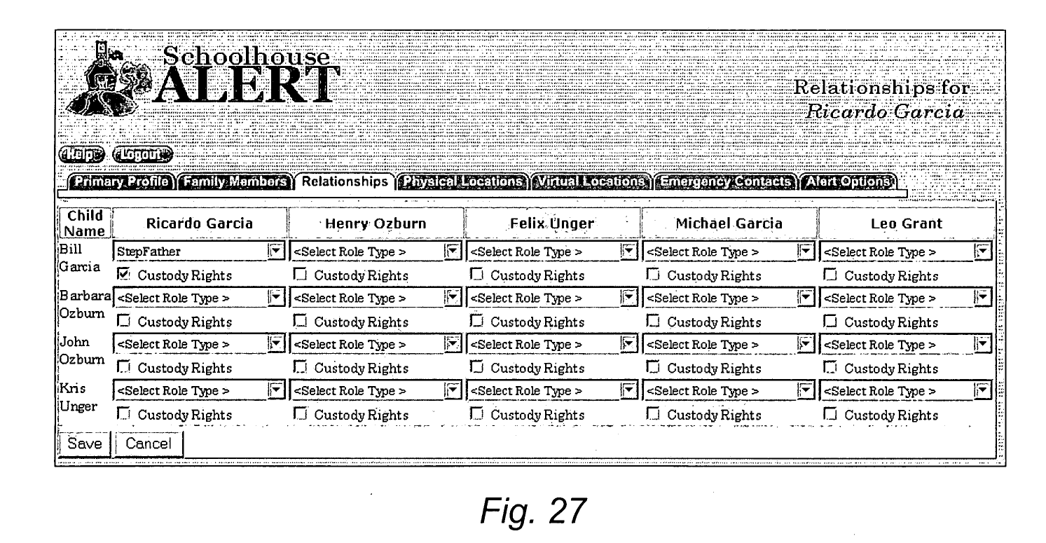

The screen shown in FIG. 27 describes relationships within the family of Ricardo Garcia. The Adults are listed in columns across the top while the children are listed in the left-hand column. The table that follows describes the fields (required fields are bolded) in this folder.

| Field Label: | Content/Use: |
|---|---|
| Child Name | List of all of the students of the head of |
| | household. |
| [Non-Student Name] | There will be as many columns as non-students |
| | defined in the family. The entries may be wider |
| | than the screen (use the thumb to access |
| | additional family members). |
| [Relationship] | Choose an appropriate relationship from the list |
| | in the dropdown provided (every relationship |
| | must be established). |
| Custody Rights | Click on the field to indicate that the person has |
| | custodial rights (it toggles on and off). |

The following buttons are used to save or reset your responses

| | |
|---|---|
| Save Relationships | Save the relationship data entered. |
| Cancel | Discard the data entered. |

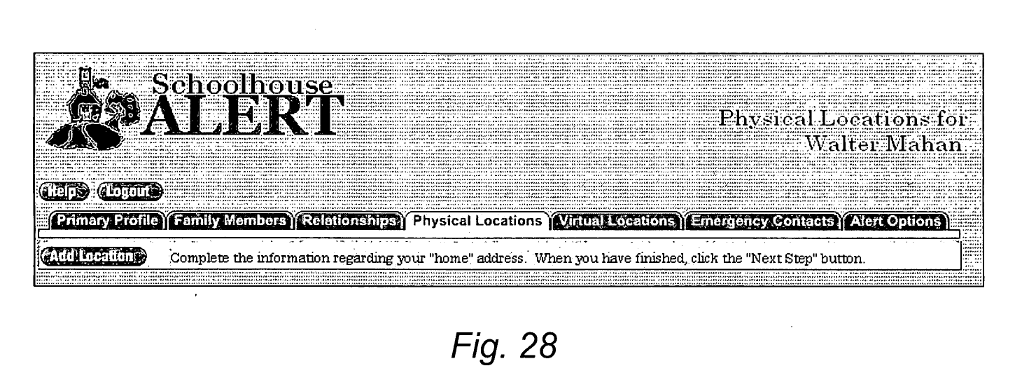

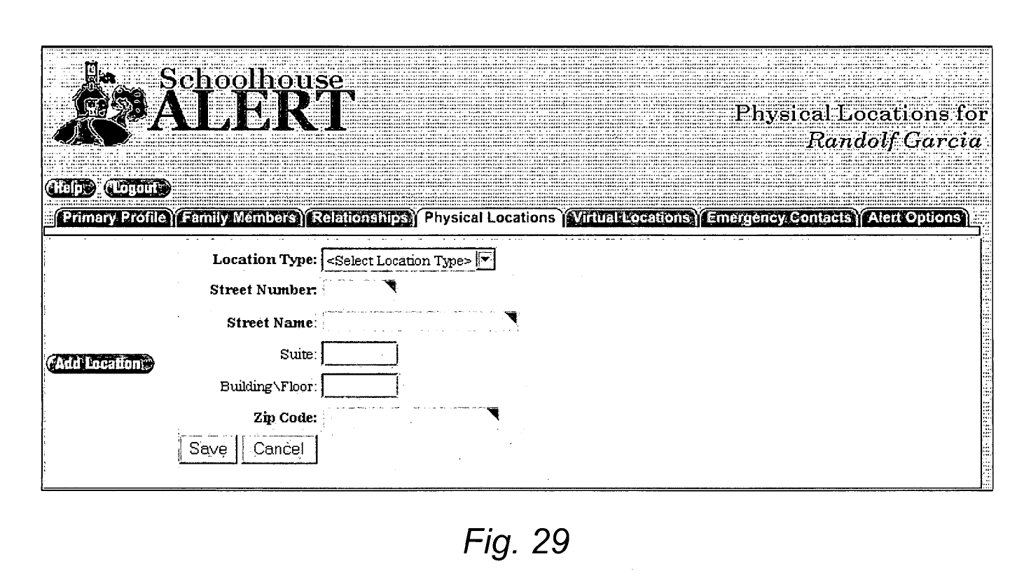

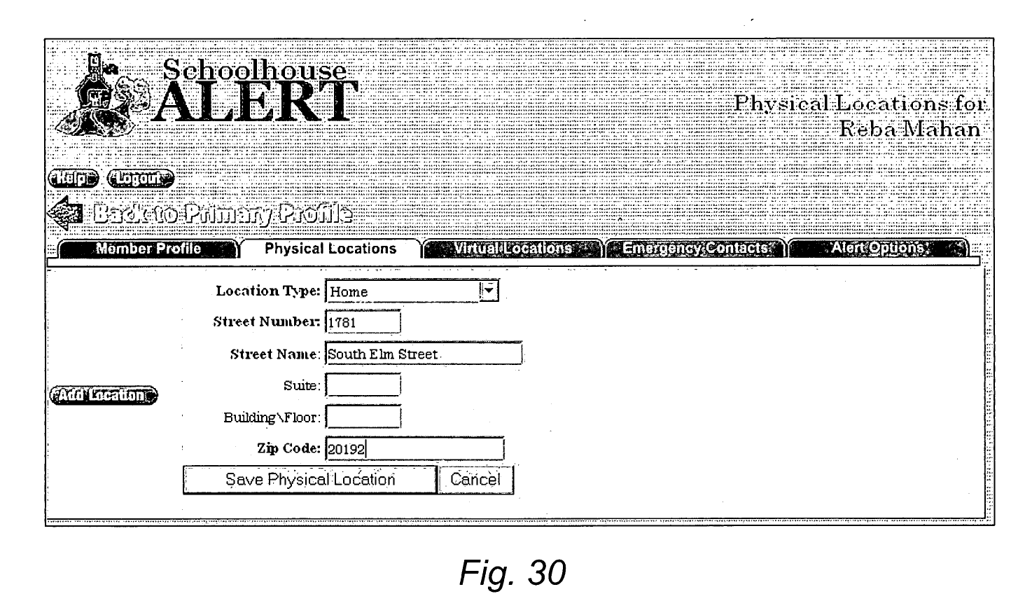

The physical locations folder is for information about the physical locations of family members. The initial screen is depicted in FIG. 28. A physical location is added when the “Add Location” button is clicked to create the screen shown in FIG. 29. A completed location screen is shown in FIG. 30.

The table that follows describes the fields (required fields are bolded) in the folder.

| Field Label: | Content/Use: |
|---|---|
| Location Type: | Choose type of location from the list in |
| | the dropdown provided. |
| Street Number: | Enter the number of the house or building. |
| Street Name: | Enter the name of the street location. |
| Suite: | Enter the room, apartment, unit or suite |
| | number. |
| Building\Floor: | Enter additional information about the |
| | location such as building number or floor. |
| Zip Code: | Enter the zip code of the location. |

The following buttons are used to save or reset your responses

| | |
|---|---|
| Save Physical Location | Save the data entered. |
| Cancel | Discard the data entered. |

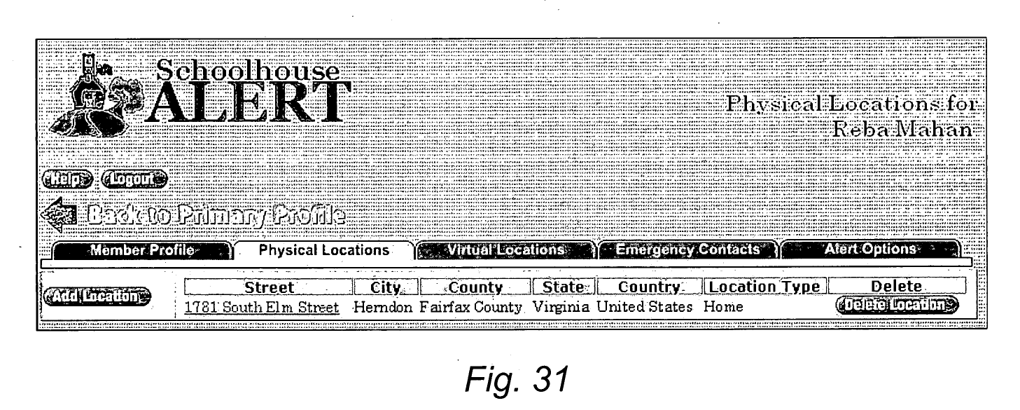

The screen shown in FIG. 31 lists the physical location(s) for a family member that is not a student. Clicking on the desired hyperlinked location in the list enables the location record to be changed. A location may be deleted by clicking the “Delete Location” button for the appropriate record.

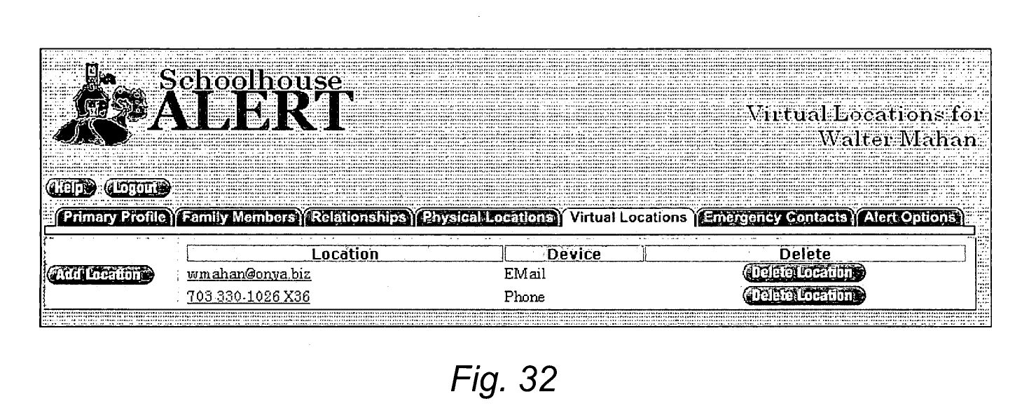

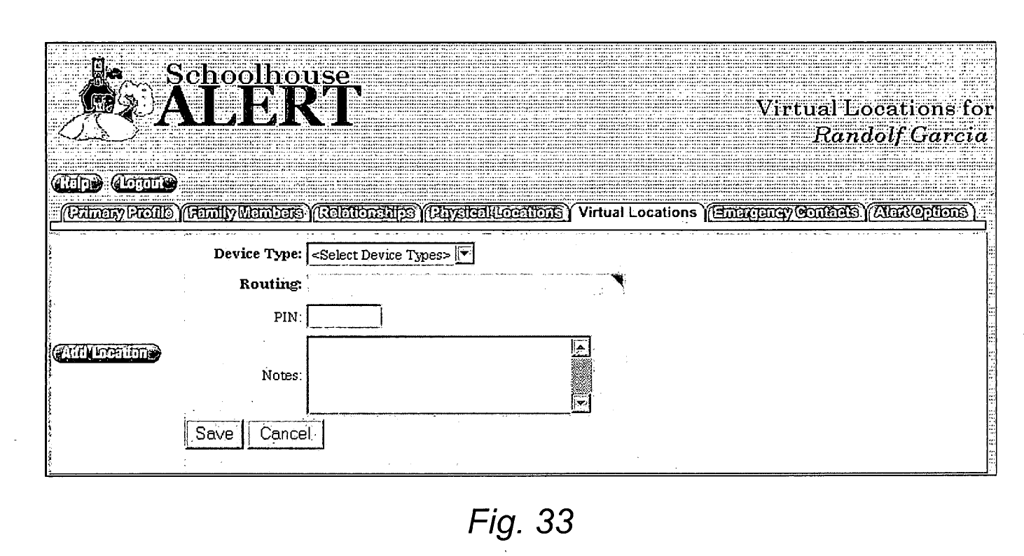

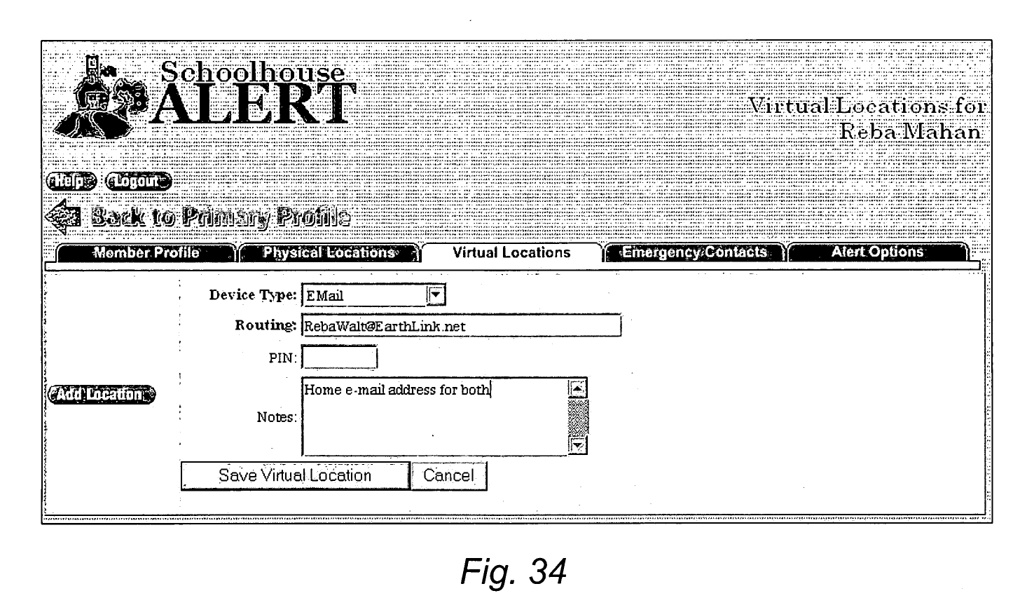

The virtual locations folder is for information about how to contact family members in case of emergency (e-mail, phone, pager, etc.). The initial screen is depicted in FIG. 32. A virtual location will be added when the “Add Location” button is clicked to create the screen shown in FIG. 33. A completed virtual location record is depicted in FIG. 34.

The table that follows describes the fields (required fields are bolded) on this folder.

| Field Label: | Content/Use: |
|---|---|
| Device Type: | Choose type of device from the list in the dropdown |
| | provided. |
| Routing: | Enter the phone number, e-mail address, etc. to the |
| | specified device. This field provides the device |
| | address. |
| PIN: | Enter the Personal Identification Number, if |
| | necessary. |
| Notes: | Enter additional notes to further describe the |
| | virtual location. |

The following buttons are used to save or reset your responses

| | |
|---|---|
| Save Virtual | Save the data entered. |
| Location | |
| Cancel | Discard the data entered. |

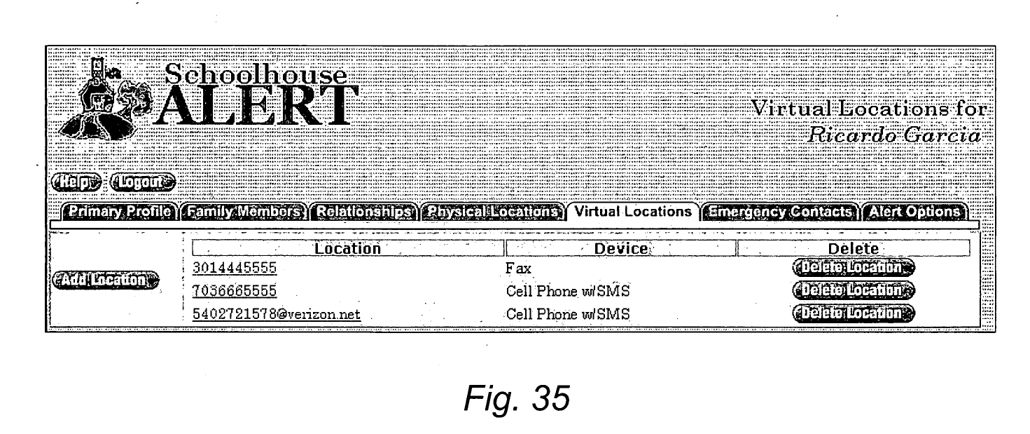

The screen shown in FIG. 35 lists the virtual location(s) for a family member that is not a student. Clicking on the desired hyperlinked location in the list enables the location record to be changed. A location may be deleted by clicking the “Delete Location” button for the appropriate record.

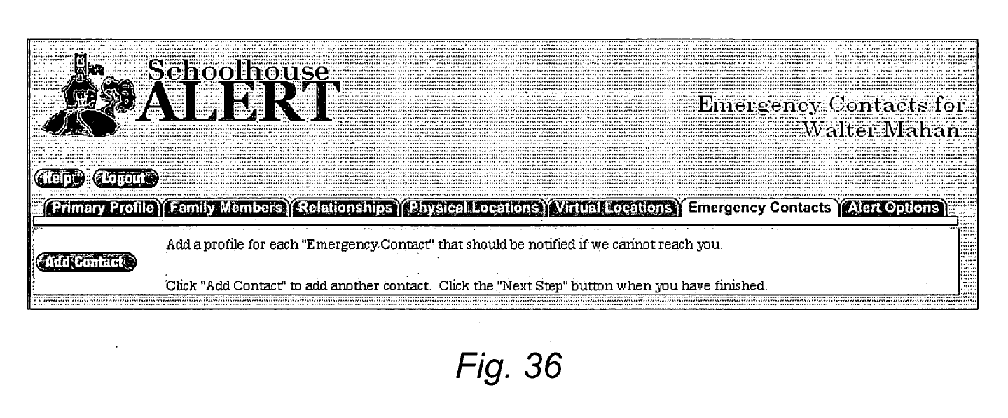

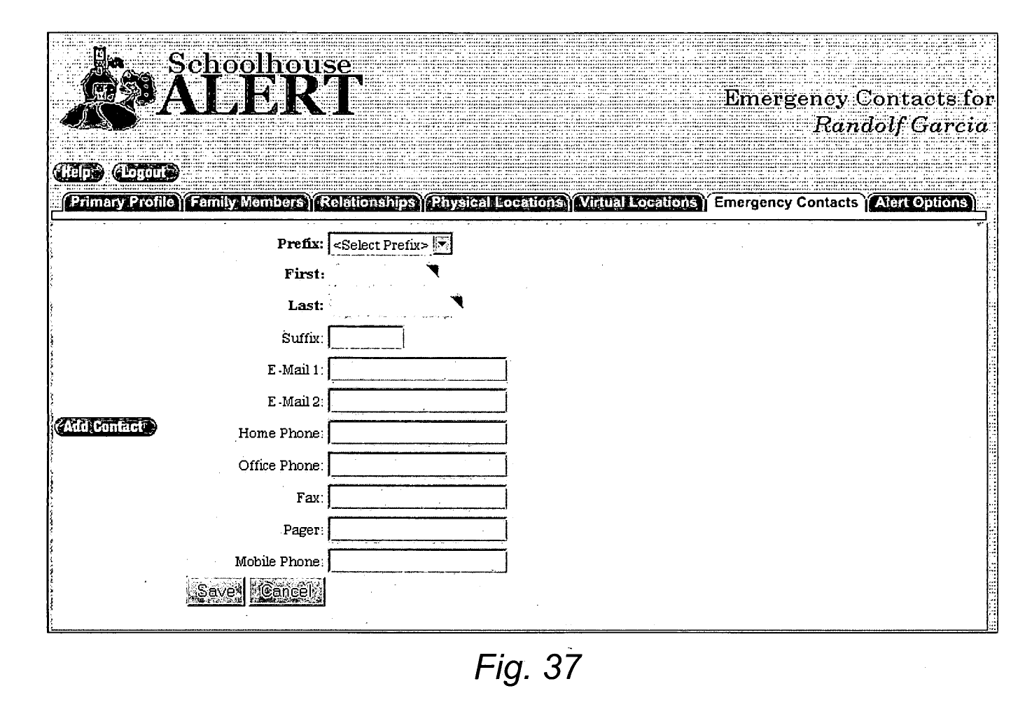

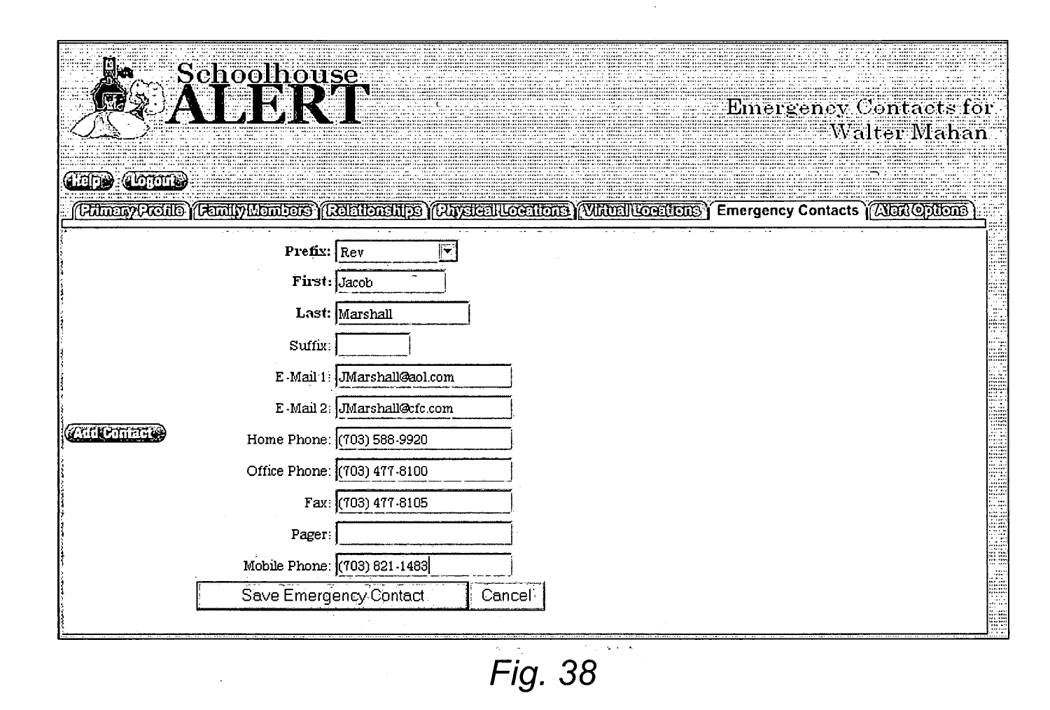

The emergency contacts folder is for information about who and how family members should be contacted in case of an emergency. The initial screen is depicted in FIG. 36. When the “Add Contact” button is clicked, the screen shown in FIG. 37 is presented to add an emergency contact to the family. A completed emergency contact record is depicted in FIG. 38. The table that follows describes the fields (required fields are bolded) on this folder.

| Field Label: | Content/Use: |
|---|---|
| Prefix: | Choose an appropriate prefix from the list in the |
| | dropdown provided (not included for students). |
| First: | Enter the first name of the emergency contact. |
| Last: | Enter the last name of the emergency contact. |
| Suffix: | Choose an appropriate suffix from the list in the |
| | dropdown provided. |
| E-Mail 1: | Enter the primary e-mail address of the contact. |
| E-Mail 2: | Enter the secondary e-mail address of the |
| | contact. |
| Home Phone: | Enter the home phone number of the contact |
| | with area code. |
| Fax: | Enter the fax phone number of the contact with |
| | area code. |
| Pager: | Enter the pager phone number of the contact |
| | with area code. |
| Mobile Phone: | Enter the mobile phone number of the contact |
| | with area code. |

The following buttons are used to save or reset your responses:

| | |
|---|---|
| Save Emergency | Save the data entered. |
| Contact | |
| Cancel | Discard the data entered. |

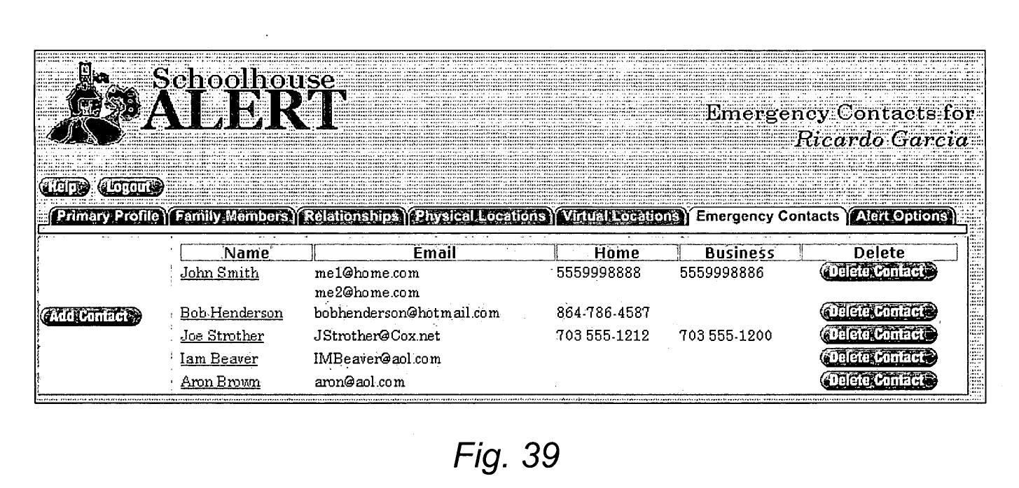

The screen shown in FIG. 39 lists the emergency contact(s) for a family. Clicking on the desired hyperlinked name in the list enables that record to be changed. A contact may be deleted by clicking the “Delete Contact” button for the appropriate record.

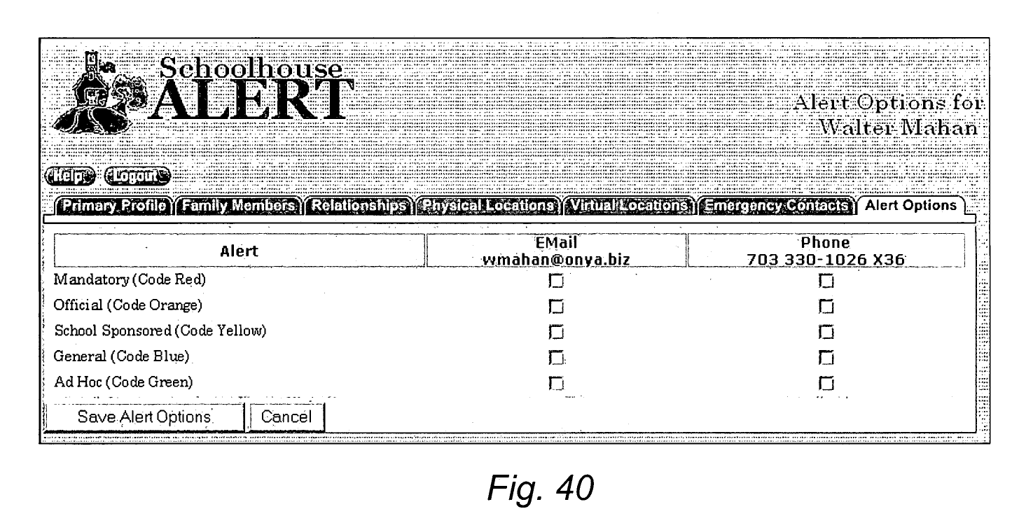

The alert options folder allows the user to define how he/she is to be contacted for various kinds of emergencies (alert levels). The initial screen is depicted in FIG. 40.

The table that follows describes the fields on this folder:

| Field Label: | Content/Use: |
|---|---|
| Alert: | List of alert levels defined for the school. |

The column headings vary depending upon
the virtual devices of the family:

| | |
|---|---|
| EMail: | A checkbox to indicate the medium to be used to |
| | communicate (it toggles on and off). |
| Phone: | A checkbox to indicate the medium to be used to |
| | communicate (it toggles on and off). |

The following buttons are used to save or reset your responses

| | |
|---|---|
| Save Alert | Save the data entered. |
| Options | |
| Cancel | Discard the data entered. |

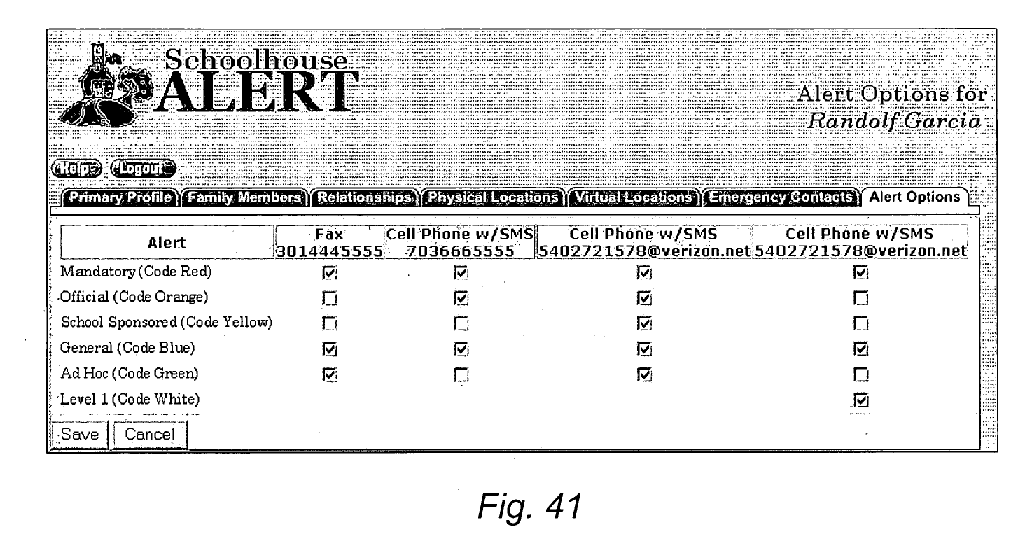

The screen shown in FIG. 41 is an example of the folder with several, alternate devices.

The fundamental purpose of the system is to get the right information to the right people at the right time. That is, to notify designated family members with an appropriate message when needed. The system enables the school to make appropriate notifications to the family. The message will come by phone (wired and/or wireless), fax, e-mail, or whichever means has been designated for the level of alert for the crisis situation. The alert messages have been structured to provide the recipients instructions as to the next step to be taken. The system obviates the need to call the school during emergency situations. In emergency situations, the phone lines are often overloaded—calls to the school are therefore counter-productive and to be avoided.

The administration facilities of the system include those functions that enable the school to maintain essential underlying facilities. One or more individuals with administration authority should be appointed as Administrators. These Administrators perform or oversee all of the necessary functions. The school should have multiple persons with Administrator authority with proper training to ensure that someone is always available to sound alerts when needed.

A Web Site address is provided for the Administration functions that differs from the one used by the head of household to register and identify the family. The primary functions of Administration include the following:
1. Define and maintain Groups where a group is any combination of students, family members and faculty that are related by some common interest (i.e., all students, cheerleading team, chess club, Spanish Club, a scheduled field trip, etc.). Groups are set up to be recipients of alert messages from the system.
2. Maintain the System Tables and Configuration Tables of the system.
3. Pre-define various alerts.
4. Send alerts when necessary.
5. Maintain student and faculty records.

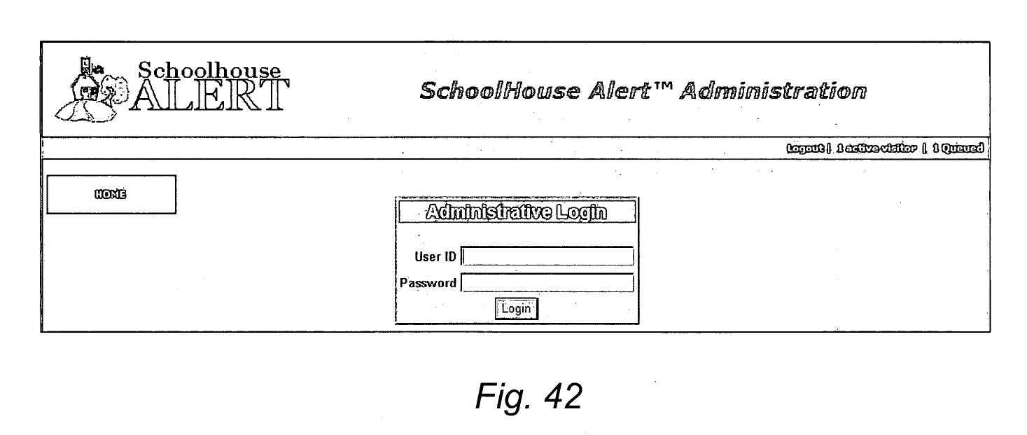

The screen shown in FIG. 42 is presented when the Administration portion of the system is started up. The Administration process begins with logging in using the screen shown in FIG. 42. The person must enter a valid User ID and Password to gain access to the Administration portion of the system. Another Administrator defines valid User IDs and Passwords, however, the current Administrator may change his/her password at any time through the faculty maintenance facility.

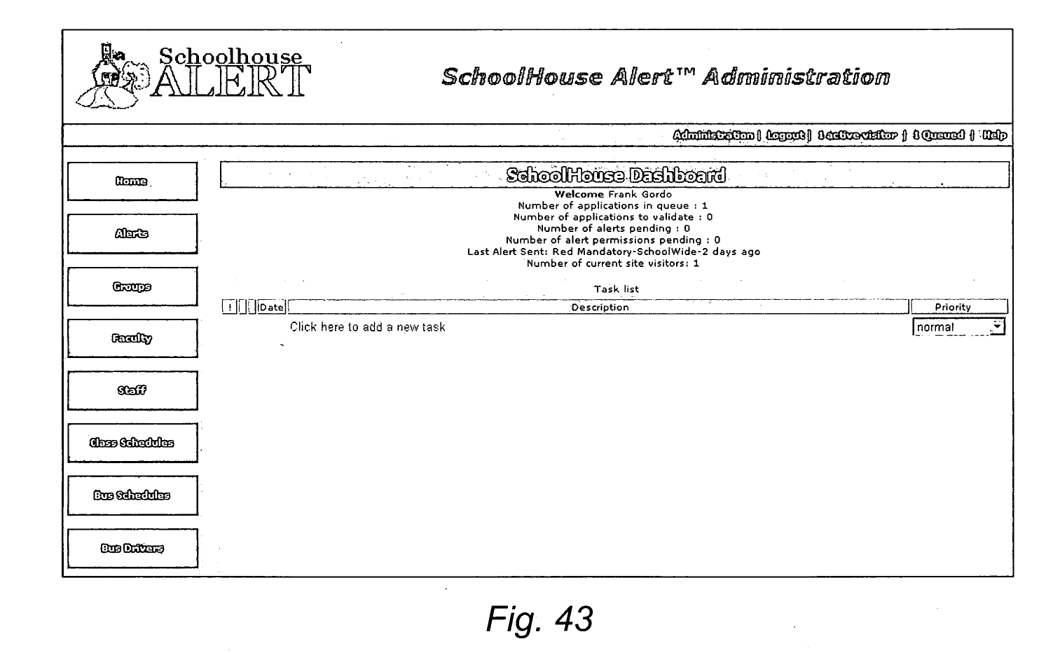

Upon successfully logging in, the Schoolhouse Dashboard screen shown in FIG. 43 will be presented showing that the following options are available:
Home—Return to this screen.
Send an Alert—Fire up an Alert (emergency situation).
Group Edit—Create or change a group record.
Administration—Apply maintenance to System Tables.
Logout—Log out of the Administration software.
Active Visitor—Count of active visitors logged in.
Queues—Count of queued messages.

The Schoolhouse Dashboard screen is what is presented whenever you click on the “Home” button. The Dashboard Summary displays recent pertinent information regarding activity within the system.

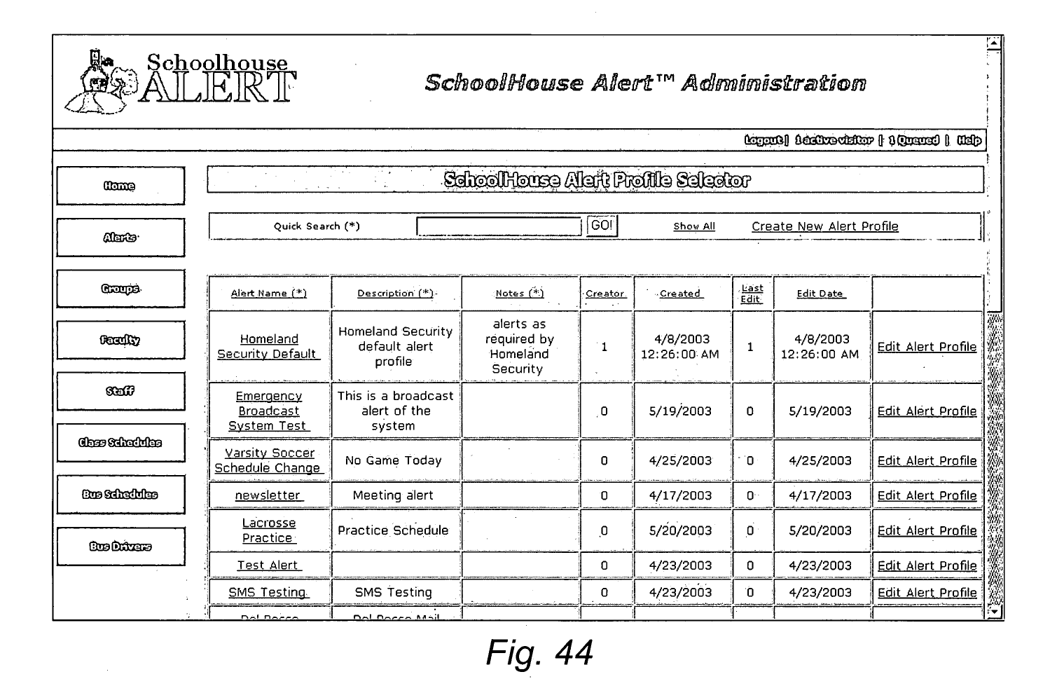

The screen shown in FIG. 44 is presented whenever you click on the “Alerts” button. As its name implies, the Alert Profile Selector is used to select the desired alert to be changed or sent. The screen contains a list of alert messages that have been pre-defined for emergency situations.

If you need to Send an Alert, do the following:
1) Locate the appropriate alert to be sent,
2) Double-click on the selected Alert Name field in the browse list.
3) When the detail record for the selected alert is presented, the content (i.e., the message) can be changed as desired.
4) Press the Send Now button.

The list of alerts can be quite large. To expedite locating the desired alert, a “Quick Search” facility is provided. Enter a portion of the Alert Name and press the Go! button to quickly locate the desired alert. To restore all of the alerts in the list, use the Show All hyperlink. Notice also that there is a thumb on the right-hand edge that may be used to parse vertically through the list by dragging it up and down. At the very bottom of the list, you will find the following to help navigate through the list. This area indicates the number of records in the list, the number of pages, and provides the means to go from page to page (click on 2 or Next >> to go to the next page).

The list may be sorted by clicking on any of the underlined column headings. The first click sorts the list in descending order. The next, in ascending order. The content of the browse list changes to include View, Edit and Delete options.

The following table describes each column in the list and its content.

| Field Label: | Content/Use: |
|---|---|
| Alert Name | The unique name defining the alert. |
| Description | A description to amplify the use of the alert. |
| Notes | Additional description of the alert. |
| Creator | The User ID of the person who created the alert. |
| Created | The date when the alert was created. |
| Updated | The date when the alert was last updated. |
| | Edit Alert Profile - Click on this to edit the alert content. |

The following columns only appear when the list is sorted:

View - Click on this to view the alert content (read-only).
Edit - Click on this to edit (change) the alert content
(functions the same as the Edit Alert Profile above).
Delete - Click on this to delete the alert record (the user will
be prompted to confirm the deletion of the alert).

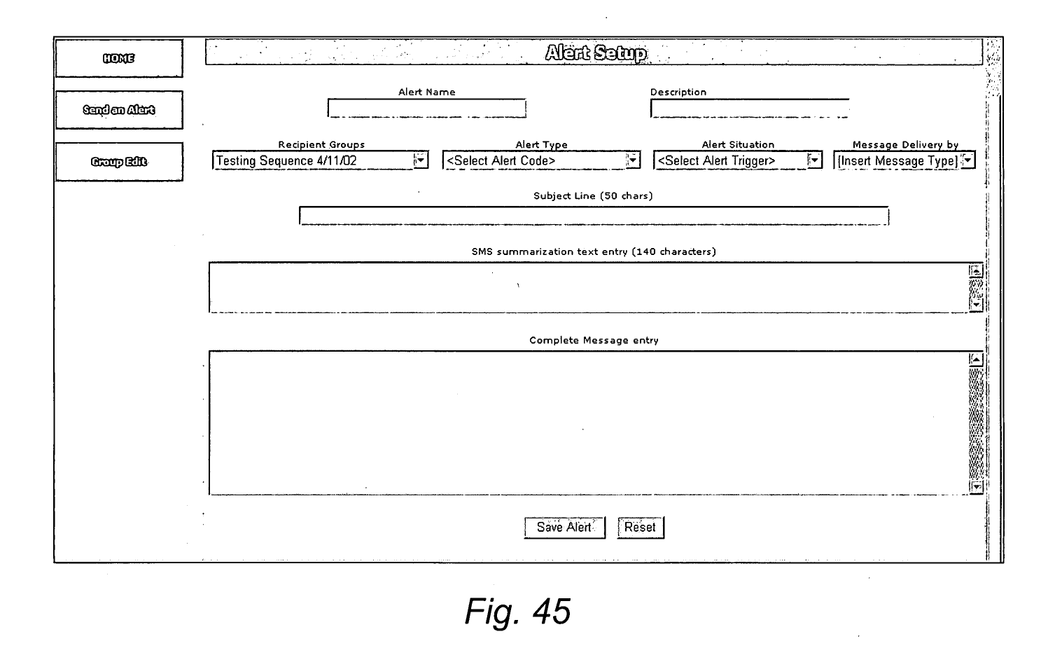

Click on the Create New Alert Profile hyperlink to create a new alert record as shown by the screen in FIG. 45. The following table (required fields are bolded) describes each column in the list and its content. The SMS summarization text entry box is used to define messages to be transmitted to virtual locations identified as SMS devices, such as pagers, cell phones, etc. The complete message entry box is used to define messages to be transmitted by e-mail.

| Field Label: | Content/Use: |
|---|---|
| Alert Name | The unique name defining the alert. Clicking on |
| | this hyperlink will enable the record to be |
| | modified. |
| Description | A description to amplify the use of the alert. |
| Recipient Group | Choose the group of individuals to be notified |
| | from the dropdown provided. The school defines |
| | these groups. |
| Alert Type | Choose the type of alert from the dropdown |
| | provided. These represent the criticality of |
| | the alert and usually have an appropriate |
| | color associated with them. |
| Alert Situation | This dropdown permits an alert to be associated |
| | with a triggering event such as a fire, |
| | homeland security or hostage alert situation. |
| Message Delivered | Choose the means to deliver the message by |
| by | selecting a dropdown entry (e-mail, letter, |
| | etc.). |
| Subject Line | Enter the information (maximum of 50 characters) |
| | to appear in the Subject Line of the e-mail that |
| | is to be sent. |
| SMS Summarization | Enter the information (maximum of 140 characters) |
| Text Entry | to appear in the SMS message that is to be sent. |
| Complete Message | Full message to be sent for the alert |
| Entry | (unlimited size). |

The following buttons are used to save or discard the entry:

| | |
|---|---|
| Save Alert | Save the data for this alert. |
| Reset | Discard the data entered and reset all fields |
| | as if a new alert is being created. |

The screen shown in FIG. 46 is a sample alert that cancels a field trip to the U.S. Mint.

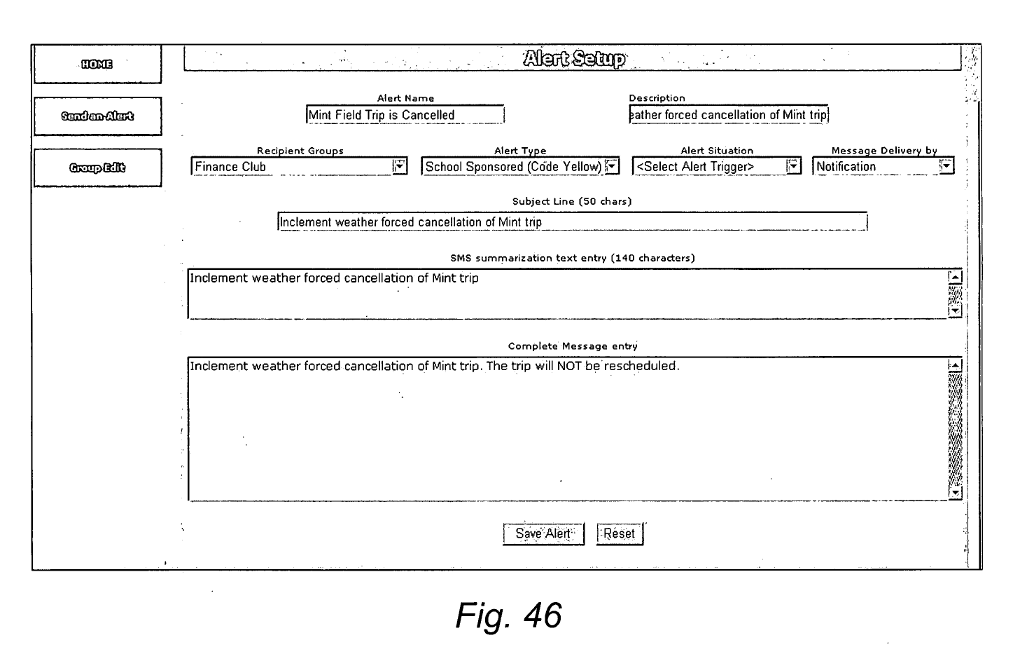

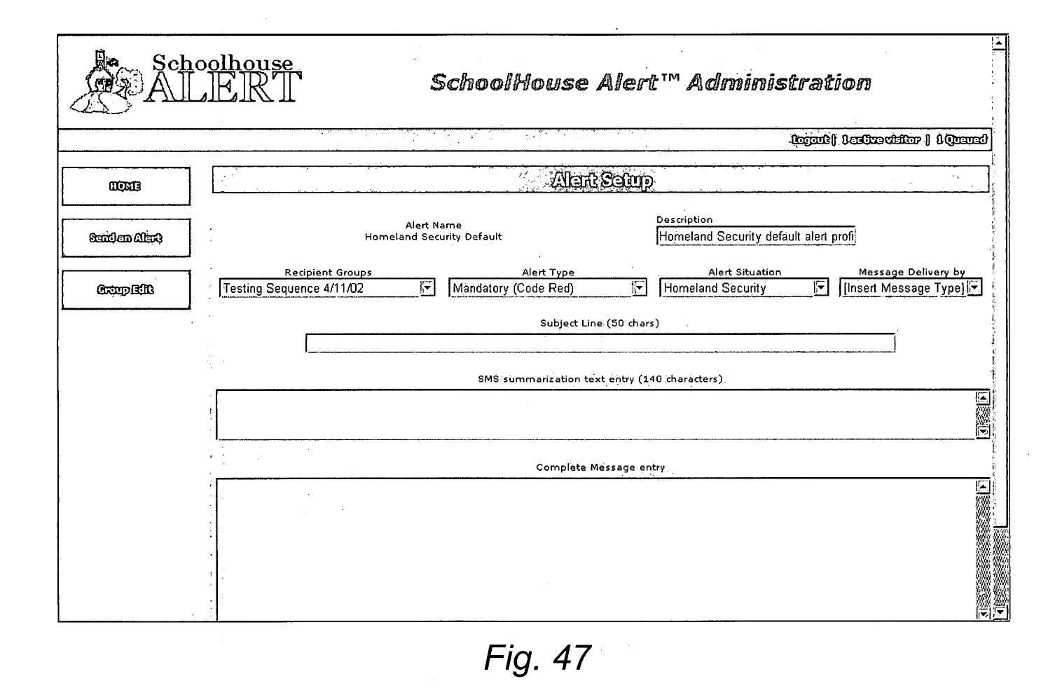

While in the list of alerts, click on the Alert Name field or Edit Alert Profile hyperlink entry to begin editing the desired record. The screen shown in FIG. 47 will be presented. The fields are identical to those found when creating a new alert, which were described previously.

While in the list of alerts, and after the list has been sorted, you may click on the View hyperlink. The screen presented is identical to the one presented for edit, however, you may not make any changes to the record.

While in the list of alerts, and after the list has been sorted, you may click on the Delete hyperlink. The software will prompt you to confirm prior to actually deleting the record.

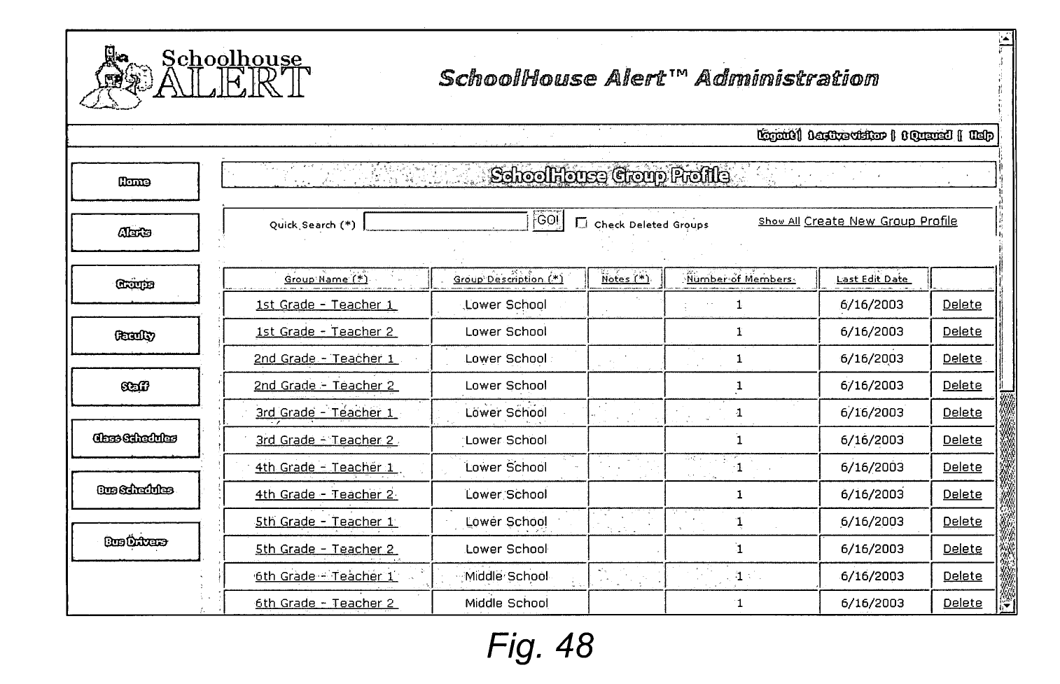

This screen shown in FIG. 48 is presented whenever you click on the “Groups” button. The Group Profile Selector is used to select the desired group to be changed. The screen contains a list of group records that have been defined for the system.

The list of groups can be quite large. To expedite locating the desired group, the Quick Search facility is provided. Enter a portion of the Group Name and press the Go! button to quickly locate the desired group. To restore all of the groups in the list, use the Show All hyperlink.

Notice also that there is a thumb on the right-hand edge that may be used to parse vertically through the list by dragging it up and down. At the very bottom of the list, you will find the following to help navigate through the list. This area indicates the number of records in the list, the number of pages, and provides the means to go from page to page (click on 2 or Next >> to go to the next page).

The list may be sorted by clicking on any of the underlined column headings. The first click sorts the list in descending order. The next click, in ascending order.:

The following table describes each column in the list and its content.

| Field Label: | Content/Use: |
|---|---|
| GroupName | The unique name defining the group. Clicking on |
| | this hyperlink will enable the record to be |
| | modified. |
| Group Description | A description to amplify the use of the group. |
| Notes | Additional description of the group. |
| Creator | The User ID of the person who created the |
| | group. |
| Created | The date when the group was created. |
| Updated | The date when the group was last updated. |
| | Delete - Click on this to delete the group. |

Within the system, groups comprise more than those collections of people to be notified in emergency situations. For example, members of the football team can make up a group that occasionally needs some form of mass communication that can be done easier with the system.

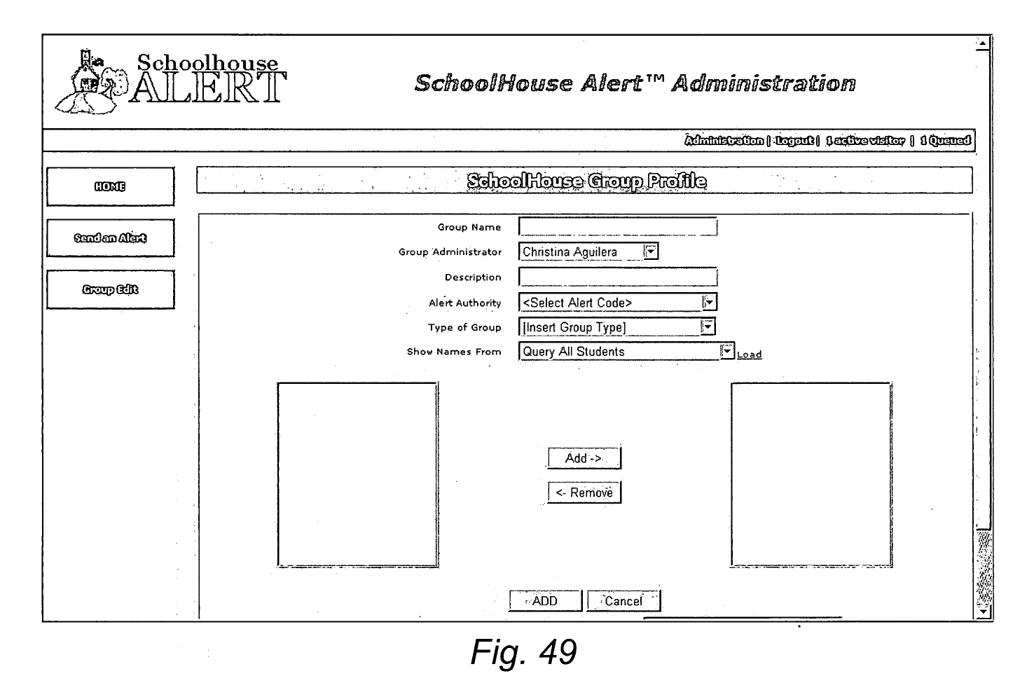

Click on the Create New Group Profile hyperlink, shown in FIG. 48, to create a new group record, as shown in the screen in FIG. 49.

The following table (required fields are bolded) describes each column in the list and its content.

| Field Label: | Content/Use: |
|---|---|
| GroupName | The unique name defining the group. Clicking |
| | on this hyperlink will enable the record to |
| | be modified. |
| Group Administrator | Choose name of the person in charge of the |
| | group from the dropdown provided. |
| Description | A description to amplify the use of the |
| | group. |
| Alert Authority | Choose the appropriate alert authority from |
| | the dropdown provided. The school defines |
| | these groups. These represent the criticality |
| | of the group and usually have an appropriate |
| | color associated with them. |
| Type of Group | Choose the type of group from the dropdown |
| | provided. |
| Show Names From | This dropdown permits the group to be defined |
| | from one or more sources (students, teachers, |
| | sports team, etc.). Once a source is |
| | identified, click on the Load hyperlink |
| | (Load). To mix sources, click on another |
| | source, click on the Load and select other |
| | individuals as shown below: |

The following Left-Hand Area contains potential group members.
The following Right-Hand Area contains designated group members.

| | |
|---|---|
| [Left-Hand Area] | Contains all names from the Show Names From |
| | field once the Load hyperlink is clicked. |
| [Right-Hand Area] | Enter the information (maximum of 50 |
| | characters) to appear in the |
| | Subject Line of the e-mail that is to |
| | be sent. |
| Add −> | Move a name from the Left-Hand Area to the |
| | Right-Hand Area (selected). |
| <− Remove | Move a name from the Right-Hand Area |
| | (selected) to the Left-Hand Area. |

The following buttons are used to save or discard the entry:

| | |
|---|---|
| ADD | Add the new record for this group. |
| Save | Save the data for this group. |
| Reset | Discard the data entered and reset all |
| | fields as if a new group is being |
| | created. |
| Cancel | Discard the data entered and reset all |
| | fields as if a new group is being |
| | created. |

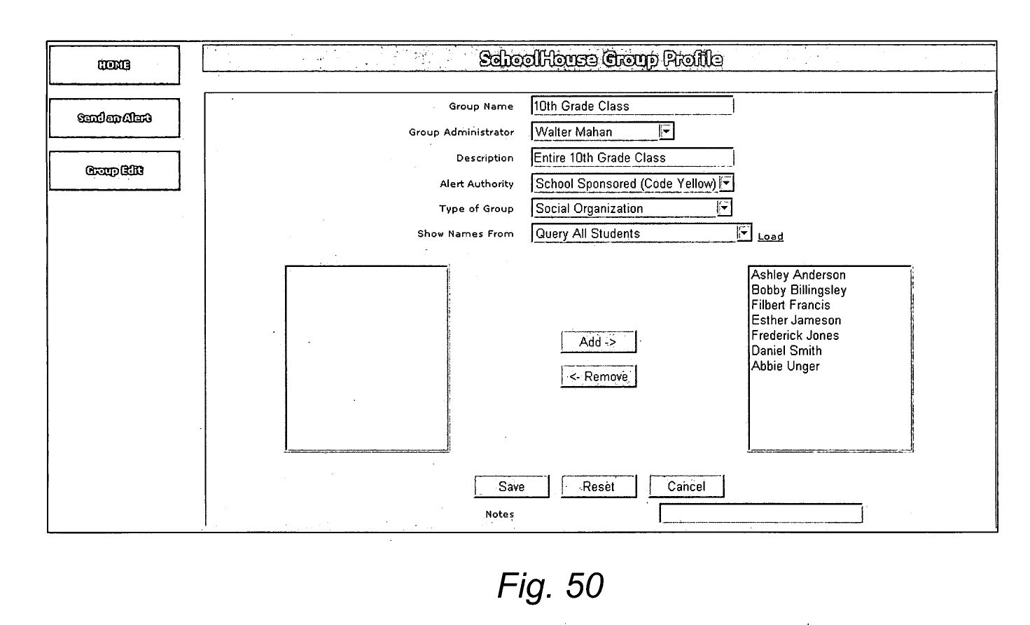

The screen shown in FIG. 50 depicts a sample group representing the 10^{th} grade class.

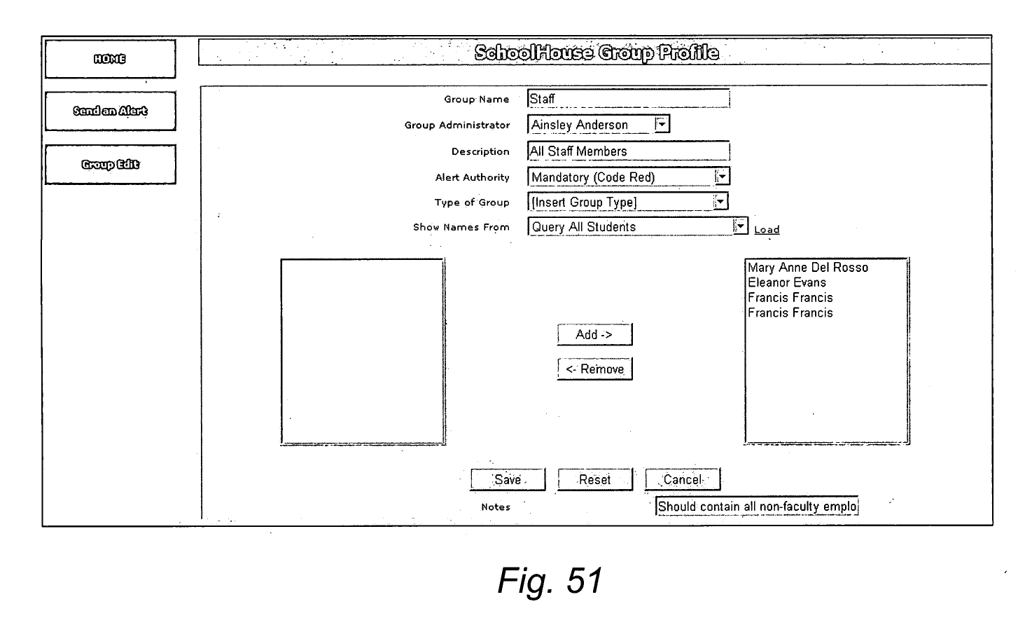

While in the list of groups, click on the Group Name field or Edit Group Profile hyperlink entry to begin editing the desired record. If the list has been sorted, you may click on the Edit hyperlink. The screen shown in FIG. 51 will be presented. The fields are identical to those found when creating a new group, which were previously described.

While in the list of groups, and after the list has been sorted, you may click on the View hyperlink. The screen presented is identical to the one presented for edit, however, you may not make any changes to the record.

While in the list of groups, and after the list has been sorted, you may click on the Delete hyperlink. The software will prompt you to confirm prior to actually deleting the record.

Similarly to the above, whenever you click on the Faculty button shown in the screen depicted in FIG. 43, an edit screen appears that contains a list of faculty member records that have been defined for the system.

In addition, whenever you click on the Staff button as shown in the screen depicted in FIG. 43, an edit screen appears that contains a list of staff member records that have been defined for the system.

Similarly, whenever you click on the Class Schedules button as shown in the screen depicted in FIG. 43, an edit screen appears that contains a list of class schedule records that have been defined for the system.

Finally, whenever you click on the Bus Schedules or Bus Drivers button as shown in the screen depicted in FIG. 43, a respective edit screen appears that contains a list of bus schedule records or bus driver records that have been defined for the system.

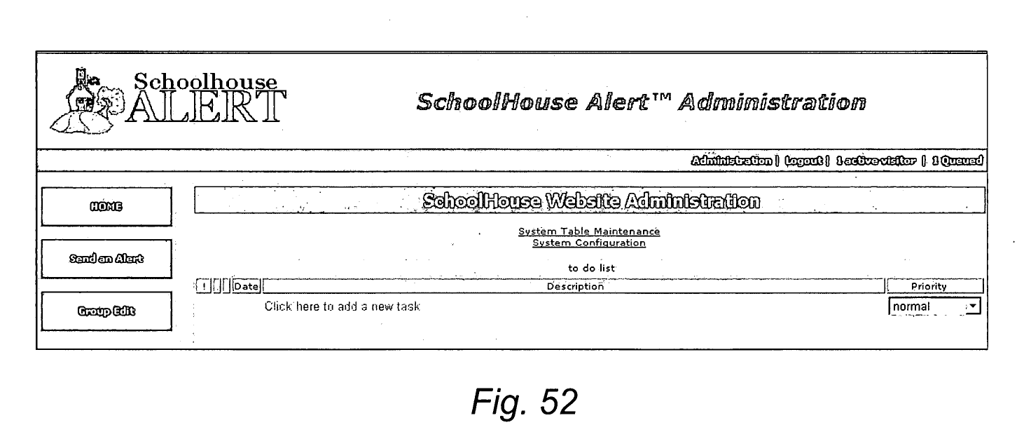

The System Tables are comprised of the various tables that are referenced as dropdowns throughout the system. The Administrator accesses these tables by clicking on the Administration button on the Schoolhouse Dashboard screen shown in FIG. 43 to generate the Website Administration screen shown in FIG. 52.

Some of these tables have been pre-populated with lots of data Zip Codes, (Countries, Counties, etc.). The school will want to purge unnecessary entries prior to launch to make dropdown selection easy for the users. Once on this screen, click on the System Table Maintenance hyperlink to perform maintenance on these table. The Website Administration screen will change by presenting a dropdown table for System Table Maintenance.

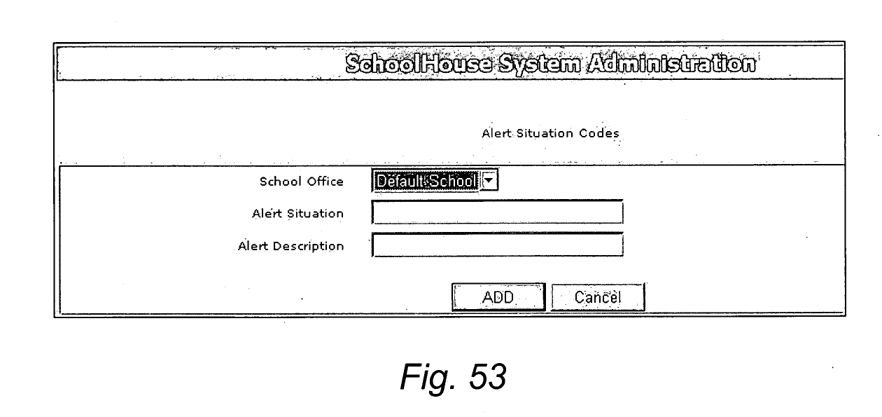

Select the desired table to change from the dropdown entries. The following sections describe the tables in detail. Use the Add hyperlink once the table is presented to add an entry to create a new entry. The Edit and Delete hyperlinks enable the Administrator to change or delete the entry in the displayed row, respectively. The user will be prompted to confirm that the record is to be deleted prior to actually deleting the record. All of the Add and Edit screens are similar to the one shown in FIG. 53. The following table (required fields are bolded) describes each column in the list and its content.

| Field Label: | Content/Use: |
|---|---|
| School Office: | Choose the school that this code applies to (usually |
| | only a single entry). |
| Alert Situation: | Define the appropriate code that will be displayed |
| | in the dropdown entry. |
| Alert Description | A description that more fully describe the code. |

The following buttons are used to save or discard the entry:

| | |
|---|---|
| ADD | Add the new record for this group. |
| Save | Save the data for this group. |
| Cancel | Discard the data entered and reset all fields as |
| | if a new group is being created. |

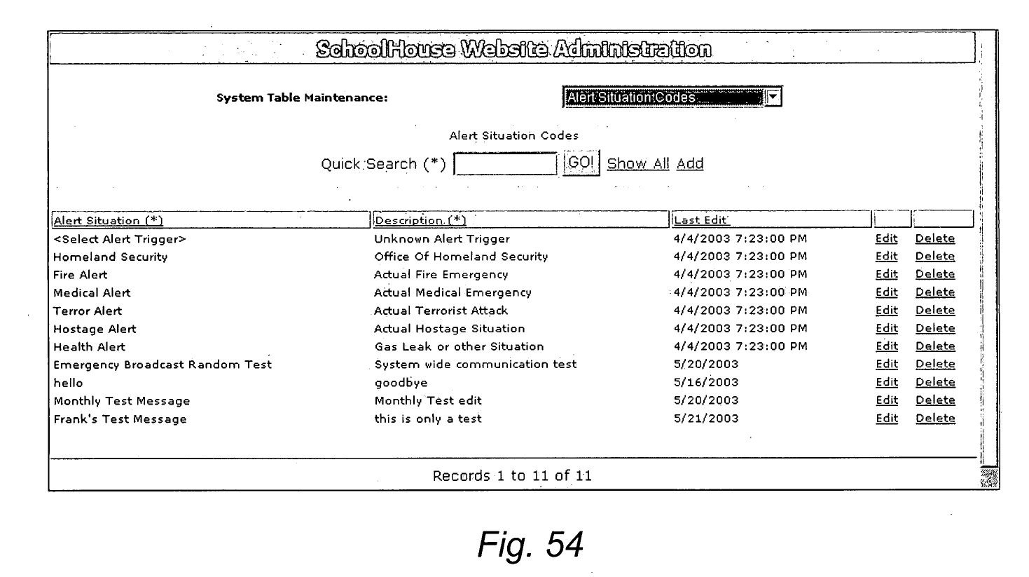

Choosing the “Alert Situation Codes” dropdown entry in the System Table Maintenance field enables the Administrator to add, edit or delete entries in the table. This table defines general categories of alert situations and is shown in FIG. 54.

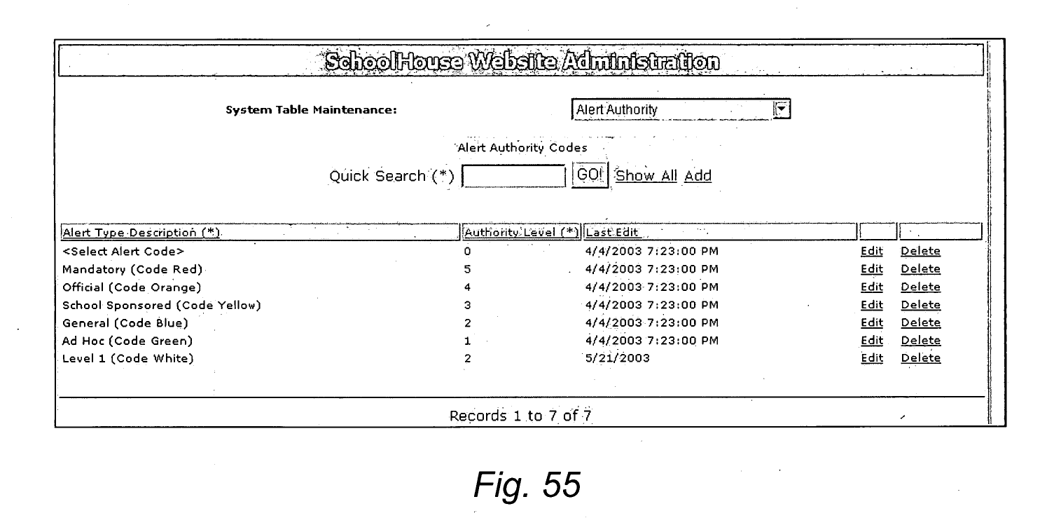

Choosing the “Alert Authority” dropdown entry in the System Table Maintenance field enables the Administrator to add, edit or delete entries in the table. This table defines impact levels of alerts and is shown in FIG. 55.

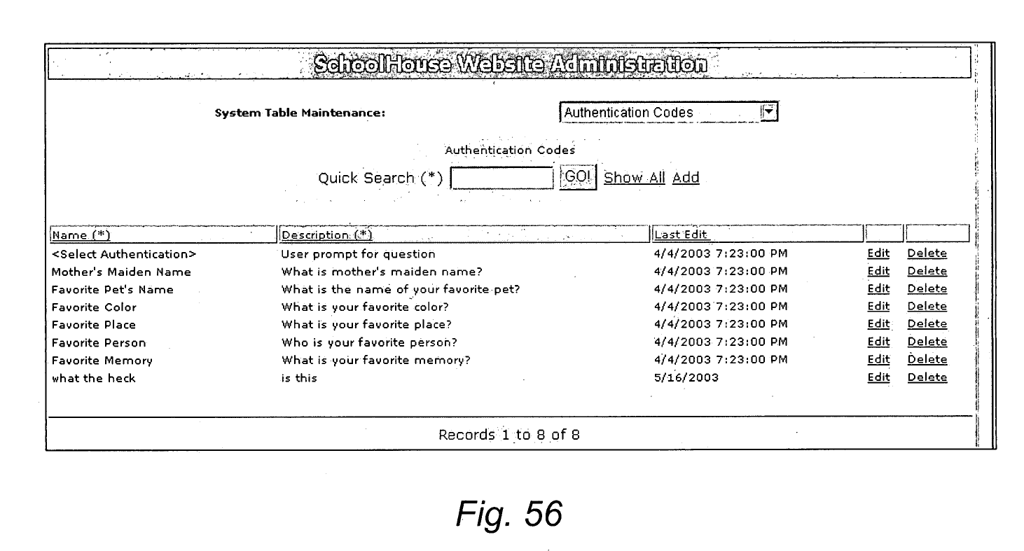

Choosing the “Authentication Codes” dropdown entry in the System Table Maintenance field enables the Administrator to add, edit or delete entries in the table. This table defines general categories of authentication questions and is shown in FIG. 56.

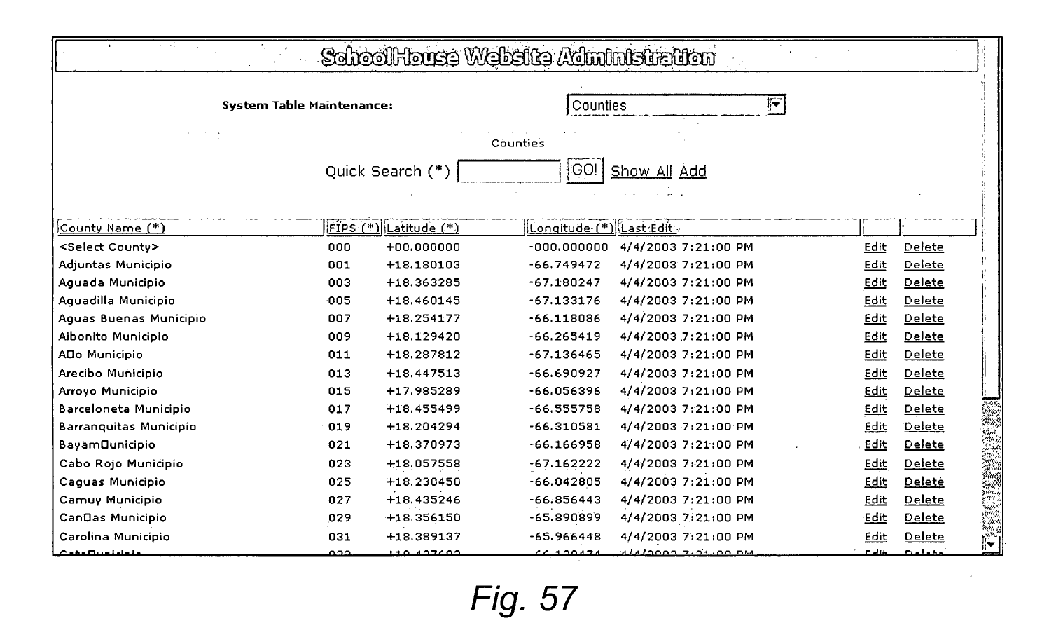

Choosing the “Counties” dropdown entry in the System Table Maintenance field enables the Administrator to add, edit or delete entries in the table. This table defines Counties that are in the area of the school and is shown in FIG. 57.

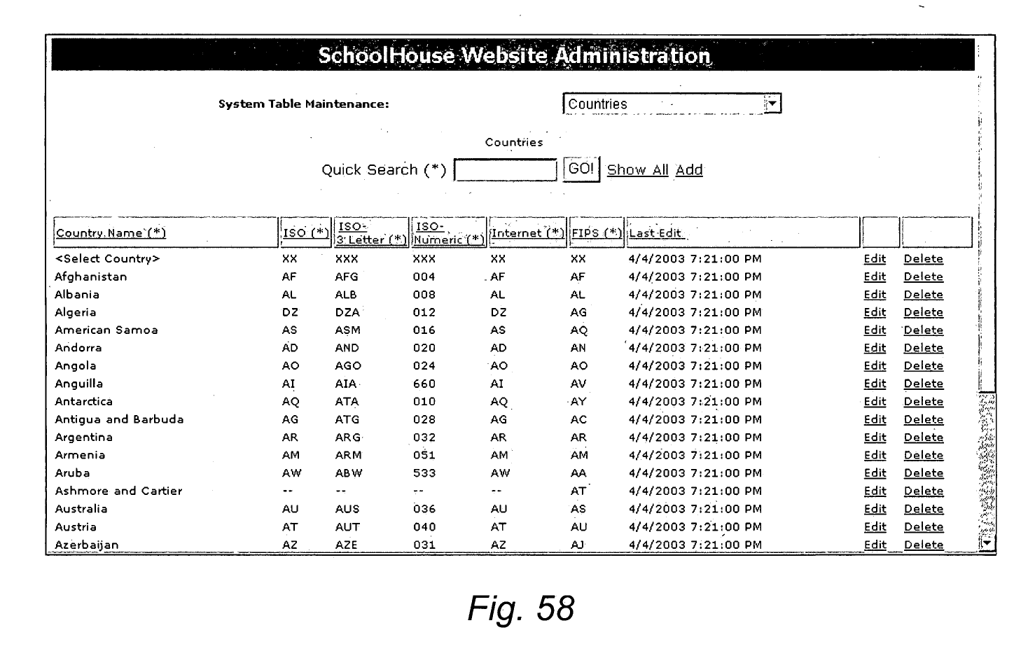

Choosing the “Countries” dropdown entry in the System Table Maintenance field enables the Administrator to add, edit or delete entries in the table. This table defines countries where students reside and is shown in FIG. 58.

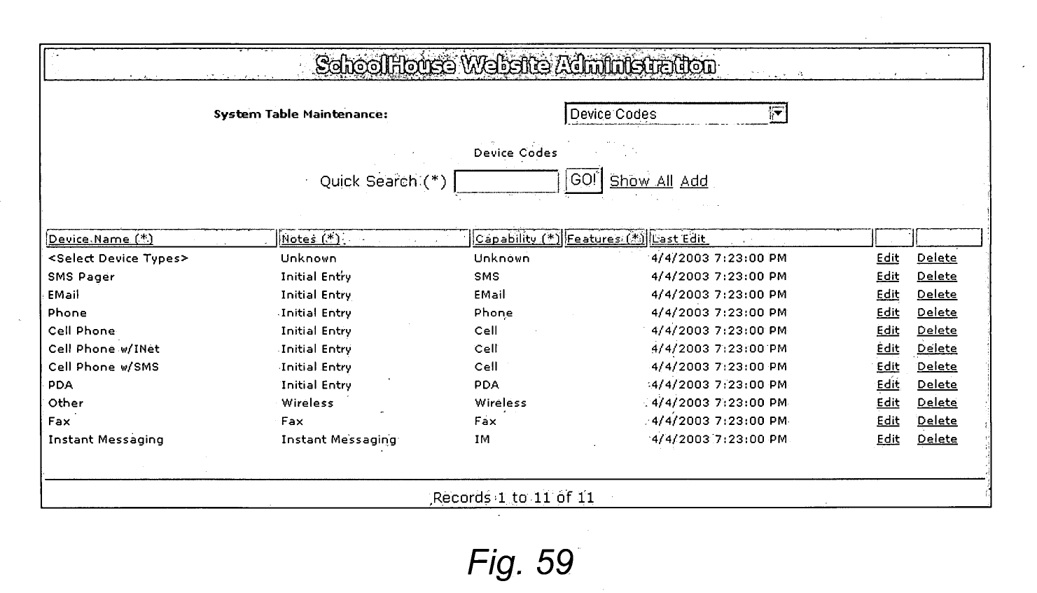

Choosing the “Device Codes” dropdown entry in the System Table Maintenance field enables the Administrator to add, edit or delete entries in the table. This table defines communication devices used in the system and is shown in FIG. 59.

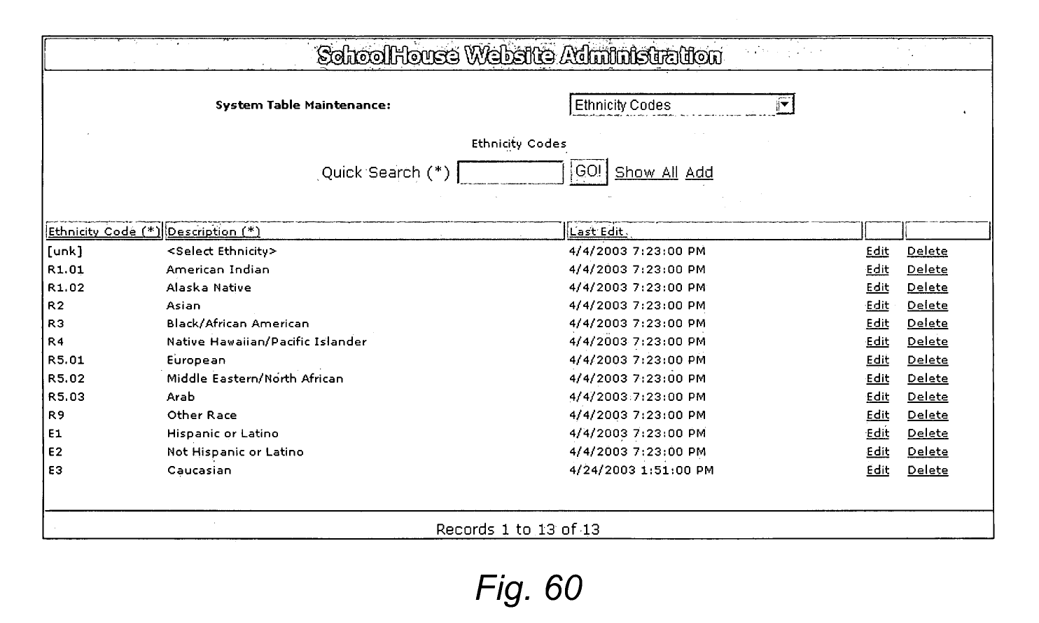

Choosing the “Ethnicity Codes” dropdown entry in the System Table Maintenance field enables the Administrator to add, edit or delete entries in the table. This table defines general ethnic origins and is shown in FIG. 60.

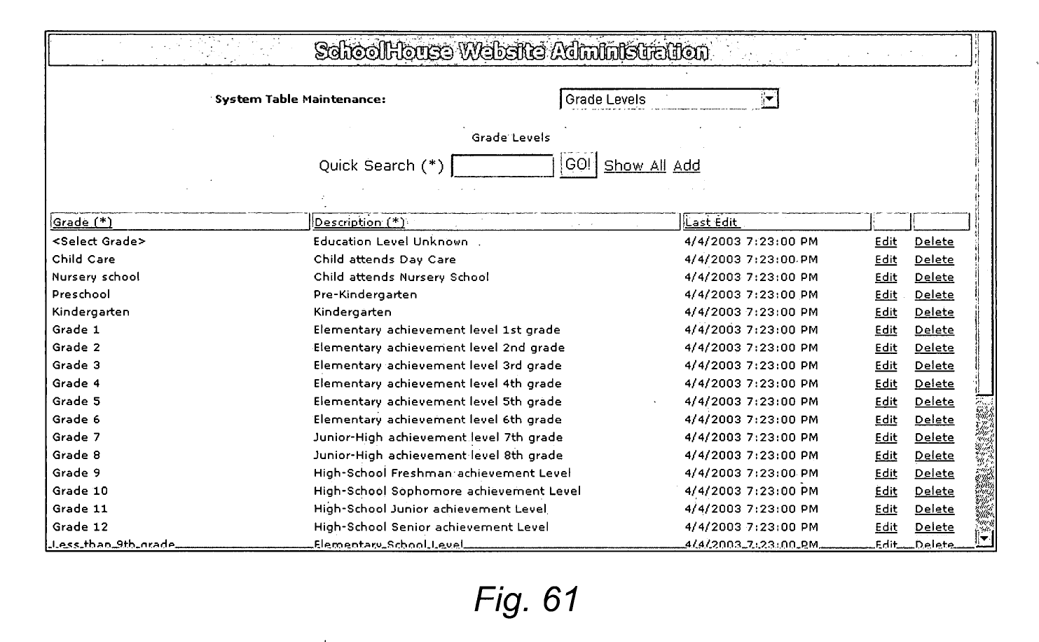

Choosing the “Grade Level Codes” dropdown entry in the System Table Maintenance field enables the Administrator to add, edit or delete entries in the table. This table defines grade levels at the school and is shown in FIG. 61.

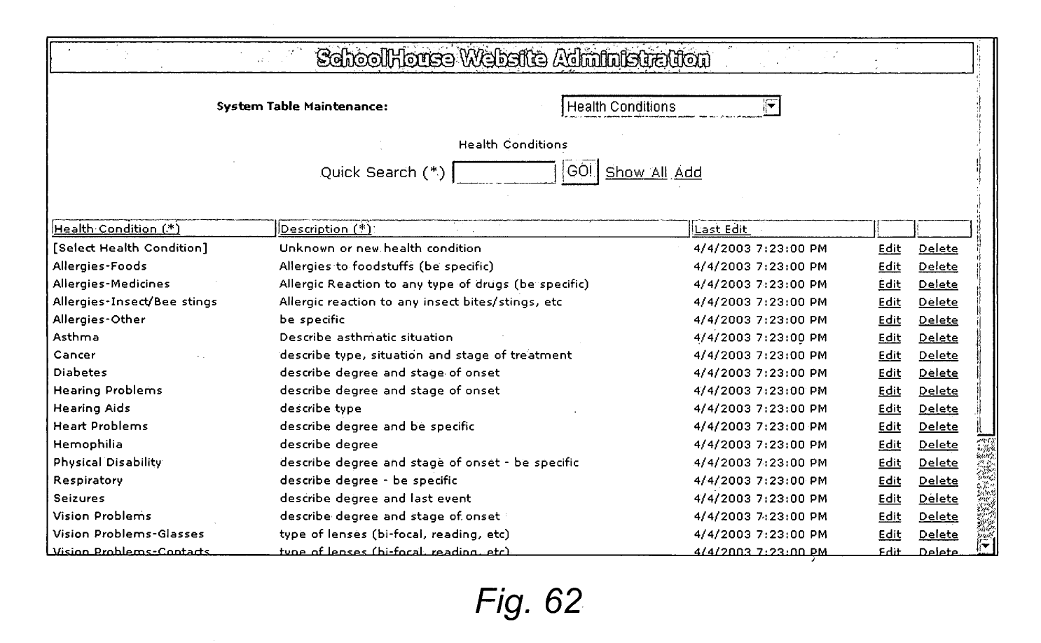

Choosing the “Health Conditions” dropdown entry in the System Table Maintenance field enables the Administrator to add, edit or delete entries in the table. This table defines potential health conditions of students and is shown in FIG. 62.

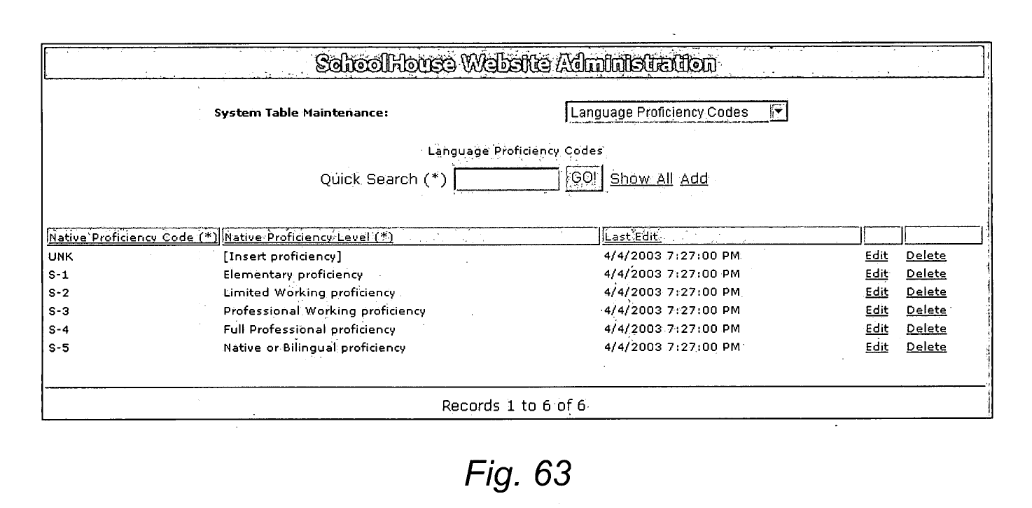

Choosing the “Language Proficiency Codes” dropdown entry in the System Table Maintenance field enables the Administrator to add, edit or delete entries in the table. This table defines student's proficiency in languages and is shown in FIG. 63.

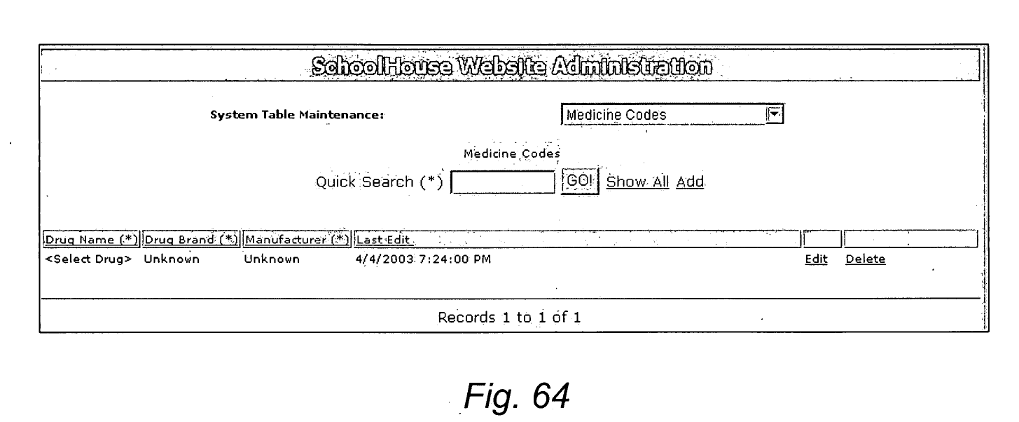

Choosing the “Medicine Codes” dropdown entry in the System Table Maintenance field enables the Administrator to add, edit or delete entries in the table. This table defines potential medicines taken by students and is shown in FIG. 64.

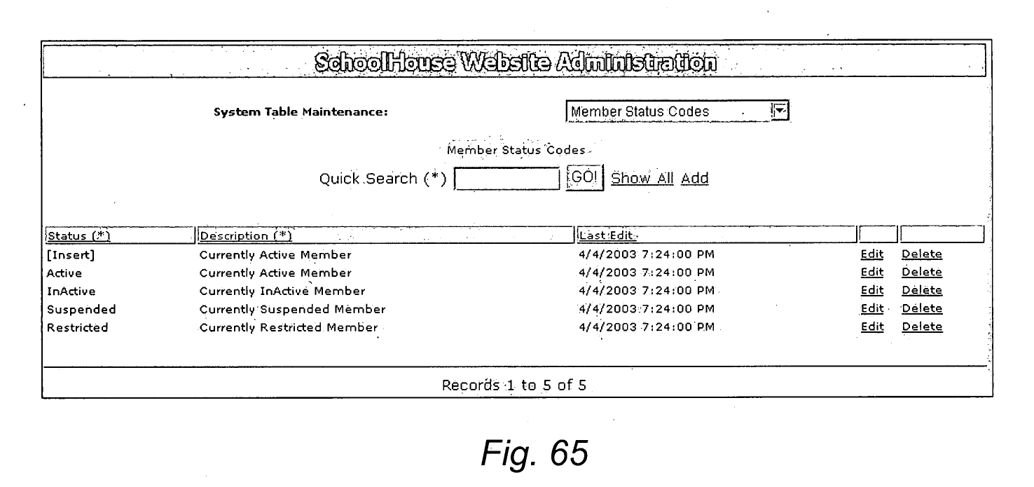

Choosing the “Member Status Codes” dropdown entry in the System Table Maintenance field enables the Administrator to add, edit or delete entries in the table. This table defines status codes of family members and is shown in FIG. 65.

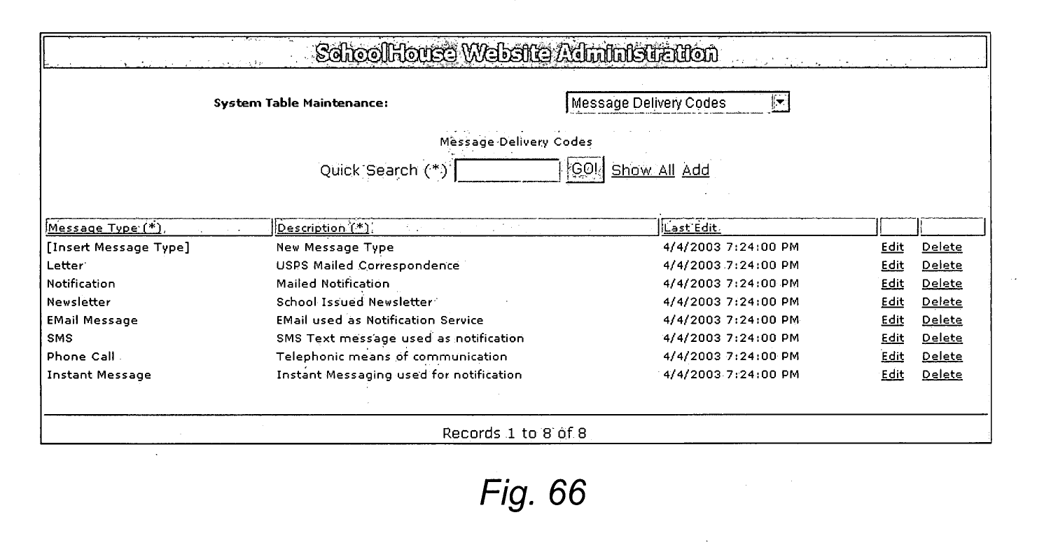

Choosing the “Message Delivery Codes” dropdown entry in the System Table Maintenance field enables the Administrator to add, edit or delete entries in the table. This table defines delivery modes for messages and is shown in FIG. 66.

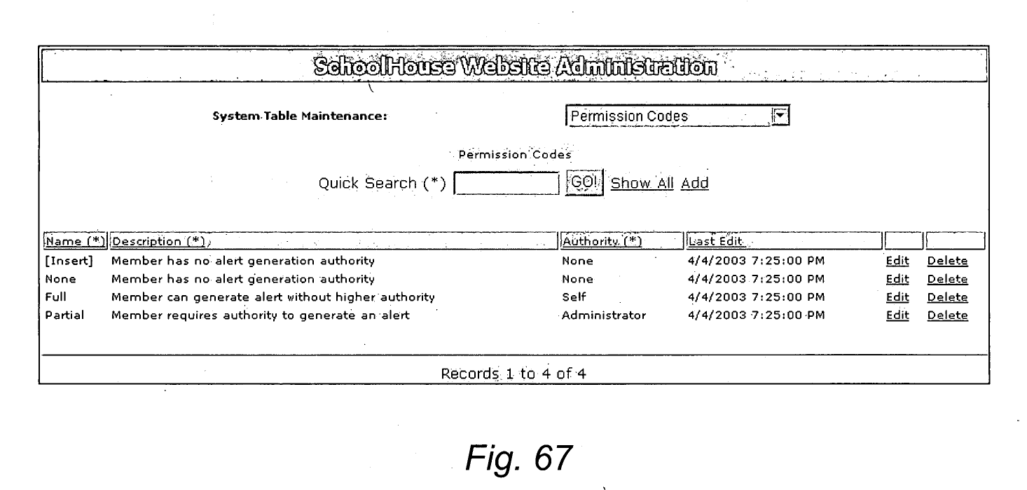

Choosing the “Permission Codes” dropdown entry in the System Table Maintenance field enables the Administrator to add, edit or delete entries in the table. This table defines permission authorities of individual users and is shown in FIG. 67.

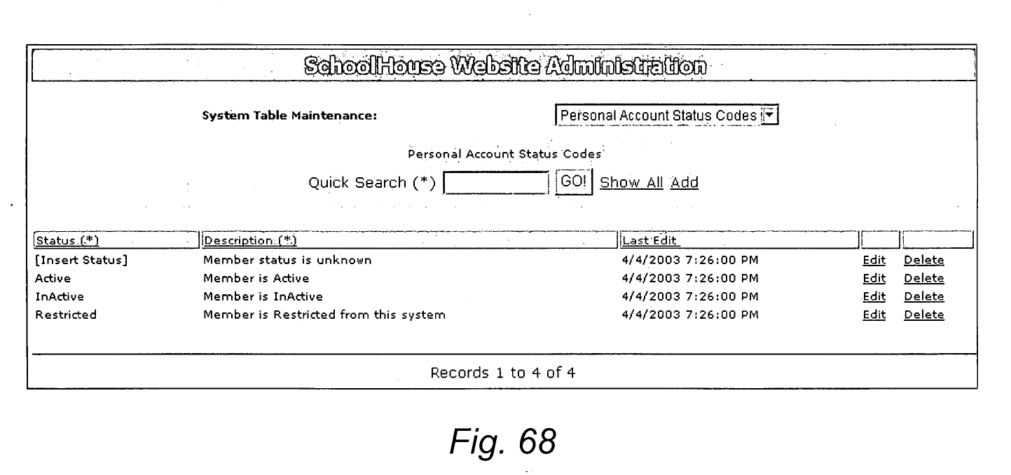

Choosing the “Personal Account Status Codes” dropdown entry in the System Table Maintenance field enables the Administrator to add, edit or delete entries in the table. This table defines status codes of individuals and is shown in FIG. 68.

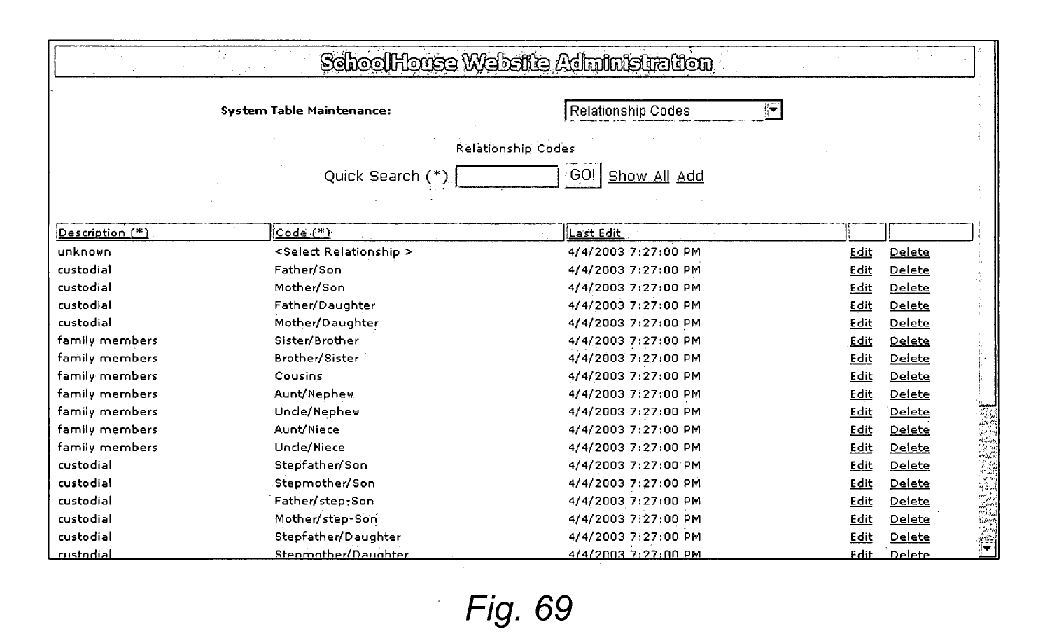

Choosing the “Relationship Codes” dropdown entry in the System Table Maintenance field enables the Administrator to add, edit or delete entries in the table. This table defines potential relationships between family members and is shown in FIG. 69.

Choosing the “Relationships Role Codes” dropdown entry in the System Table Maintenance field enables the Administrator to add, edit or delete entries in the table. This table defines general roles of relationships within a family and is shown in FIG. 70.

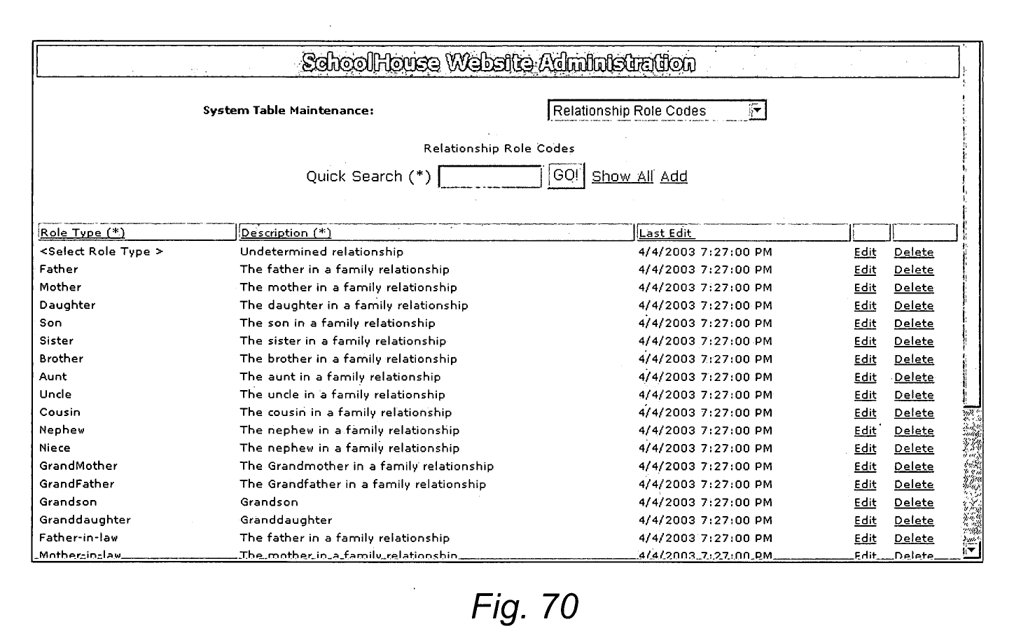

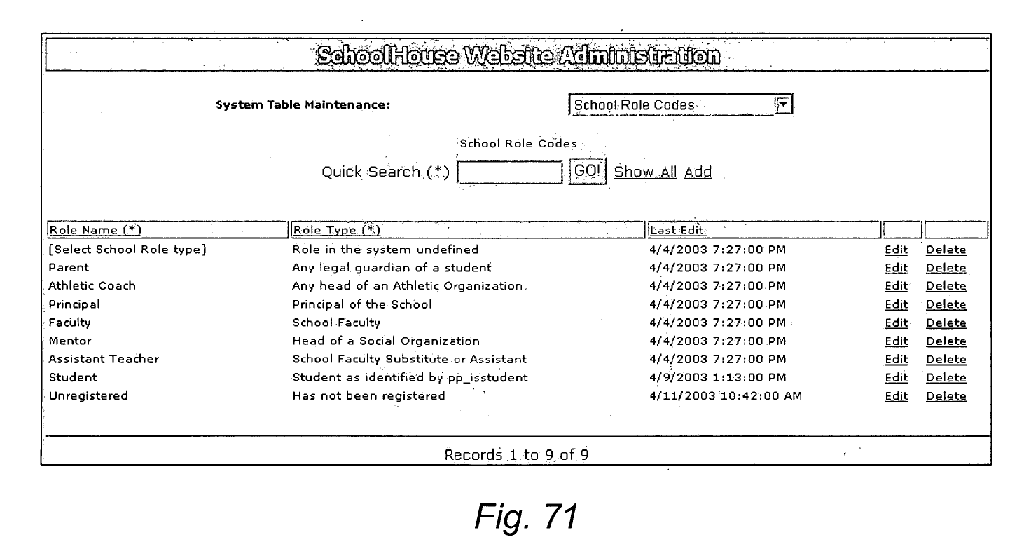

Choosing the “School Role Codes” dropdown entry in the System Table Maintenance field enables the Administrator to add, edit or delete entries in the table. This table defines general roles of school personnel and is shown in FIG. 71.

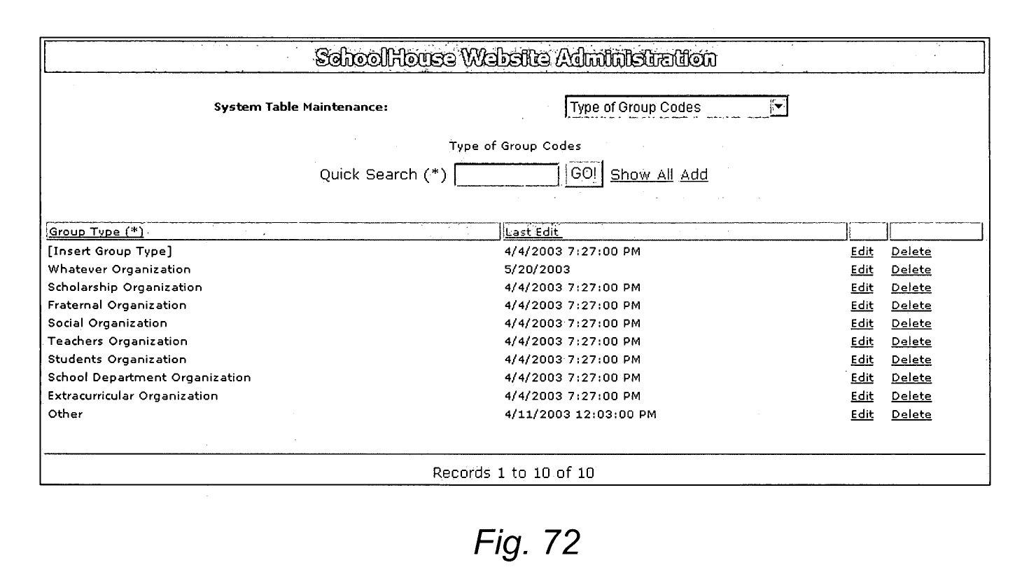

Choosing the “Type of Group Codes” dropdown entry in the System Table Maintenance field enables the Administrator to add, edit or delete entries in the table. This table defines group types within the school and is shown in FIG. 72.

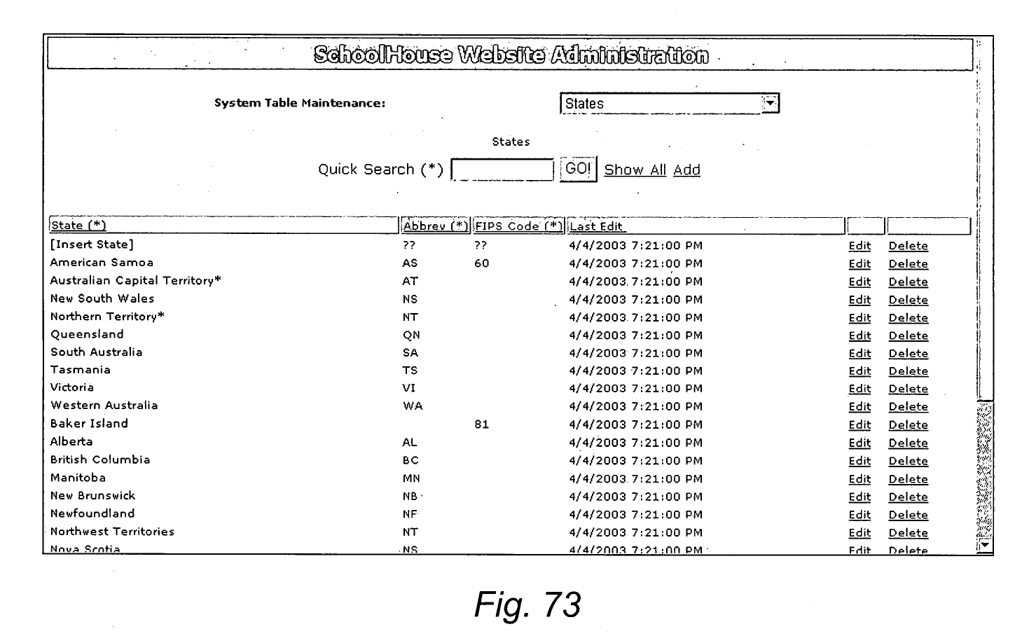

Choosing the “State Codes” dropdown entry in the System Table Maintenance field enables the Administrator to add, edit or delete entries in the table. This table defines states within your school area and is shown in FIG. 73.

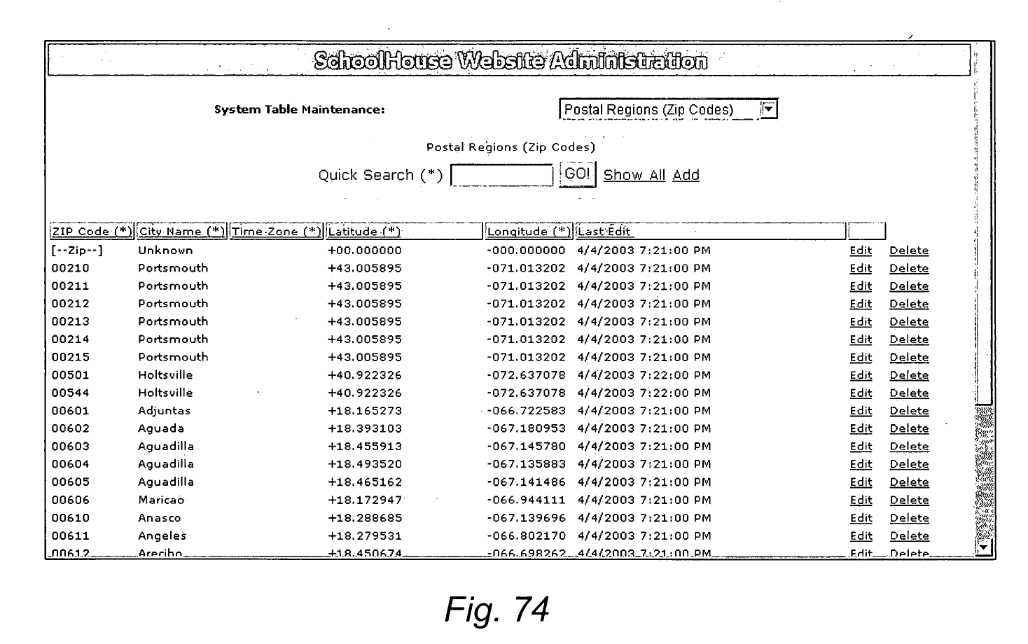

Choosing the “Zip Codes” dropdown entry in the System Table Maintenance field enables the Administrator to add, edit or delete entries in the table. This table defines zip (or postal) codes within the school area and is shown in FIG. 74.

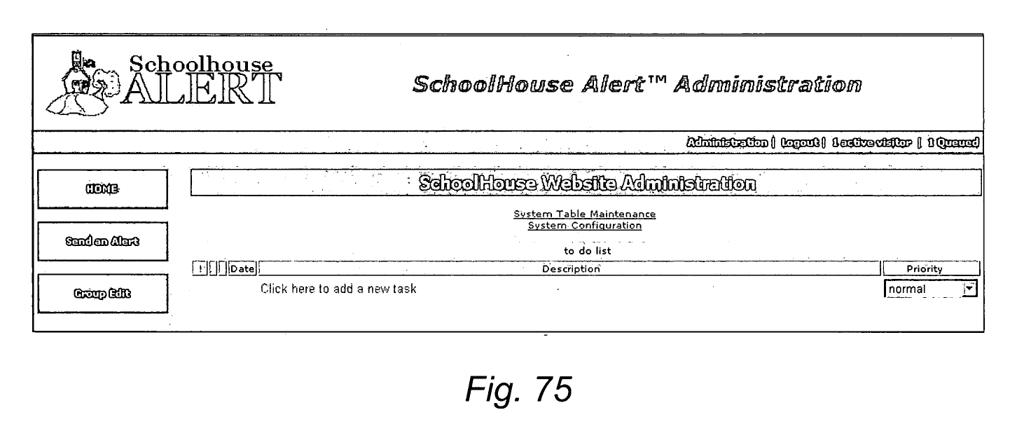

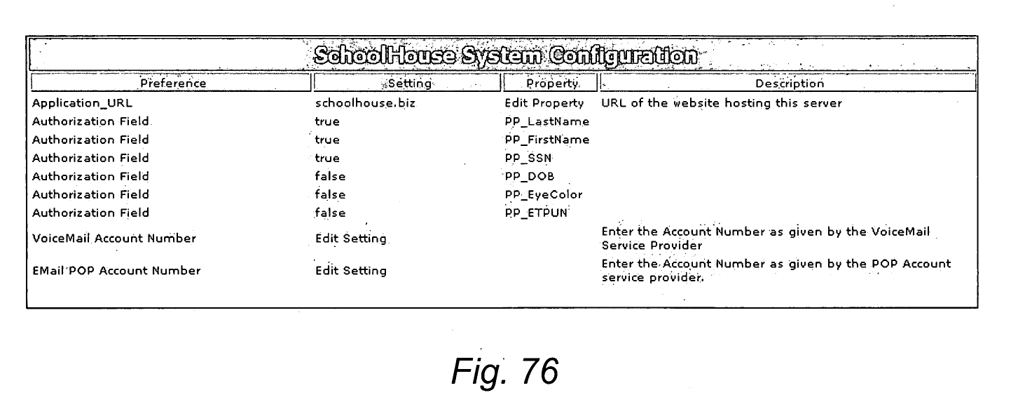

The System Tables are comprised of the various tables that are referenced as dropdowns throughout the system. The Administrator accesses these tables by clicking on the Administration button on the Schoolhouse Dashboard screen shown in FIG. 43, to generate the Website Administration screen and is shown in FIG. 75. Once on this screen, a click on the System Configuration hyperlink will allow maintenance to be performed on these tables. The Website Administration screen will change by presenting the dropdown screen shown in FIG. 76 for System Configuration Maintenance. The Administrator selects the desired table to change from the dropdown entries.

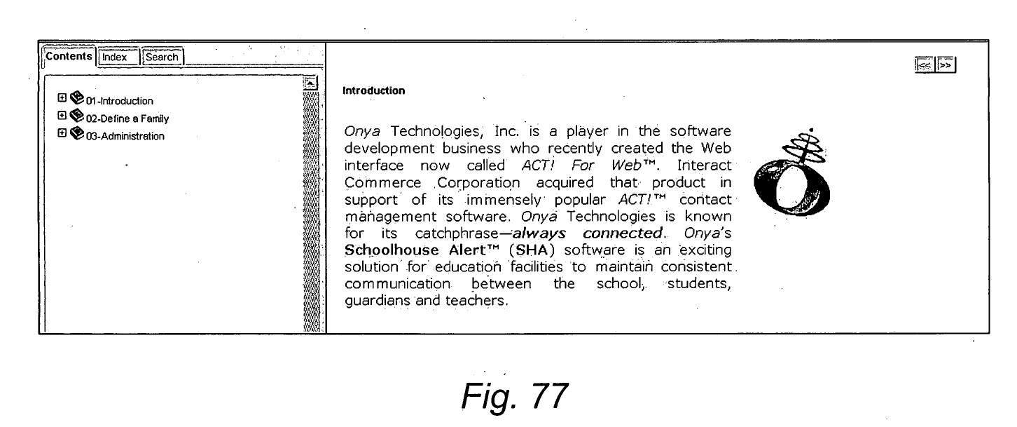

The system includes an Online Help facility that makes finding information easy. The online Help facility is accessed by clicking on the Help button present on a number of the screens to generate the screen shown in FIG. 77. The user can locate their desired information by looking through an online Table of Contents, or by using the Search Facility (by keyword) that is built into Help. When the user chooses the Contents & Index-sub option under Help on the menu, the software displays three folders (Contents, Index and Search). The source of all information displayed is from this same User Guide, regardless of the option used to display it. FIG. 77 shows the default Help screen (it defaults to the first chapter titled “Introduction”). The adjacent buttons can be used to scroll forward and backward through the Online Help documents. The documentation is always displayed on the right of the screen regardless of the means to select it. There are options to use the Back button and the Print button (to print a topic).

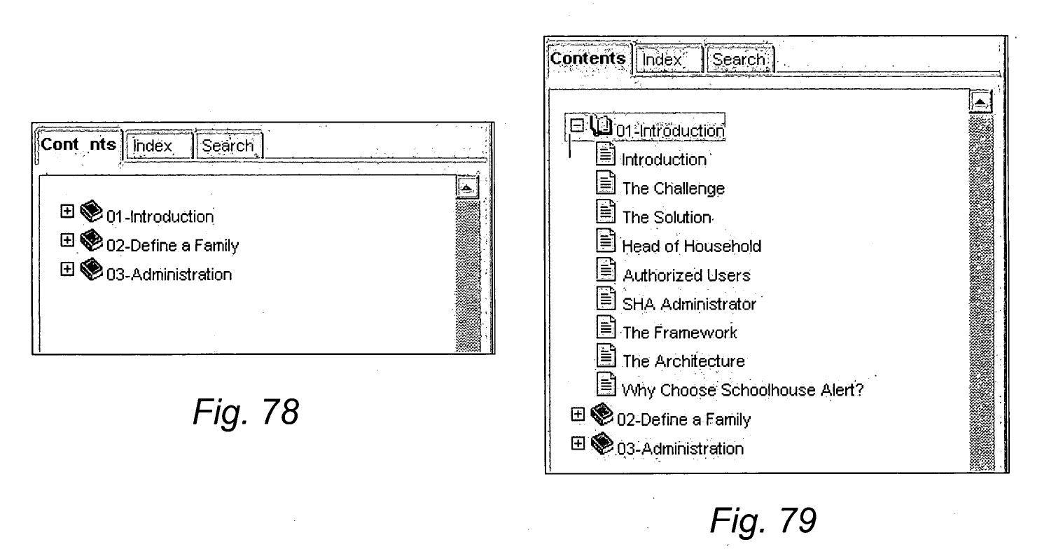

The following sections discuss the three Help options using the Contents, Index and Search Tabs. The Contents Tab, shown in FIG. 78, causes a Table of Contents to be displayed. Each chapter is presented as shown in the adjacent graphic. The chapter will open up into its components, as shown in FIG. 79, when the user clicks on the plus sign (+) or double-clicks on the chapter. Once a chapter is opened, the desired topic will be displayed when the user double-clicks on that topic. Double-clicking on another topic will display that topic in place of the previous topic. A chapter will be closed when the user clicks on the minus sign (−) adjacent to an open chapter. The Index Tab causes the display of all indexed words and phrases (presented alphabetically). This provides a quick alternative when you do not know the appropriate chapter.

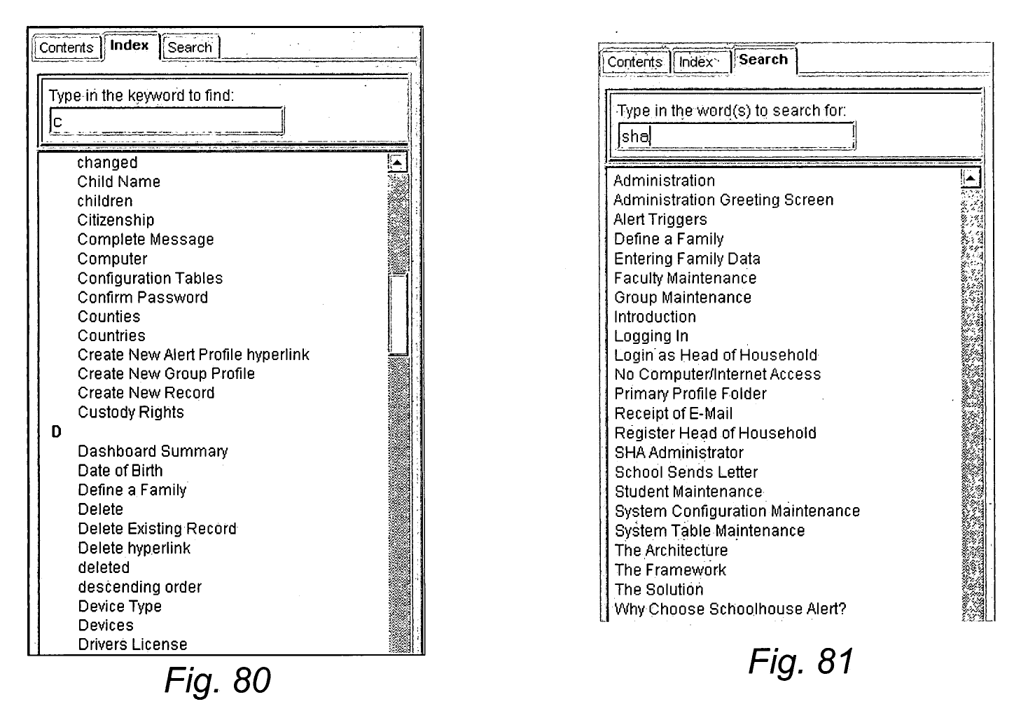

The top line may be used to speed your search for the appropriate word. Key the character (or word) in the top line, shown containing “c” in FIG. 80. The vertical scroll bar to the right may also be used. When the desired word appears, double-clicking on it will display the first topic referencing the highlighted word.

The Search Tab compiles a list of all words in the documentation as shown in FIG. 81. Once done, using the Search is a three-step process. Type the word(s) you wish to find and press the Enter key. Select matching words to narrow search. Choose topic to display. The selected topic will be displayed to the right of the Search facility.

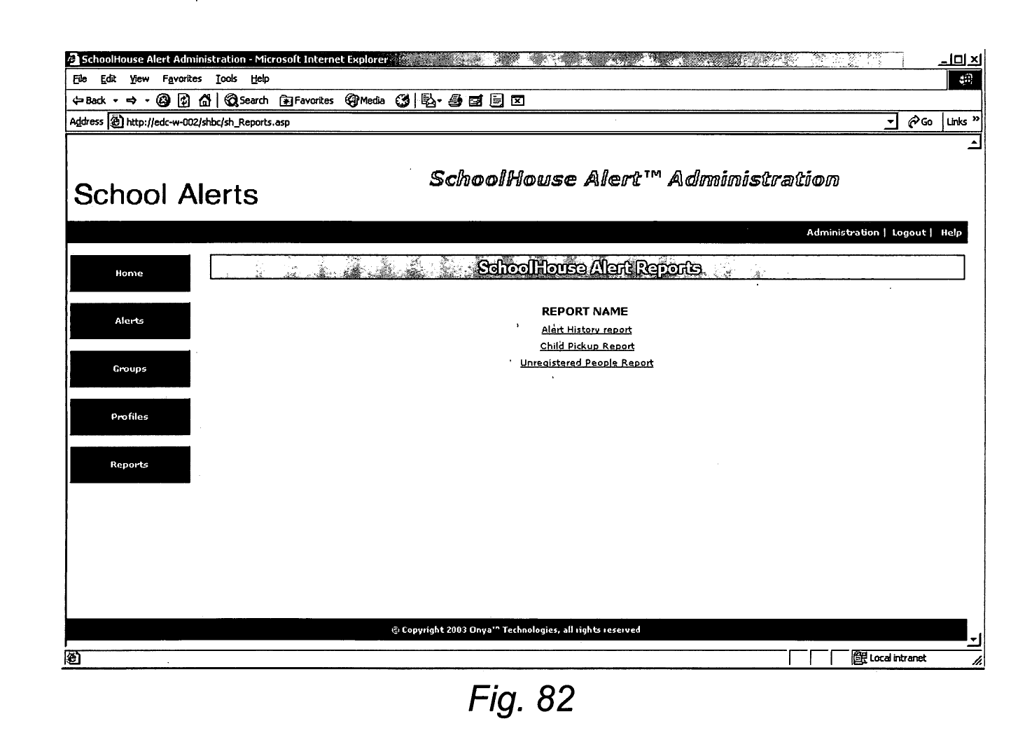

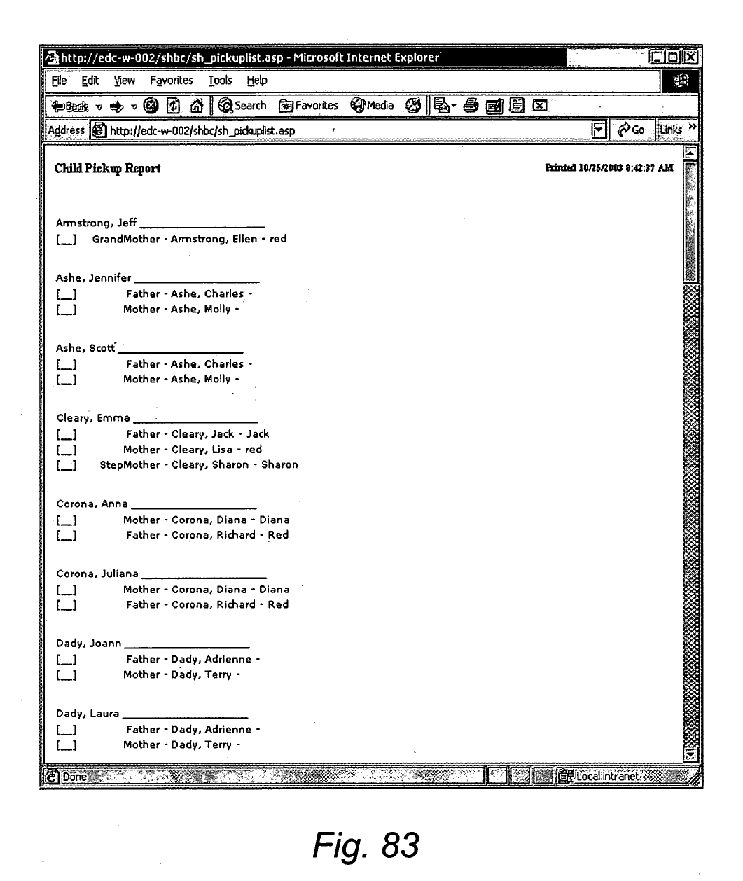

The preferred embodiment of the invention will also include an alerts report screen as shown in FIG. 82. The screen is generated by the system software by clicking on a “Reports” button provided on the prior screens. The alerts report screen has hyperlinks to an alert history report, a child pick-up report and an unregistered people report.

The child pick-up report screen is shown in FIG. 83 and is accessed by clicking on the corresponding hyperlink on the screen shown in FIG. 82. The report identifies, for each child, the persons authorized by the Head of Household to take custody of the child during a situation.

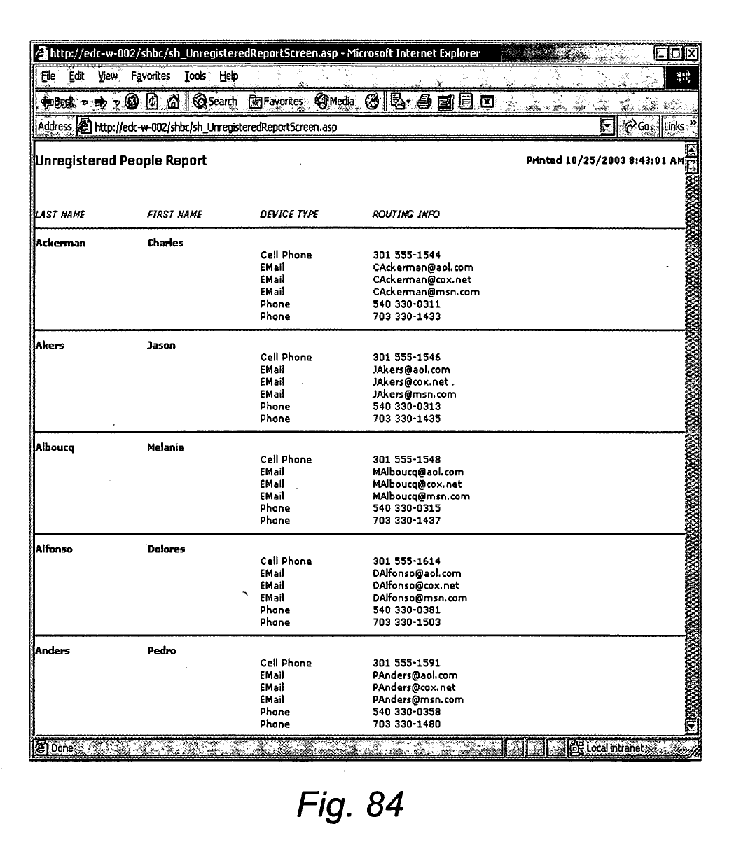

The unregistered people report, shown in FIG. 84, lists persons identified by the Head of Households who are to receive communications from the school, and the communication modes to be utilized. This report is accessed by clicking on the corresponding hyperlink on the screen shown in FIG. 82.

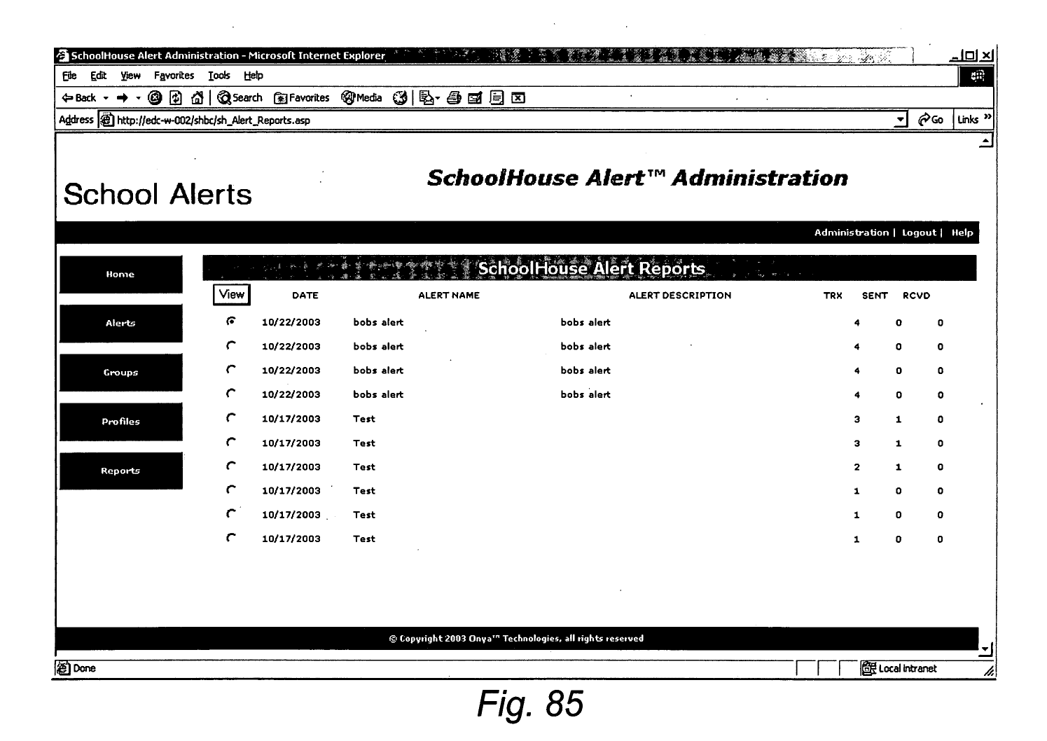

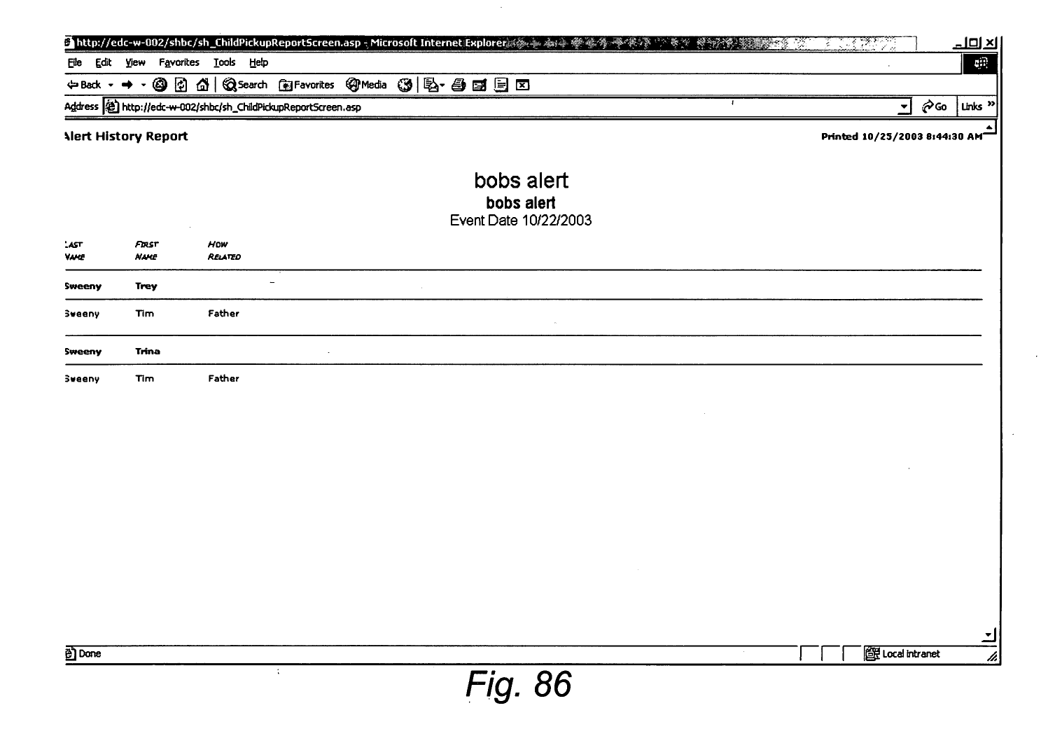

The alert history report screen is shown in FIG. 85 and is accessed by clicking on the corresponding hyperlink on the screen shown in FIG. 82. The report identifies the alerts which the system has transmitted to the users. More details on a particular alert, as shown by the screen shown in FIG. 85, can be retrieved by selecting one of the alerts listed on the screen shown in FIG. 85. The additional details can include, for example, who received notification of the alert as shown on the FIG. 86 screen.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims. For example, while the preferred embodiment described an interactive crisis management alert and information system suitable for a school, the inventive system is equally applicable for commercial enterprises and governmental facilities.

1. An interactive notification system for providing notification of a crisis to users of the system, said system comprising:
a server programmed to send notification of a crisis to a user of the system via communication devices preselected by the user;
a database connected to said server for storing information identifying the users of the system and the respective communication devices that each user has preselected to effect said notification of a crisis;
wherein said server facilitates remote registration and entry of data from each of said users to said database.

2. A system as claimed in claim 1, wherein the users are categorized into groups and said server is further programmed to disseminate information to specific ones of said groups in accordance with the content of the information.

3. A system as claimed in claim 2, wherein each of the users preselect different communication devices for crisis notification and dissemination of information.

4. A system as claimed in claim 1, wherein said communication devices comprise at least one of telephones, pagers, cell phones, PDAs, facsimile machines and computers.

5. A system as claimed in claim 2, wherein said communication devices comprise at least one of telephones, pagers, cell phones, PDAs, facsimile machines and computers.

6. A system as claimed in claim 3, wherein said communication devices comprise at least one of telephones, pagers, cell phones, PDAs, facsimile machines and computers.

7. A system as claimed in claim 1, wherein said notification of a crisis includes basic information regarding at least one of the events, a description of the current situation, what the notified users should expect, and instructions on what the notified users should do and not do.

8. A system as claimed in claim 1 wherein the system determines a Head of Household for each household using the system, and only allows the Head of Household to enter data into the system.

9. A system as claimed in claim 2 wherein the system determines a Head of Household for each household using the system, and only allows the Head of Household to enter data into the system.

10. A system as claimed in claim 8, wherein the Head of Household can add an additional Head of Household to the system so that said additional Head of Household can enter data into the system.

11. A system as claimed in claim 9, wherein the Head of Household can add an additional Head of Household to the system so that said additional Head of Household can enter data into the system.

12. A system as claimed in claim 8 wherein the Head of Household registers with the system a list of persons who can take custody of a child, during a crisis alert, previously registered by the Head of Household with the system.

13. A system as claimed in claim 12, wherein after notification of a crisis, the Head of Household is given a specific amount of time to update, by adding or deleting, the list of persons.

14. A system as claimed in claim 13, wherein said specific amount of time is 30 minutes.

15. A system as claimed in claim 8, wherein the system categorizes the severity of the crisis for which notification is sent to user.

16. A system as claimed in claim 15, wherein the Head of Household can designate different persons to receive notification of the crisis in accordance with the categorization of the crisis.

17. A system as claimed in claim 2, wherein an Administrator of the system creates said groups and determines the information that is disseminated to each of said groups.

18. A system as claimed in claim 17, wherein the Administrator delegates to a respective leader of each one of said groups the determination of the information that is disseminated to the corresponding group.

19. A method of providing notification of a crisis to users of a notification system that includes a server and database for storing data about the users, said method comprising:
registering the users of the system by providing access to the server and database to each of said users; and
sending a notification of a crisis to each of the registered users via communication devices preselected by each of the registered users.

20. A method as claimed in claim 19, further comprising categorizing the users into groups and disseminating information to specific ones of said groups in accordance with the content of the information.

21. A method as claimed in claim 20, wherein each of the users preselects different communication devices for crises notification and dissemination of information.

22. A method as claimed in claim 19, wherein the communication devices comprise at least one of telephones, pagers, cell phones, PDAs, facsimile machines and computers.

23. A method as claimed in claim 20, wherein the communication devices comprise at least one of telephones, pagers, cell phones, PDAs, facsimile machines and computers.

24. A method as claimed in claim 21, wherein the communication devices comprise at least one of telephones, pagers, cell phones, PDAs, facsimile machines and computers.

25. A method as claimed in claim 19, wherein said notification of a crisis includes basic information regarding at least one of the events, a description of the current situation, what the notified users should expect, and instructions on what the notified users should do and not do.

26. A method as claimed in claim 19, further comprising designating a Head of Household in each household of users and only allowing the Head of Household to enter data into the system.

27. A method as claimed in claim 20, further comprising designating a Head of Household in each household of users and only allowing the Head of Household to enter data into the system.

28. A method as claimed in claim 26, wherein the Head of Household can add an additional Head of Household so that said additional Head of Household can enter data into the system.

29. A method as claimed in claim 27, wherein the Head of Household can add an additional Head of Household so that said additional Head of Household can enter data into the system.

30. A method as claimed in claim 26, wherein the Head of Household registers with the system a list of persons who can take custody of a child, during a crisis alert, previously registered by the Head of Household with the system.

31. A method as claimed in claim 30, wherein after notification of a crisis, the Head of Household is given a specific amount of time to update, by adding or deleting, the list of persons.

32. A method as claimed in claim 31 wherein said specific amount of time is 30 minutes.

33. A method as claimed in claim 26, further including categorizing the severity of the crisis for which notification is sent to the Head of Household.

34. A method as claimed in claim 33, wherein the Head of Household designates persons to receive notification of the crisis in accordance with the categorization of the crisis.

35. A method as claimed in claim 20, wherein an Administrator of the system creates said groups and determines the information that is disseminated to each of said groups.

36. A method as claimed in claim 35, wherein the Administrator delegates to a respective leader of each one of said groups the determination of the information that is disseminated to the corresponding group.

37. A system as claimed in claim 8 wherein said Head of Household enters and controls family relationship data including children records, family records, family relationships, and custody control of children.

38. A system as claimed in claim 37 wherein said Head of Household delegates the entering and control of said family relationship data to an additional person.

39. A method as claimed in claim 26 wherein said Head of Household enters and controls family relationship data including children records, family records, family relationships, and custody control of children.

40. A method as claimed in claim 39, wherein said Head of Household delegates the entering and control of said family relationship data to an additional person.

41. A system as in claim 2, wherein an Administrator creates groups of users, and determines a level of importance for the crisis or information to be disseminated to said groups of users, and communicates the crisis or information in accordance with the level of importance and the communication devices preselected by said users.

42. A system as in claim 41 wherein all communication devices preselected by each user are utilized for a crisis having the highest level of importance.

43. A method as in claim 20, wherein an Administrator creates groups of users, and determines a level of importance for the crisis or information to be disseminated to said groups of users, and communicates the crisis or information in accordance with the level of importance and the communication devices preselected by said users.

44. A method as in claim 43, wherein all communication devices preselected by each user are utilized for a crisis having the highest level of importance.

45. A system as in claim 2, wherein a Head of Household preselects all communication devices to be used for receiving notification of a crisis and dissemination of information.

46. A system as in claim 45, wherein the Head of Household determines which preselected communication will receive notification of a crisis and dissemination of information based on level of importance of the crisis and information.

47. A method as in claim 20, wherein a Head of Household preselects all communication devices to be used for receiving notification of a crisis and dissemination of information.

48. A method as in claim 47 wherein the Head of Household determines which preselected communication will receive notification of a crisis and dissemination of information based on level of importance of the crisis and information.
